(19) United States
(12) Patent Application Publication
(10) Pub. No.: US 2003/0220708 A1
(43) Pub. Date: Nov. 27, 2003

(54) Integrated equipment set for forming shallow trench isolation regions

(75) Inventors: Turgut Sahin, Cupertino, CA (US); Michael C. Smayling, Sunnyvale, CA (US)

Correspondence Address: PATENT COUNSEL, APPLIED MATERIALS, INC., Legal Affairs Department, P.O. BOX 450A, Santa Clara, CA, 95052, US

(73) Assignee: APPLIED MATERIALS, INC.

(21) Appl. No.: 10/306,770

(22) Filed: Nov. 27, 2002

Related U.S. Application Data
(60) Provisional application No. 60/333,901, filed on Nov. 28, 2001.

(51) Int. Cl. G06F 19/00

(52) U.S. Cl. 700/121; 438/690

(57) ABSTRACT

A method is provided that includes (1) receiving information about a substrate etched within an etch subsystem from an integrated inspection system of the etch subsystem; (2) determining a deposition process to perform within a deposition subsystem based at least in part on the information received from the inspection system of the etch subsystem; (3) directing the deposition subsystem to deposit an insulating material on the substrate based on the deposition process; (4) receiving information about the insulating material deposited on the substrate from an integrated inspection system of the deposition subsystem; (5) determining a planarization process to perform within a planarization subsystem based at least in part on the information received from the inspection system of the deposition subsystem; and (6) directing the planarization subsystem to planarize the substrate based on the planarization process. Other methods, systems, apparatus, data structures and computer program products are also provided.

### CROSS REFERENCE TO RELATED APPLICATION

This application claims priority from U.S. Provisional Patent Application Serial No. 60/333,901, filed Nov. 28, 2001, which is hereby incorporated by reference herein in its entirety.

This application is related to U.S. Provisional Patent Application Serial No. 60/323,065, filed Sep. 18, 2001 and titled “INTEGRATED EQUIPMENT SET FOR FORMING AN INTERCONNECT ON A SUBSTRATE”, which is hereby incorporated by reference herein in its entirety.

### FIELD OF THE INVENTION

The present invention relates to semiconductor device manufacturing, and more specifically to an integrated equipment set or “module” for forming shallow trench isolation regions in a substrate.

### BACKGROUND OF THE INVENTION

Modern day integrated circuits such as microprocessors, microcontrollers, application specific integrated circuits (ASICs) and the like employ millions of discrete yet interconnected electrical devices such as metal oxide semiconductor field effect transistors (MOSFETs) and/or bipolar junction transistors, as well as other similar devices. To function properly, each device or various groups of devices must be electrically isolated from other devices located on the same semiconductor substrate or die.

Shallow trench isolation (STI) is one technique for isolating electrical devices or groups of electrical devices formed on a semiconductor substrate. During conventional STI, regions of a semiconductor substrate (wherein electrical devices are to be provided and that require electrical isolation) are electrically isolated by etching a trench around and/or between each region, by filling each trench with a dielectric material such as silicon dioxide and by then planarizing the semiconductor substrate so that only the trenches contain the dielectric material. In this manner discrete regions of semiconductor material are formed within the semiconductor substrate, with each discrete region being electrically isolated from other regions via a non-conductive, dielectric material.

As is well known, an increase in device performance is typically accompanied by a decrease in device area or an increase in device density. Such increases in device density require a similar increase in STI trench density and require that each STI trench has reduced dimensionality (e.g., a larger depth to width ratio or larger “aspect ratio”). Increased STI trench densities thus require tighter control over the etching process used to form each STI trench, the deposition process or processes used to fill each etched STI trench and the planarization process employed thereafter.

Many conventional STI formation techniques rely on the use of “process windows”. A process window is an estimated range of one or more parameters that typically result for a given process (e.g., an estimated range of trench depths and/or widths that typically result for a given etch process, an estimated range of dielectric film thicknesses that typically result for a given deposition process, etc.). For example, trench depth often is assumed to vary by about plus or minus ten percent from its target value (for a given etch process). Accordingly, when process windows are employed, STI trenches typically are overfilled to ensure that the deepest trenches (e.g., the trenches that may be up to 20% deeper than the shallowest trenches due to a plus or minus ten percent process window) are adequately filled. Due to this overfilling and the process window associated with the deposited dielectric film thickness, a longer than otherwise necessary planarization process is employed during planarization (i.e., most substrates are overprocessed). In general, overprocessing (due to the lack of process control associated with process windows) reduces device uniformity, yield and performance (because of the poor dimension/tolerance control associated with overprocessing) and decreases throughput (because of the extra time associated with overprocessing).

To ensure that each STI process (e.g., etching, dielectric deposition, planarization, etc.) maintains its proper process window, test substrates may be periodically analyzed following each STI process step. For example, following an STI etch process, a test substrate may be analyzed within a stand alone metrology tool that measures trench depth, trench width, trench profile, uniformity of trench dimensions across a substrate or the like. Similarly, a stand alone metrology tool may be employed to measure dielectric film thickness for film deposition, and stand alone defect detection tools may be used to measure defect levels following etching, deposition and planarization. In this manner, if trench dimensions and/or dielectric film thickness are outside of a required process window for an STI process, or if too many defects result following etching, dielectric film deposition and/or planarization, appropriate corrective measures may be taken so that each STI process (e.g., etching, deposition and/or planarization) produces results within its required process window.

The use of test substrates suffers from at least one major drawback. Namely, due to the lengthy time required to test and analyze each test substrate following etching, dielectric film deposition or planarization, such test wafers may only be run periodically without significantly affecting the throughput of the various semiconductor processing tools (e.g., etching tools, deposition tools, planarization tools, etc.) used during the STI formation. Test substrates are also expensive.

One technique for addressing the variability inherent with the use of process windows during STI formation is described in Toprac et al., “RUN-TO-RUN CONTROL OF SHALLOW TRENCH ISOLATION ETCH”, AEC/APC 2000. Toprac et al. describe the use of stand alone metrology tools to determine thicknesses of various layers used during STI etch processing. The results of these thickness measurements are used to affect subsequent trench etch processes (e.g., by affecting etch rate/time) and during trench depth measurements (performed via a stand alone profilometer following trench etching).

By using actual (rather than estimated) layer thickness when performing trench depth calculations, a more accurate measure of trench depth is achieved so that a tighter etching process window is defined. However, because of the delay associated with transferring semiconductor wafers to a stand alone metrology tool and from a stand alone metrology tool to a subsequent processing apparatus (e.g., an etching tool), as well as the time required to perform each thickness measurement within the metrology tool, significant throughput delays during STI formation result (particularly if every wafer processed is analyzed). Accordingly, wafers may only be examined on a periodic basis in much the same manner as the above described test substrates.

The use of stand-alone metrology tools also may increase scrap substrate costs. For example, if a stand-alone metrology tool is used to analyze substrates during production processing, because of the long delay associated with (1) transferring a substrate from a processing tool to the stand-alone metrology tool; (2) measuring the substrate with the stand-alone metrology tool; and (3) analyzing the results of the measurement, several other substrates may be processed before the analysis is complete. If the analysis reveals a non-correctible substrate defect (e.g., due to a defective process), numerous substrates (processed after the measured substrate was processed) may have been erroneously processed and require disposal along with the measured substrate. Likewise, a process adjustment based on the measurements of the stand-alone metrology tool may no longer be relevant because of process conditions variations since the measured substrate was processed.

Thus, while Toprac et al. overcome some of the drawbacks associated with the use of process windows (e.g., variability/uniformity), many of the drawbacks associated with test substrates remain (e.g., throughput decreases, limited process control, etc.).

Accordingly a need exists for improved methods and apparatus for forming shallow trench isolation regions.

### SUMMARY OF THE INVENTION

In a first aspect of the invention, a first method of forming shallow trench isolation regions in a substrate is provided. The method includes the steps of (1) receiving information about a substrate etched within an etch subsystem from an integrated inspection system of the etch subsystem; (2) determining a deposition process to perform within a deposition subsystem based at least in part on the information received from the inspection system of the etch subsystem; (3) directing the deposition subsystem to deposit an insulating material on the substrate based on the deposition process; (4) receiving information about the insulating material deposited on the substrate from an integrated inspection system of the deposition subsystem; (5) determining a planarization process to perform within a planarization subsystem based at least in part on the information received from the inspection system of the deposition subsystem; and (6) directing the planarization subsystem to planarize the substrate based on the planarization process.

In a second aspect of the invention, a second method of forming shallow trench isolation regions in a substrate is provided. The method includes the steps of (1) determining an etch process to perform within an etch subsystem; (2) directing the etch subsystem to etch a substrate having a patterned masking layer based on the etch process; (3) directing the etch subsystem to remove the patterned masking layer from the substrate; (4) receiving information about the etched substrate from an integrated inspection system of the etch subsystem; (5) directing a cleaning subsystem to clean the substrate; (6) determining an oxidation process to perform within an oxidation subsystem; (7) directing the oxidation subsystem to form an oxide layer on the substrate based on the oxidation process; (8) determining a deposition process to perform within a deposition subsystem based at least in part on the information received from the inspection system of the etch subsystem about the etched substrate; (9) directing the deposition subsystem to deposit an insulating material on the substrate based on the deposition process; (10) receiving information about the insulating material deposited on the substrate from an integrated inspection system of the deposition subsystem; (11) determining a planarization process to perform within a planarization subsystem based at least in part on the information received from the inspection system of the deposition subsystem about the deposited insulating material; and (12) directing the planarization subsystem to planarize the substrate based on the planarization process.

In a third aspect of the invention, a third method for forming shallow trench isolation regions in a substrate is provided. The method includes the steps of (1) determining an etch process to perform within an etch subsystem based at least in part on information received from an integrated inspection system of the etch subsystem about a substrate previously processed within the etch subsystem; (2) directing the etch subsystem to etch a substrate based on the etch process; (3) determining a deposition process to perform within a deposition subsystem based at least in part on information received from an integrated inspection system of the deposition subsystem about a substrate previously processed within the deposition subsystem; (4) directing the deposition subsystem to deposit an insulating material on the substrate based on the deposition process; (5) determining a planarization process to perform within a planarization subsystem; and (6) directing the planarization subsystem to planarize the substrate based on the planarization process.

In a fourth aspect of the invention, a method is provided that includes the steps of (1) receiving information about an etched substrate from an integrated inspection system of an etch subsystem; (2) determining a deposition process to perform within a deposition subsystem based at least in part on the information received from the inspection system of the etch subsystem; and (3) directing the deposition subsystem to deposit a material layer on the substrate based on the deposition process.

In a fifth aspect of the invention, a method is provided that includes the steps of (1) receiving information about a material layer deposited on a substrate from an integrated inspection system of a deposition subsystem; (2) determining a planarization process to perform within a planarization subsystem based at least in part on the information received from the inspection system of the deposition subsystem; and (3) directing the planarization subsystem to planarize the substrate based on the planarization process.

Systems, apparatus, data structures and computer program products are provided for carrying out these and other methods in accordance with the present invention. Each computer program product described herein may be carried by a medium readable by a computer (e.g., a carrier wave signal, a floppy disc, a compact disc, a DVD, a hard drive, a random access memory, etc.).

In at least one embodiment of the invention, means for forming shallow trench isolation regions in a substrate are provided that include (1) means for determining an etch process to perform within an etch subsystem; (2) means for directing the etch subsystem to etch a substrate based on the etch process; (3) means for receiving information about the etched substrate from an integrated inspection system of the etch subsystem; (4) means for determining a deposition process to perform within a deposition subsystem based at least in part on the information received from the inspection system of the etch subsystem; (5) means for directing the deposition subsystem to deposit an insulating material on the substrate based on the deposition process; (6) means for receiving information about the insulating material deposited on the substrate from an integrated inspection system of the deposition subsystem; (7) means for determining a planarization process to perform within a planarization subsystem based at least in part on the information received from the inspection system of the deposition subsystem; and (8) means for directing the planarization subsystem to planarize the substrate based on the planarization process.

Other features and aspects of the present invention will become more fully apparent from the following detailed description, the appended claims and the accompanying drawings.

### BRIEF DESCRIPTION OF THE DRAWINGS

FIG. 1A is a schematic diagram of an inventive system for forming shallow trench isolation regions in a substrate in accordance with the present invention;

FIG. 1B is a schematic diagram of an alternate embodiment of the invention system of FIG. 1A;

FIG. 2 is a schematic diagram of an exemplary controller that may be employed within the inventive system of FIGS. 1A and 1B;

FIG. 3 is a top plan view of an exemplary etch subsystem having an integrated inspection system that may be employed within the inventive system of FIGS. 1A and 1B;

FIG. 4 is a top plan view of an exemplary deposition subsystem having an integrated inspection system that may be employed within the inventive system of FIGS. 1A and 1B;

FIG. 5 is a top plan view of an exemplary planarization subsystem having an integrated inspection system that may be employed within the inventive system of FIGS. 1A and 1B;

FIGS. 6A-F illustrate a flowchart of a first exemplary process that may be performed by the inventive system of FIGS. 1A and 1B;

FIGS. 7A-G illustrate cross sectional views of a semiconductor substrate during the formation of shallow trench isolation regions employing the inventive system of FIGS. 1A and 1B;

FIGS. 8A(1), 8A(2), 8B(1) and 8B(2) illustrate a flowchart of a second exemplary process that may be performed by the inventive system of FIGS. 1A and 1B;

FIG. 9 is a flowchart of a third exemplary process that may be performed by the inventive system of FIGS. 1A and 1B;

FIG. 10 is a flowchart of a fourth exemplary process that may be performed by the inventive system of FIGS. 1A and 1B;

FIG. 11 is a flowchart of a fifth exemplary process that may be performed by the inventive system of FIGS. 1A and 1B;

FIG. 12 is a flowchart of a sixth exemplary process that may be performed by the inventive system of FIGS. 1A and 1B;

FIG. 13 is a flowchart of a seventh exemplary process that may be performed by the inventive system of FIGS. 1A and 1B;

FIGS. 14A(1) and 14A(2) are a table of exemplary process parameters of the etch subsystem of FIGS. 1A and 1B that may be adjusted based on feedback and feedforward information;

FIG. 14B is a table of exemplary process parameters of the deposition subsystem of FIGS. 1A and 1B that may be adjusted based on feedback and feedforward information;

FIGS. 14C(1) and 14C(2) are a table of exemplary process parameters of the planarization subsystem of FIGS. 1A and 1B that may be adjusted based on feedback and feedforward information;

FIG. 15 illustrates an alternative embodiment for the inventive system of FIGS. 1A and 1B having a distributed module controller;

FIG. 16 is a top plan view of an exemplary stand-alone cleaning tool that may be employed within the inventive system of FIGS. 1A, 1B and 15;

FIG. 17 is a top plan view of an exemplary etch and clean subsystem that may be employed within the inventive system of FIGS. 1A, 1B and 15;

FIG. 18 is a top plan view of an alternative etch and clean tool that may be employed within the inventive system of FIGS. 1A, 1B and 15;

FIG. 19A is a schematic diagram of an exemplary embodiment of a feedback etch control portion of an integrated shallow trench isolation manufacturing system provided in accordance with the present invention;

FIG. 19B is a schematic diagram of an exemplary embodiment of a feedforward etch control portion of an integrated shallow trench isolation manufacturing system provided in accordance with the present invention;

FIG. 19C is a schematic diagram of an exemplary embodiment of a feedback and feedforward deposition control portion of an integrated shallow trench isolation manufacturing system provided in accordance with the present invention; and

FIG. 19D is a schematic diagram of an exemplary embodiment of a feedback and feedforward planarization control portion of an integrated shallow trench isolation manufacturing system provided in accordance with the present invention.

### DETAILED DESCRIPTION

Overview of Integrated Shallow Trench Isolation Manufacturing

The present invention provides integrated methods, apparatus, systems, data structures and computer program products for forming shallow trench isolation (STI) regions in a substrate. The substrate may be a semiconductor substrate (e.g., a semiconductor wafer) or any other suitable substrate.

In one aspect of the invention, a novel system is provided that includes an etch subsystem having an integrated inspection system, a deposition subsystem having an integrated inspection system, a planarization subsystem having an integrated inspection system and a module controller for controlling STI region formation via these subsystems. Each integrated inspection system is capable of performing defect detection (e.g., to detect defect density on a surface of a substrate after a processing step) and/or metrology (e.g., to measure STI trench dimensions such as width or depth, STI trench profile, deposited layer thicknesses, surface planarity following planarization, etc., after a processing step).

To form STI regions in a substrate, the substrate is delivered to the inventive system with a masking layer (e.g., photoresist) that is patterned so as to define regions in the substrate where STI trenches are to be etched. For example, the substrate may be delivered to the inventive system from a conventional lithography tool.

The substrate is delivered to the etch subsystem, and the integrated inspection system of the etch subsystem may perform defect detection on the substrate (e.g., to ensure that the patterned masking layer does not have too high of a defect density) and/or metrology on the substrate (e.g., to ensure that the masking layer has been properly patterned and/or to determine pattern density). Based at least in part on “feedforward” information about the patterned masking layer such as defect density or pattern density, dimensions and/or profile of patterned masking layer features that may influence STI trench dimensions/profile, etc., the module controller may determine an etch process to perform within the etch subsystem. The etch process also may be determined based at least in part on other information such as information received from the integrated inspection system of the etch subsystem for a substrate previously etched within the etch subsystem (e.g., “feedback” information such as trench dimension and/or profile information, defect density, etc.). The module controller then directs the etch subsystem to perform the determined etch process (e.g., so as to etch the substrate).

Once the substrate has been etched (and the patterned masking layer has been removed as described below), the substrate is again inspected within the integrated inspection system of the etch subsystem to determine trench dimension and/or profile information, defect density, etc., and this information is communicated to the module controller. Thereafter, the substrate is transferred to the deposition subsystem (e.g., after a cleaning step and an oxidation step as described below), and an insulating layer is deposited on the substrate (e.g., to fill the etched trenches).

To deposit the insulating layer, the module controller determines and directs the deposition subsystem to employ a deposition process that may be based at least in part on the actual trench dimensions and/or profile information previously measured for the substrate by the integrated inspection system of the etch subsystem. The deposition process also may be based at least in part on information obtained from the integrated inspection system of the deposition subsystem for a substrate previously processed within the deposition subsystem (e.g., information such as deposited layer thickness, defect density, etc.), or the deposition process may be based at least in part on information gathered by the integrated inspection system of the deposition subsystem prior to processing.

Once the insulating material has been deposited on the substrate, the substrate is inspected with the integrated inspection system of the deposition subsystem (e.g., to determine deposited layer thickness, defect density, etc.), and inspection information is communicated to the module controller. The substrate then is transferred to the planarization subsystem and is planarized.

To planarize the substrate, the module controller determines and directs the planarization subsystem to employ a planarization process that may be based at least in part on (1) the actual thickness of the insulating layer deposited on the substrate as obtained from the integrated inspection system of the deposition subsystem; (2) from the integrated inspection system of the planarization subsystem for a substrate previously processed therein (e.g., information such as defect density, surface planarity following planarization, etc.); and/or (3) from the incoming substrate itself. Once the substrate has been planarized, the substrate is inspected with the integrated inspection system of the planarization subsystem (e.g., to determine defect density), and this inspection information is communicated to the module controller.

Numerous other aspects of the invention also are provided. The module “controller” may be a single, central controller that communicates with the integrated inspection system of each subsystem, or each subsystem may include controller capabilities (e.g., the module controller may be distributed among the subsystems such that each subsystem has a controller that communicates with one or more other subsystem controllers). In at least one embodiment, each subsystem includes an embedded module controller and an automated process control module (e.g., computer program code) that may communicate with the integrated inspection system of the subsystem and with embedded module controllers of other subsystems, determine processes to perform within the subsystem based at least in part on feedback information (e.g., from the integrated inspection system of the subsystem) and/or feedforward information (e.g., from an embedded module controller of another subsystem), etc., as described in more detail below.

Because during STI region formation, each process performed (e.g., etching, deposition, planarization, etc.) may be based at least in part on feedforward information (e.g., masking layer pattern density, defect density, trench dimensions/profile, deposited layer thickness, etc., for the substrate to be processed) and/or based at least in part on feedback information (e.g., defect density, trench dimensions/profile, deposited layer thickness, etc., for a substrate previously processed), the use of “estimated” process windows during STI region formation may be reduced, and the accuracy and repeatability of each process step may be significantly increased. Additionally, the integrated nature of each inspection system allows substrates to be inspected without significantly affecting subsystem throughput (e.g., every substrate processed may be inspected).

Relevant Terminology

As used herein, an integrated inspection system refers to an inspection system that is (1) coupled to a fabrication subsystem; and (2) capable of inspecting one substrate of a batch of substrates delivered to the fabrication subsystem during at least a portion of the time that another substrate of the batch of substrates is processed within the fabrication subsystem. A fabrication subsystem may include any known semiconductor device fabrication tool, system or subsystem such as an etch tool, a deposition tool, a cleaning tool, an oxidation tool, a planarization tool or the like. A stand-alone inspection system refers to an inspection system that is (1) not coupled to a fabrication subsystem; and/or (2) incapable of inspecting one substrate of a batch of substrates delivered to the fabrication subsystem during at least a portion of the time that another substrate of the batch of substrates is processed within the fabrication subsystem.

An inspection system refers to a system capable of performing defect detection or metrology. Defect detection refers to the detection and/or identification or classification of defects, contaminants, flaws, imperfections, deficiencies or the like. Metrology refers to the determination of one or more material or process parameters such as thickness, composition, index of refraction, atomic structure, mechanical properties, electrical properties, depth, width and/or profile of an etch feature, gas pressure, process temperature, gas flow rate, pump rate or the like.

Determining may include selecting, calculating, computing, defining, delineating, measuring or the like. Directing may include applying, initiating, controlling, managing or the like. Configured to or adapted to may include formed to, designed to, selected to, constructed to, manufactured to, programmed to or the like. Communication may include one or two way communication, polling, or the like. Feedback information refers to information regarding a substrate (e.g., defect density, material properties such as trench depth, trench width, trench profile, thickness, etc.) that is relevant to at least the processing of a subsequent substrate. Feedforward information refers to information regarding a substrate that is relevant to at least the subsequent processing of the same substrate.

System Apparatus Overview

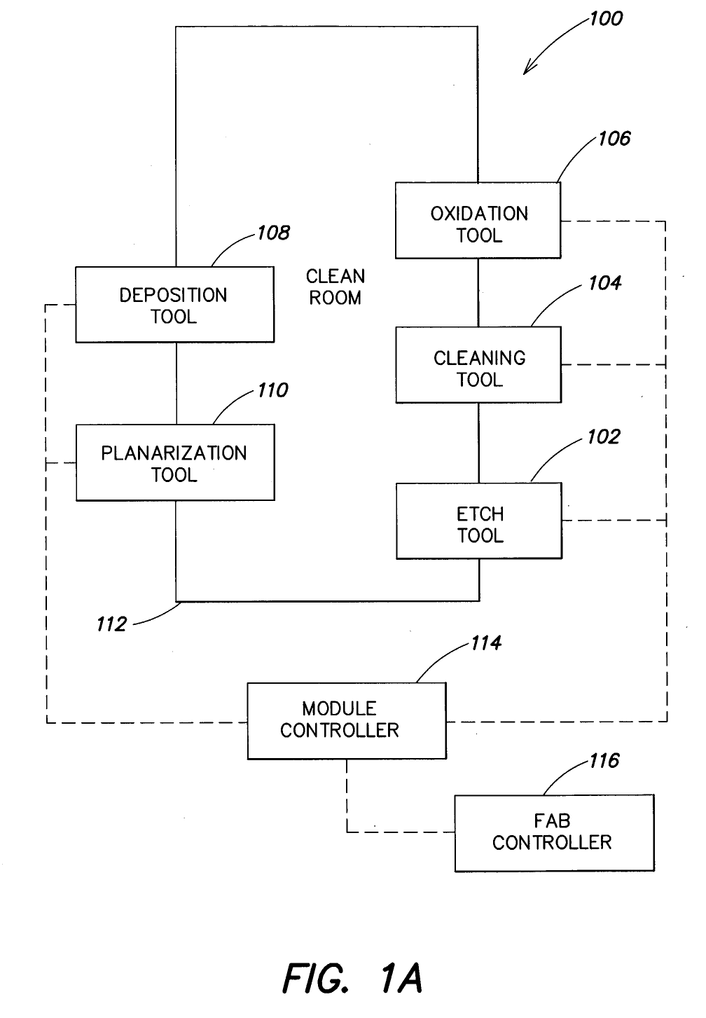

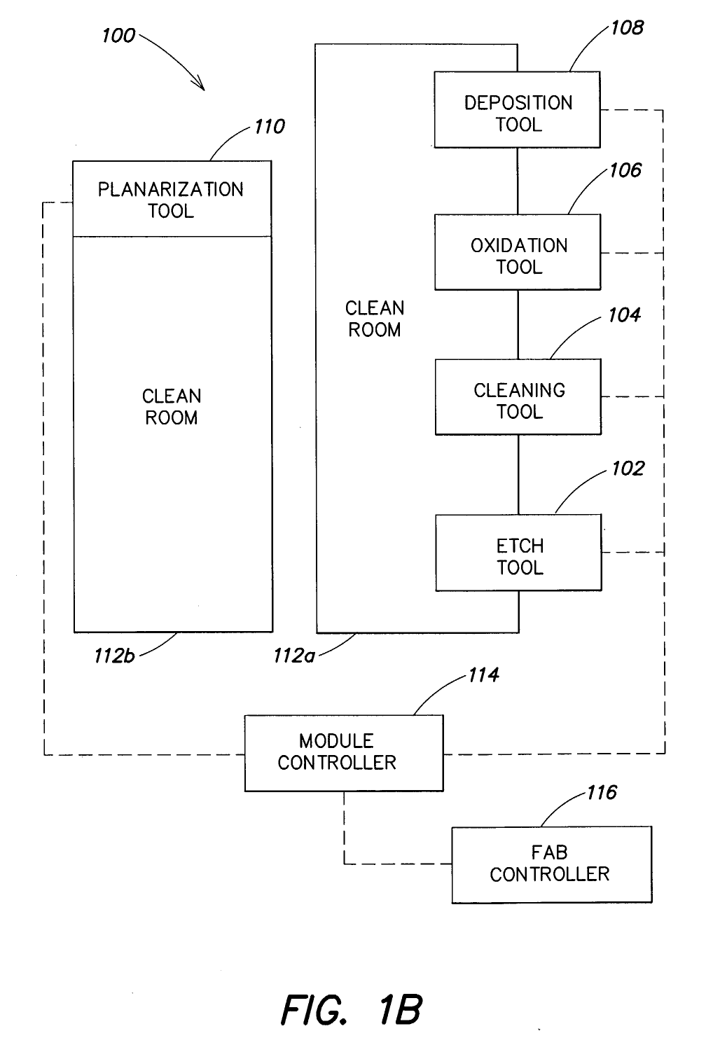

FIG. 1A is a schematic diagram of an inventive system 100 for forming shallow trench isolation regions in a substrate in accordance with the present invention. With reference to FIG. 1A, the inventive system 100 includes an etch subsystem (referred to as “etch tool 102”), a cleaning subsystem (referred to as “cleaning tool 104”), an oxidation subsystem (referred to as “oxidation tool 106”), a deposition subsystem (referred to as “deposition tool 108”), and a planarization subsystem (referred to as “planarization tool 110”) each located at least partially within a clean room 112. Each tool 102-110 is in communication with a module controller 114 which is in turn in communication with a fabrication (FAB) host/controller or manufacturing execution system (referred to as “FAB controller 116”), both described in more detail below. One or more of the tools 102-110 also may be in communication with the FAB controller 116. More than one module or FAB controller also may be employed, as may additional/redundant processing tools (e.g., additional/redundant etch tools, cleaning tools, oxidation tools, deposition tools, planarization tools, etc.).

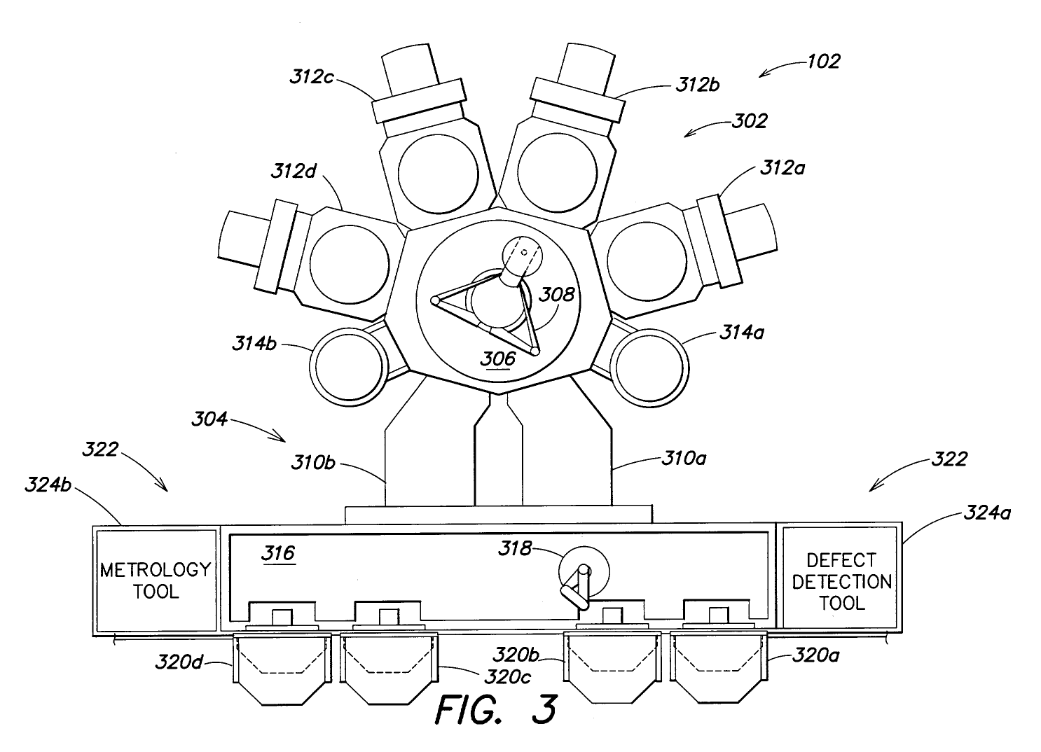

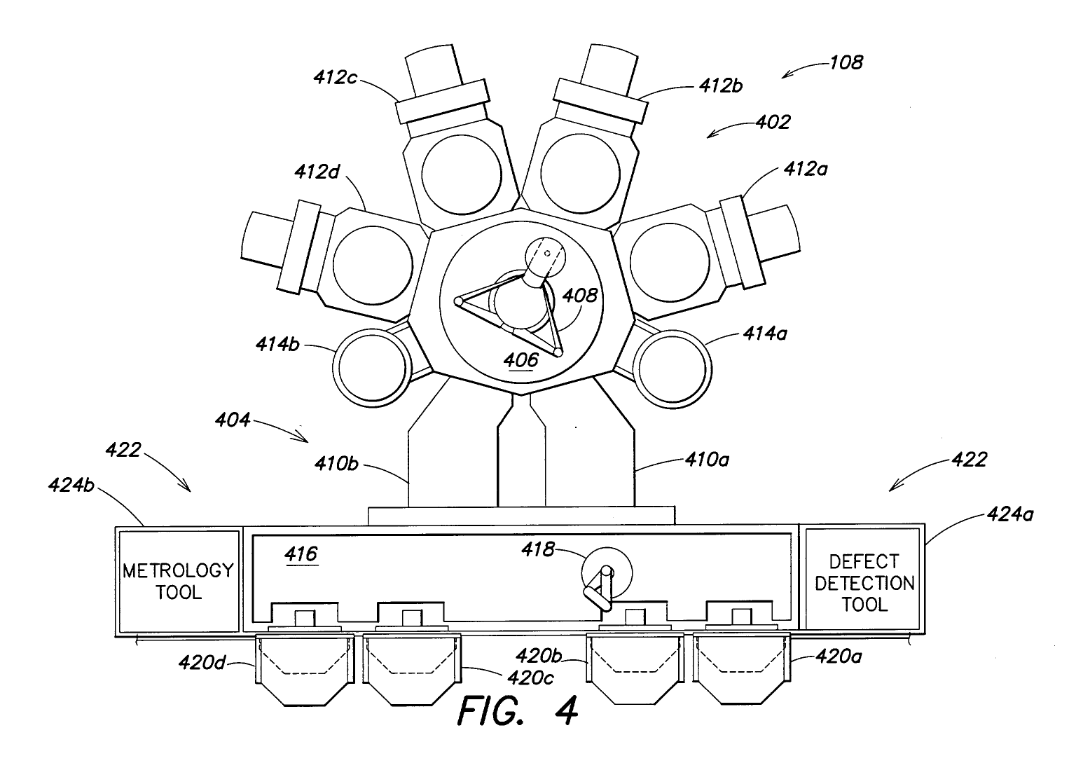

The etch tool 102 may comprise any apparatus capable of etching trenches within a substrate and that includes an integrated inspection system for inspecting substrates etched within the etch tool 102. One exemplary embodiment of the etch tool 102 is described below with reference to FIG. 3.

The cleaning tool 104 may comprise any conventional apparatus for cleaning a substrate such as a wet chemical cleaning station that employs dilute HF, de-ionized (DI) water rinsing, Marangoni drying, megasonic techniques and/or any combination thereof to clean a single substrate or a batch of substrates. Such cleaning tools are well known in the art and are not described in further detail herein.

The oxidation tool 106 may comprise any apparatus capable of producing a liner oxide within an STI trench formed by the etch tool 102. For example, the oxidation tool 106 may comprise a rapid thermal processing (RTP) tool such as the RTP Centura™ manufactured by Applied Materials Incorporated, although any other RTP or other oxide forming tool such as an oxidation furnace may be similarly employed.

The deposition tool 108 may comprise any apparatus capable of depositing a dielectric material (e.g., silicon dioxide) within an STI trench formed by the etch tool 102. One exemplary embodiment of the deposition tool 108 is described below with reference to FIG. 4.

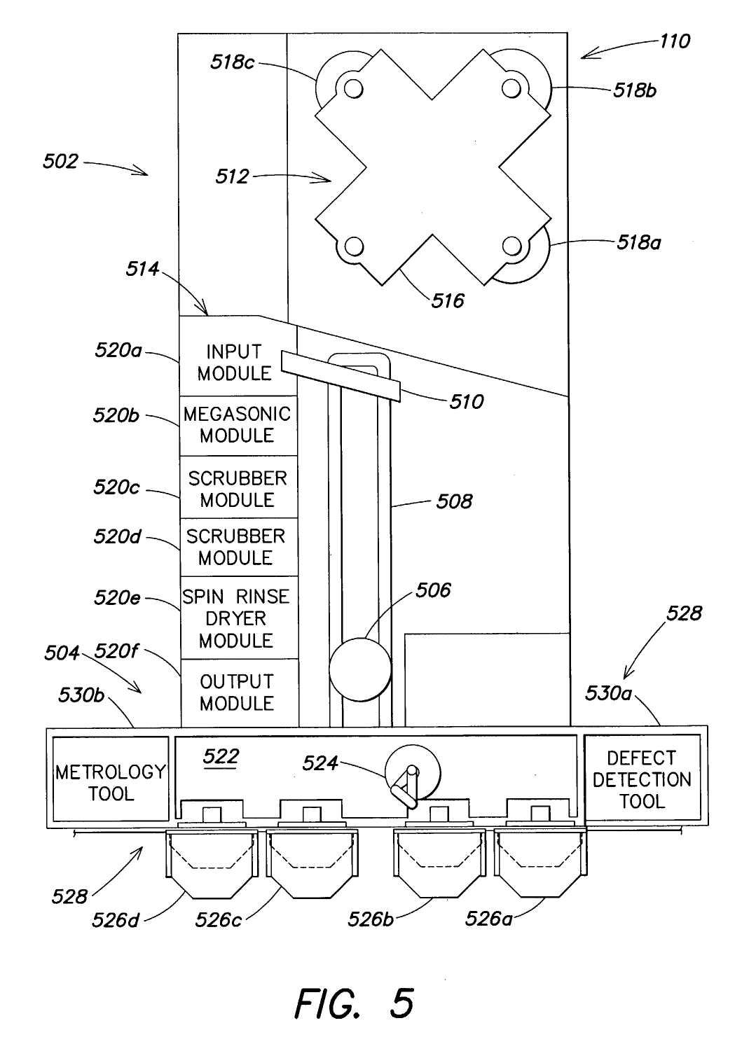

The planarization tool 110 may comprise any apparatus capable of planarizing a substrate following deposition of a dielectric layer on the substrate within the deposition tool 108. One exemplary embodiment of the planarization tool 110 is described below with reference to FIG. 5. The clean room 112 may comprise any suitable clean room facility such as a class 1 clean room.

Because a planarization tool may be a significant contamination source (e.g., due to the nature of chemical mechanical polishing), it may be preferable to employ a separate clean room for interfacing with the planarization tool 110. FIG. 1B illustrates an exemplary embodiment of the system 100 wherein the etch tool 102, the cleaning tool 104, the oxidation tool 106 and the deposition tool 108 are accessible via a first clean room 112a, and wherein the planarization tool 110 is accessible via a second clean room 112b. Substrates may be transferred between the two clean rooms 112a, 112b via any conventional mechanism (e.g., via a technician, a conveyor system, an automated guided vehicle, etc.). The clean rooms 112a, 112b may be of different classes.

System Module Controller and Programming

The FAB controller 116 may comprise any conventional fabrication controller, fabrication host or manufacturing execution system (MES) capable of administering process flow among a plurality of processing tools (as is known in the art), but that is configured to communicate with the module controller 114 for receiving communications therefrom (as described further below). The FAB controller 116, for example, may monitor wafer lots or lot numbers, work in progress, equipment quality, module quality, perform wafer/lot dispatching and document management, etc., and may be implemented as hardware, software or a combination thereof.

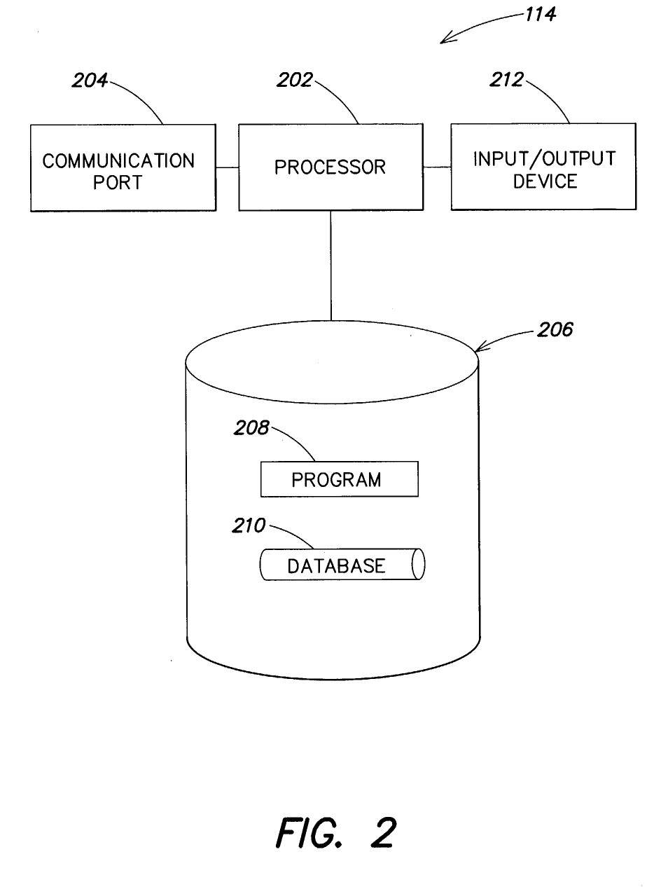

FIG. 2 is a schematic diagram of an exemplary embodiment of the module controller 114 of FIGS. 1A or 1B. The module controller 114 may be implemented as a system controller, as a dedicated hardware circuit, as an appropriately programmed general purpose computer, or as any other equivalent electronic, mechanical or electromechanical device.

With reference to FIG. 2 the module controller 114 comprises a processor 202, such as one or more conventional microprocessors (e.g., one or more Intel® Pentium® processors). The processor 202 is in communication with a communication port 204 through which the processor 202 communicates with other devices (e.g., with tools 102-110, with the FAB controller 116 and/or with any other relevant device). The communication port 204 may include multiple communication channels for simultaneous communication with, for example, the etch tool 102, the cleaning tool 104, the oxidation tool 106, the deposition tool 108, the planarization tool 110, the FAB controller 116 and/or any other relevant device.

Those skilled in the art will understand that devices in communication with each other need only be capable of communicating with each other and need not be continually transmitting data to or receiving data from each other. On the contrary, such devices need only transmit data to or receive data from each other as necessary, and may actually refrain from exchanging data most the time. Further, devices may be in communication even though steps may be required to establish a communication link.

The processor 202 also is in communication with a data storage device 206. The data storage device 206 may comprise an appropriate combination of magnetic, optical and/or semiconductor memory, and may include, for example, random access memory (RAM), read only memory (ROM), a compact disk, a floppy disk, a DVD, a hard disk, or any other storage medium. The processor 202 and the data storage device 206 each may be, for example, located entirely within a single computer or other computing device, or connected to each other by a communication medium, such as a serial port cable, a telephone line or a radio frequency transceiver. Alternatively, the module controller 114 may comprise one or more computers that are connected to a remote server computer (not shown).

In the exemplary embodiment of the module controller 114 shown in FIG. 2, the data storage device 206 may store, for example, (i) a program 208 (e.g., computer program code and/or a computer program product) adapted to direct the processor 202 in accordance with the present invention, and particularly in accordance with one or more of the processes described in detail below; and (ii) a database 210 adapted to store various information employed by the module controller 114 such as process recipes for one or more of the tools 102-110, algorithms for controlling the operation of one or more of the etch tool 102, the deposition tool 108 and the planarization tool 110 based on feedforward and/or feedback information as described further below, and/or any other relevant information (e.g., system status, processing conditions, process models, substrate history, metrology and/or defect data for each substrate, etc.). Note that rather than employing a database 210 to store process recipes, algorithms or the like, such information may be hard coded in the program 208.

The program 208 may be stored in a compressed, an uncompiled and/or an encrypted format, and may include computer program code that allows the module controller 114 to:

1. determine an etch process to perform within the etch tool 102 on a substrate (e.g., based on information about the substrate such as masking layer pattern density, based on information about a substrate previously processed within the etch tool 102, etc.);

2. direct the etch tool 102 to etch the substrate based on the etch process;

3. receive information about the etched substrate from an integrated inspection system of the etch tool 102;

4. determine a cleaning process to perform within the cleaning tool 104;

5. direct the cleaning tool 104 to clean the substrate;

6. determine an oxidation process to perform within the oxidation tool 106;

7. direct the oxidation tool 106 to form an oxide layer on the substrate based on the oxidation process;

8. determine a deposition process to perform within the deposition tool 108 (e.g., based on the information received from the inspection system of the etch tool 102 about the etched substrate, based on information regarding a substrate previously processed within the deposition tool 108, etc.);

9. direct the deposition tool 108 to deposit an insulating material on the substrate based on the deposition process;

10. receive information about the insulating material deposited on the substrate from an integrated inspection system of the deposition tool 108;

11. determine a planarization process to perform within the planarization tool 110 (e.g., based on the information received from the inspection system of the deposition tool 108 about the deposited insulating material, based on information obtained regarding a substrate previously processed within the planarization tool 110, etc.);

12. direct the planarization tool 110 to planarize the substrate based on the planarization process; and/or

13. receive information from an integrated inspection system of the planarization tool 110 regarding the substrate.

Numerous additional functions and/or processes may be performed via the module controller 114 as described further below.

The module controller 114 may include any peripheral devices (e.g., keyboards, computer displays, pointing devices, etc., represented generally as input/output device 212) required to implement the above functionality.

Note that instructions of the program 208 may be read into a main memory (not shown) of the processor 202 from a computer readable medium other than the data storage device 206 such as from a ROM or from a RAM. While execution of sequences of instructions in the program 208 causes the processor 202 to perform the process steps described herein, hardwired circuitry may be used in place of, or in combination with, software instructions for implementation of the processes of the present invention. Thus, embodiments of the present invention are not limited to any specific combination of hardware and software.

Etch Subsystem

FIG. 3 is a top plan view of an exemplary embodiment of the etch tool 102 of FIGS. 1A or 1B. With reference to FIG. 3, the etch tool 102 comprises a processing tool 302 coupled to a factory interface 304. The processing tool 302 includes a transfer chamber 306 which houses a first substrate handler 308. The transfer chamber 306 is coupled to a first loadlock 310a, a second loadlock 310b, a first etch chamber 312a, a second etch chamber 312b, a third etch chamber 312c, a fourth etch chamber 312d, a first auxiliary processing chamber 314a and a second auxiliary processing chamber 314b. Fewer or more etch chambers or auxiliary processing chambers may be employed, and the module controller 114 may communicate with and/or control the processes performed within each chamber.

Loadlock chambers 310a-b may comprise any conventional loadlock chambers capable of transferring substrates from the factory interface 304 to the transfer chamber 306. The etch chambers 312a-d may comprise any conventional processing chambers capable of etching STI trenches in a substrate. The auxiliary processing chambers 314a-b, if employed, may include, for example, cooldown chambers, substrate orientors, degas chambers, inspections chambers, ashing chambers or the like. In at least one embodiment of the invention, the processing tool 302 is a DPS silicon etch tool (based on a Centura™ platform) manufactured by Applied Materials, Inc. Any other etching system may be similarly employed.

The factory interface 304 includes a buffer chamber 316 which houses a second substrate handler 318 and which is coupled to a plurality of loadports 320a-d. It will be understood that in general, any number of substrate handlers may be located within the buffer chamber 316, and that any number of loadports may be coupled to the buffer chamber 316.

Integrated Inspection for Etch Subsystem

As shown in FIG. 3, the etch tool 102 includes an integrated inspection system 322. In the exemplary embodiment of FIG. 3, the integrated inspection system 322 includes a defect detection tool 324a and a metrology tool 324b both coupled to the buffer chamber 316 of the factory interface 304. Alternatively, the integrated inspection system 322 may include only one of the defect detection tool 324a and the metrology tool 324b, or may be coupled to the processing tool 302 rather than to the factory interface 304 (e.g., by coupling the defect detection tool 324a and/or the metrology tool 324b to the transfer chamber 306 such as at the location of one or more of the auxiliary processing chambers 314a-b).

Defect Detection for Etch Subsystem

The defect detection tool 324a may comprise any conventional defect detection tool capable of detecting and/or characterizing defects on a surface of a substrate. In at least one embodiment of the invention, the defect detection tool 324a comprises the Excite™ or IPM™ defect detection tool manufactured by Applied Materials, Inc. and described in U.S. patent application Ser. No. 09/110,870, filed Jul. 7, 1998 and titled “A PIXEL BASED MACHINE FOR PATTERNED WAFERS”, which is hereby incorporated by reference herein in its entirety. The defect detection tool 324a may, for example, merely provide a measure of defect density on a substrate surface or may provide detailed information about any detected defects such as defect characterization and/or classification information. The defect detection tool 324 may provide such information to the module controller 114.

Metrology for Etch Subsystem

The metrology tool 324b may comprise any conventional metrology tool capable of measuring STI trench depth, width, profile, and/or other critical dimension information. In at least one embodiment of the invention, the metrology tool 324b comprises a laser based metrology tool wherein laser light is scattered off of a substrate surface and analyzed to determine trench depth, trench profile, trench width and/or other critical dimension information as is known in the art.

The metrology tool 324b also may be configured to inspect a substrate prior to etching so as to determine the density of a patterned masking layer used to define STI trench regions. The metrology tool 324b can then provide information regarding the pattern masking layer to the module controller 114, and based on this information the module controller 114 may determine an appropriate etch process (e.g., a “baseline” etch process selected from a plurality of etch processes stored by the module controller 114) for the substrate as described further below.

Operation of Etch Subsystem

In operation, a cassette or “carrier” of substrates is delivered to the factory interface 304 of the etch tool 102. In particular, the substrate carrier is delivered to one of the loadports 320a-d. Each loadport 320a-d may or may not be configured with pod opening capability for opening sealed substrate carriers. Once the substrate carrier has been loaded into the appropriate loadport 320a-d of the factory interface 304, the substrate handler 318 retrieves a substrate from the substrate carrier and transfers the substrate to the first loadlock 310a. Thereafter the substrate handler 308 of the processing tool 302 retrieves the substrate from the first loadlock 310a and transfers the substrate to one of the etch chambers 312a-d. The substrate is then etched within the etch chamber (e.g., in accordance with one or more of the inventive processes described below) and is transferred to the second loadlock 310b. A patterned masking layer formed on the substrate (e.g., a patterned photoresist layer) used to define STI trenches during etching also may be removed within the etch chamber (as described below) before the substrate is transferred to the second loadlock 310b. An auxiliary ashing chamber (not shown) similarly may be used to remove the patterned masking layer. Prior to etching within the etch chamber and/or after etching within the etch chamber the substrate may be processed within one or both of the auxiliary processing chambers 314a-b (e.g., for substrate orientation purposes, for degassing, for cooldown, etc.).

The substrate handler 318 of the factory interface 304 retrieves the substrate from the second loadlock 310b and transfers the substrate to one of the defect detection tool 324a and the metrology tool 324b. Assuming the substrate is first transferred to the defect detection tool 324a, the defect detection tool 324a performs defect detection (e.g., determines the defect density on the surface of the substrate, identifies or otherwise characterizes defects on the surface of the substrate, etc.) and communicates information regarding the results of the defect detection to the module controller 114. The substrate handler 318 of the factory interface 304 retrieves the substrate from the defect detection tool 324a and transfers the substrate to the metrology tool 324b.

The metrology tool 324b analyzes the substrate to determine such information as trench depth, trench width, trench profile and/or other critical dimension information. The metrology tool 324b then provides this information to the module controller 114. The substrate handler 318 of the factory interface 304 retrieves the substrate from the metrology tool 324b and returns the substrate to a substrate carrier (located within one of the loadports 320a-d).

It will be understood that more than one substrate may be processed at a time within the etch tool 102. For example, while one substrate is being processed within the etch chamber 312a, up to three other substrates may be simultaneously processed within the etch chambers 312b-d. Likewise, substrates may be processed within the etch chambers 312a-d while defect detection is performed within the defect detection tool 324a or while metrology is performed within the metrology tool 324b on a different substrate. In this manner, because of the integrated nature of the defect detection tool 324a and the metrology tool 324b, defect detection measurements and/or metrology measurements have little affect on the throughput of the etch tool 102. Defect detection and/or metrology therefore may be performed on every substrate processed within the etch tool 102 (if desired). Further, substrates may be inspected via the defect detection tool 324a and/or the metrology tool 324b before being processed within one of the etch chambers 312a-d.

Either the module controller 114 or the FAB controller 116 may comprise computer program code for performing the various substrate transfer operations described above. The development of such computer program code is well within the ordinary skill in the pertinent art.

Deposition Subsystem

FIG. 4 is a top plan view of the deposition tool 108 of the inventive system 100 of FIGS. 1A and 1B. The deposition tool 108 is configured similarly to the etching tool 102 of FIG. 3.

With reference to FIG. 4, the deposition tool 108 comprises a processing tool 402 coupled to a factory interface 404. The processing tool 402 includes a transfer chamber 406 which houses a first substrate handler 408. The transfer chamber 406 is coupled to a first loadlock 410a, a second loadlock 410b, a first deposition chamber 412a, a second deposition chamber 412b, a third deposition chamber 412c, a fourth deposition chamber 412d, a first auxiliary processing chamber 414a and a second auxiliary processing chamber 414b. Fewer or more deposition chambers or auxiliary processing chambers may be employed, and the module controller 114 may communicate with and/or control the processes performed within each chamber.

Loadlock chambers 410a-b may comprise any conventional loadlock chambers capable of transferring substrates from the factory interface 404 to the transfer chamber 406. The deposition chambers 412a-d may comprise any conventional processing chambers capable of depositing a dielectric material for filling STI trenches in a substrate. The auxiliary processing chambers 414a-b, if employed, may include, for example, cooldown chambers, substrate orientors, degas chambers, inspections chambers or the like. In at least one embodiment of the invention, the processing tool 402 is an Ultima™ High Density Plasma (HDP) Chemical Vapor Deposition (CVD) tool (based on a Centura™ platform) manufactured by Applied Materials, Inc. Any other deposition system may be similarly employed such as a system based on an ozone and tetraethyl orthosilicate (TEOS) subatmospheric pressure chemical vapor deposition (SA-CVD) process or on any other deposition method capable of filling trenches with a dielectric film.

The factory interface 404 includes a buffer chamber 416 which houses a second substrate handler 418 and which is coupled to a plurality of loadports 420a-d. It will be understood that in general, any number of substrate handlers may be located within the buffer chamber 416, and that any number of loadports may be coupled to the buffer chamber 416.

Integrated Inspection for Deposition Subsystem

As shown in FIG. 4, the deposition tool 108 includes an integrated inspection system 422. In the exemplary embodiment of FIG. 4, the integrated inspection system 422 includes a defect detection tool 424a and a metrology tool 424b both coupled to the buffer chamber 416 of the factory interface 404. Alternatively, the integrated inspection system 422 may include only one of the defect detection tool 424a and the metrology tool 424b, or may be coupled to the processing tool 402 rather than to the factory interface 404 (e.g., by coupling the defect detection tool 424a and/or the metrology tool 424b to the transfer chamber 406 such as at the location of one or more of the auxiliary processing chambers 414a-b).

Defect Detection for Deposition Subsystem

The defect detection tool 424a may comprise any conventional defect detection tool capable of detecting and/or characterizing defects on a surface of a substrate. In at least one embodiment of the invention, the defect detection tool 424a comprises the Excite™ or IPM™ defect detection tool manufactured by Applied Materials, Inc. and described in previously incorporated U.S. patent application Ser. No. 09/110,870, filed Jul. 7, 1998. The defect detection tool 424a may, for example, merely provide a measure of defect density on a substrate surface or may provide detailed information about any detected defects such as defect characterization and/or classification information. The defect detection tool 424 may provide such information to the module controller 114.

Metrology for Deposition Subsystem

The metrology tool 424b may comprise any conventional metrology tool capable of measuring the thickness of a deposited dielectric layer or any other relevant parameter (e.g., deposited film uniformity). In at least one embodiment of the invention, the metrology tool 424b may comprise a reflectometry-based thickness measurement tool such as a NanoSpec 9000 or 9000B measurement tool manufactured by Nanometrics, or a Novascan 840, 2200 or 3000 measurement tool manufactured by Nova Measuring Instruments.

Operation of Deposition Subsystem

In operation, a substrate carrier is delivered to the factory interface 404 of the deposition tool 108. In particular, the substrate carrier is delivered to one of the loadports 420a-d. Each loadport 420a-d may or may not be configured with pod opening capability for opening sealed substrate carriers. Once the substrate carrier has been loaded into the appropriate loadport 420a-d of the factory interface 404, the substrate handler 418 retrieves a substrate from the substrate carrier and transfers the substrate to the first loadlock 410a. Thereafter the substrate handler 408 of the processing tool 402 retrieves the substrate from the first loadlock 410a and transfers the substrate to one of the deposition chambers 412a-d. A dielectric layer then is deposited on the substrate (e.g., in accordance with one or more of the inventive processes described below) and the substrate is transferred to the second loadlock 410b.

The substrate handler 418 of the factory interface 404 retrieves the substrate from the second loadlock 410b and transfers the substrate to one of the defect detection tool 424a and the metrology tool 424b. Assuming the substrate is first transferred to the defect detection tool 424a, the defect detection tool 424a performs defect detection (e.g., determines the defect density on the surface of the deposited layer, identifies or otherwise characterizes defects on the surface of the deposited layer, etc.) and communicates information regarding the results of the defect detection to the module controller 114. The substrate handler 418 of the factory interface 404 retrieves the substrate from the defect detection tool 424a and transfers the substrate to the metrology tool 424b.

The metrology tool 424b analyzes the substrate to determine such information as deposited layer thickness and/or uniformity and provides this information to the module controller 114. The substrate handler 418 retrieves the substrate from the metrology tool 424b and returns the substrate to a substrate carrier (located within one of the loadports 420a-d).

It will be understood that more than one substrate may be processed at a time within the deposition tool 108. For example, while one substrate is being processed within the deposition chamber 412a, up to three other substrates may be simultaneously processed within the deposition chambers 412b-d. Likewise, substrates may be processed within the deposition chambers 412a-d while defect detection is performed within the defect detection tool 424a or while metrology is performed within the metrology tool 424b on a different substrate. In this manner, because of the integrated nature of the defect detection tool 424a and the metrology tool 424b, defect detection measurements and/or metrology measurements have little affect on the throughput of the deposition tool 108. Defect detection and/or metrology therefore may be performed on every substrate processed within the deposition tool 108 (if desired).

Either the module controller 114 or the FAB controller 116 may comprise computer program code for performing the various substrate transfer operations described above. The development of such computer program code is well within the ordinary skill in the pertinent art.

Planarization Subsystem

FIG. 5 is a top plan view of an exemplary embodiment of the planarization tool 110 of FIGS. 1A or 1B. In general, the planarization tool 110 may comprise any tool or apparatus capable of planarizing a substrate as is known in the art and configured in accordance with the present invention as described below.

With reference to FIG. 5, the planarization tool 110 includes a processing tool 502 coupled to a factory interface 504. In the exemplary embodiment of FIG. 5, the processing tool 502 comprises a Mirra Mesa™ planarization tool manufactured by Applied Materials Incorporated (e.g., a 200 mm substrate planarization tool) and described in U.S. patent application Ser. No. 09/547,189, filed Apr. 11, 2000 and titled “METHOD AND APPARATUS FOR TRANSFERRING SEMICONDUCTOR SUBSTRATES USING AN INPUT MODULE”, which is hereby incorporated by reference herein in its entirety. It will be understood that any other planarization apparatus may be similarly employed (e.g., a Reflexion™ planarization tool manufactured by Applied Materials, Inc. for use with 300 mm substrates and described in U.S. patent application Ser. No. 09/244,456, filed Feb. 4, 1999 and titled “APPARATUS AND METHODS FOR CHEMICAL MECHANICAL POLISHING WITH AN ADVANCEABLE POLISHING SHEET”, which is hereby incorporated by reference herein in its entirety). The processing tool 502 includes a robot 506 that is movable along a track 508, an input shuttle 510, a polishing system 512 and a cleaning system 514. The polishing system 512 includes a load cup 516, a first polishing platen 518a, a second polishing platen 518b and a third polishing platen 518c. The cleaning system 514 includes an input module 520a, a megasonic module 520b, a first scrubber module 520c, a second scrubber module 520d, a spin rinse dryer module 520e and an output module 520f.

Factory interface 504 includes a buffer chamber 522, a substrate handler 524 located within the buffer chamber 522 and a plurality of loadports 526a-d coupled to the buffer chamber 522. An integrated inspection system 528 also is coupled to the buffer chamber 522 as shown. In general, any number of substrate handlers and/or loadports may be employed within the factory interface 504.

Integrated Inspection for Planarization Subsystem

In the exemplary embodiment of FIG. 5, the integrated inspection system 528 includes a defect detection tool 530a and a metrology tool 530b both coupled to the buffer chamber 522 of the factory interface 504. Alternatively, the integrated inspection system 528 may include only one of the defect detection tool 530a and the metrology tool 530b.

Defect Detection for Planarization Subsystem

The defect detection tool 530a may comprise any conventional defect detection tool capable of detecting and/or characterizing defects on a surface of a substrate. In at least one embodiment of the invention, the defect detection tool 530a comprises the Excite™ or IPM™ defect detection tool manufactured by Applied Materials, Inc. and described in previously incorporated U.S. patent application Ser. No. 09/110,870, filed Jul. 7, 1998. The defect detection tool 530a may, for example, merely provide a measure of defect density on a substrate surface or may provide detailed information about any detected defects such as defect characterization and/or classification information. The defect detection tool 530a may provide such information to the module controller 114.

Metrology for Planarization Subsystem

The metrology tool 530b may comprise any conventional metrology tool capable of measuring the planarity of a planarized substrate and/or the removal of all material to be planarized from a stop layer (e.g., the removal of all silicon dioxide from a silicon nitride stop layer). In at least one embodiment of the invention, the metrology tool 530b may comprise a reflectometry-based thickness measurement tool such as a NanoSpec 9000 or 9000B measurement tool manufactured by Nanometrics, or a Novascan 840, 2200 or 3000 measurement tool manufactured by Nova Measuring Instruments.

Operation of Planarization Subsystem

In operation, a substrate carrier is delivered to the factory interface 504 of the planarization tool 110. In particular, the substrate carrier is delivered to one of the loadports 526a-d. Each loadport 526a-d may or may not be configured with pod opening capability for opening sealed substrate carriers. Once the substrate carrier has been loaded into the appropriate loadport 526a-d of the factory interface 504, the substrate handler 524 retrieves a substrate from the substrate carrier and transfers the substrate to the robot 506. Thereafter the robot 506 transfers the substrate to the load cup 516 of the polishing system 512 via the track 508. The substrate is then polished within the polishing system 512 (e.g., in accordance with one or more of the inventive processes described below employing one or more of the polishing platens 518a-c) and is transferred to the input module 520a of the cleaning system 514 via the input shuttle 510.

The substrate is cleaned in the megasonic module 520b, scrubbed within one or both of the scrubber modules 520c-d and dried in the spin rinse dryer module 520e. The substrate then is transferred to the output module 520f and from the output module 520f to the substrate handler 524 (via the robot 506).

The substrate handler 524 transfers the substrate to one of the defect detection tool 530a and the metrology tool 530b. Assuming the substrate is first transferred to the defect detection tool 530a, the defect detection tool 530a performs defect detection (e.g., determines the defect density on the surface of the substrate, identifies or otherwise characterizes defects on the surface of the substrate, etc.) and communicates information regarding the results of the defect detection to the module controller 114. The substrate handler 524 retrieves the substrate from the defect detection tool 530a and transfers the substrate to the metrology tool 530b.

The metrology tool 530b analyzes the substrate to determine such information as surface planarity (and/or complete removal of the material to be planarized from a stop layer) and provides this information to the module controller 114. The substrate handler 524 retrieves the substrate from the metrology tool 530b and returns the substrate to a substrate carrier (located within one of the loadports 526a-d).

It will be understood that more than one substrate may be processed at a time within the planarization tool 110. For example, while one substrate is being processed within the polishing system 512 (e.g., on one platen), other substrates may be simultaneously processed within the polishing system 512 (e.g., on other platens) and/or cleaned within the cleaning system 514. Likewise, substrates may be processed within the polishing system 512 and/or the cleaning system 514 while defect detection is performed within the defect detection tool 530a or while metrology is performed within the metrology tool 530b on a different substrate. In this manner, because of the integrated nature of the defect detection tool 530a and the metrology tool 530b, defect detection measurements and/or metrology measurements have little affect on the throughput of the planarization tool 110. Defect detection and/or metrology therefore may be performed on every substrate processed within the planarization tool 110 (if desired).

Either the module controller 114 or the FAB controller 116 may comprise computer program code for performing the various substrate transfer operations described above. The development of such computer program code is well within the ordinary skill in the pertinent art.

First Exemplary Integrated Process and Operation of Integrated System and Method for Forming Shallow Trench Isolation Regions

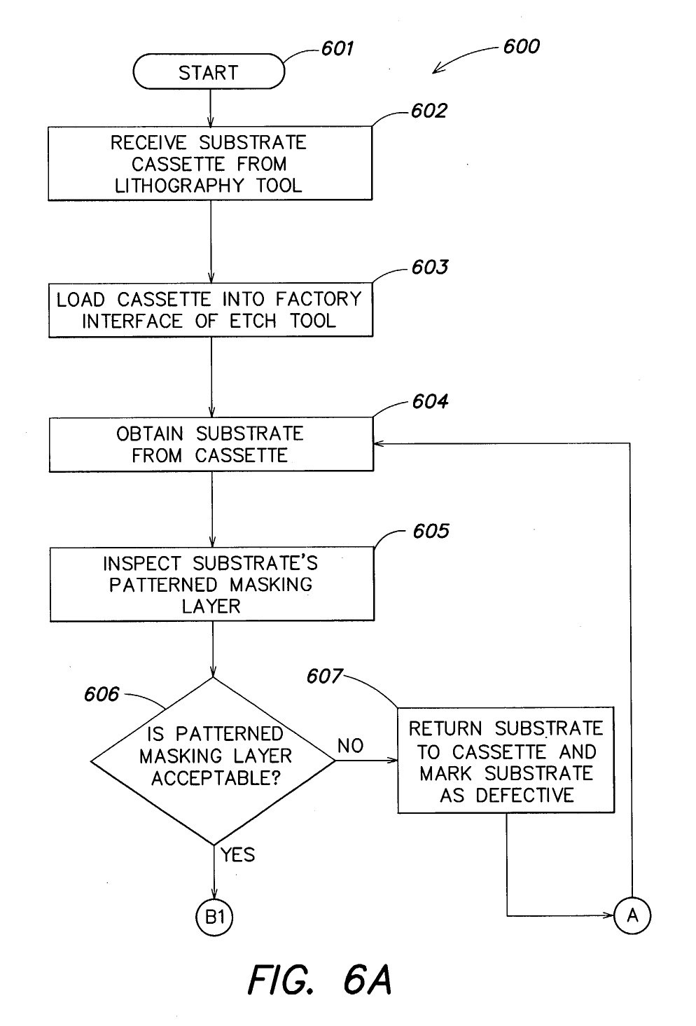

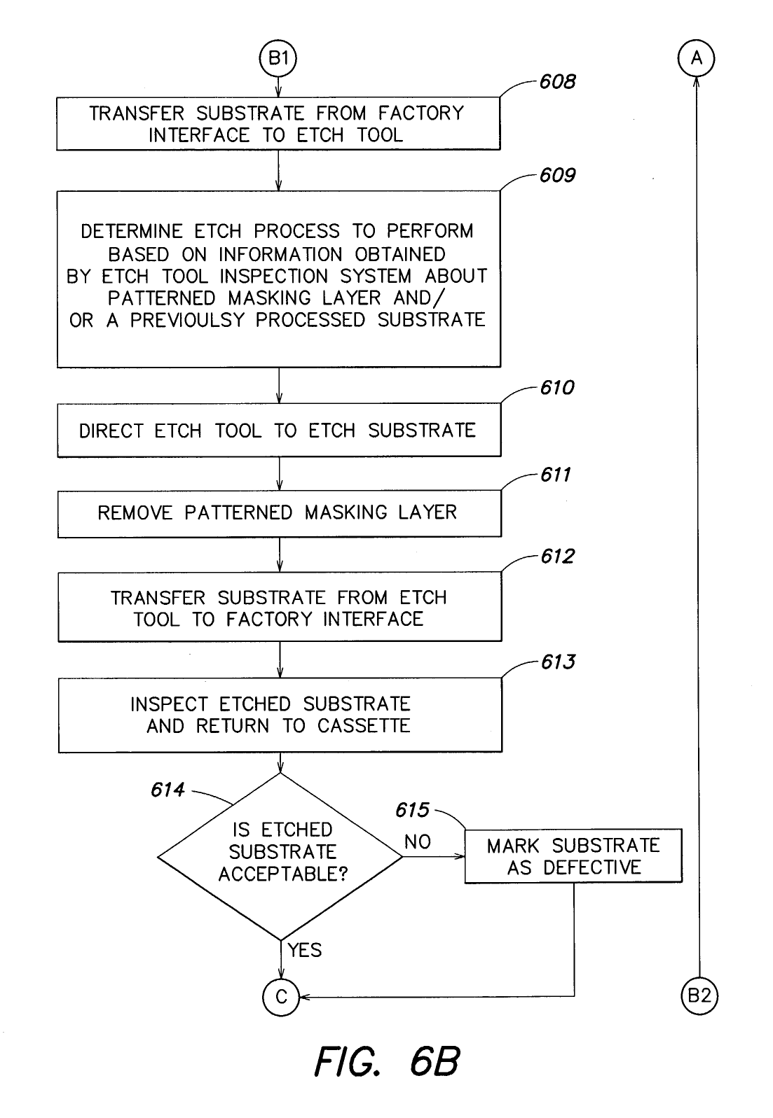

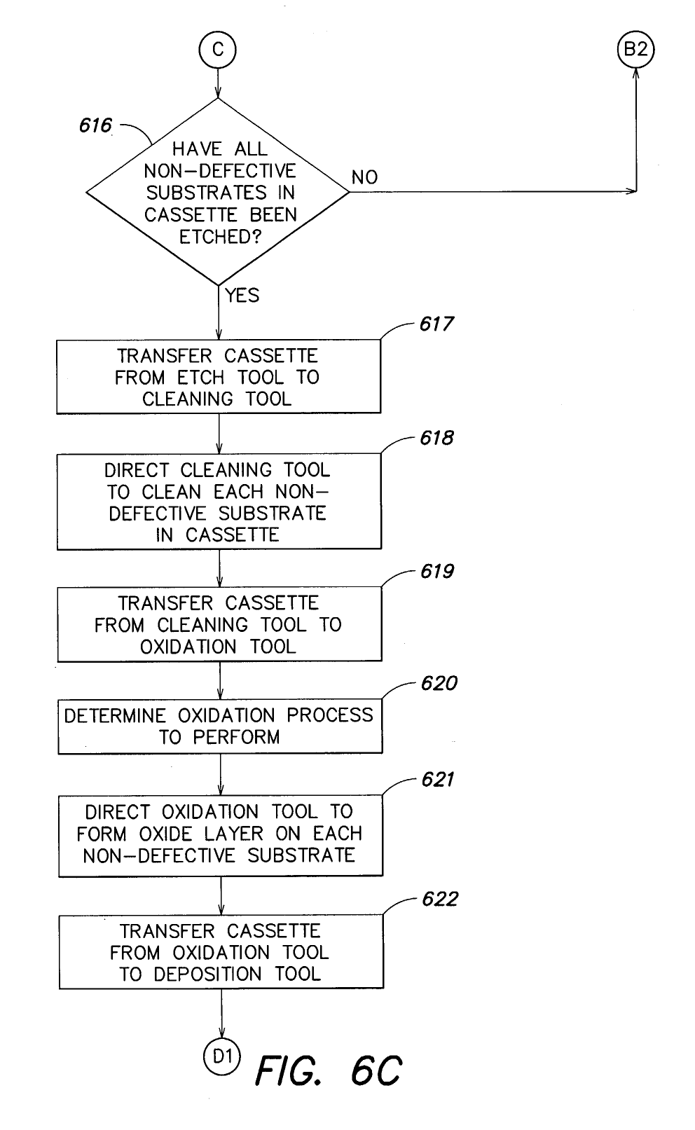

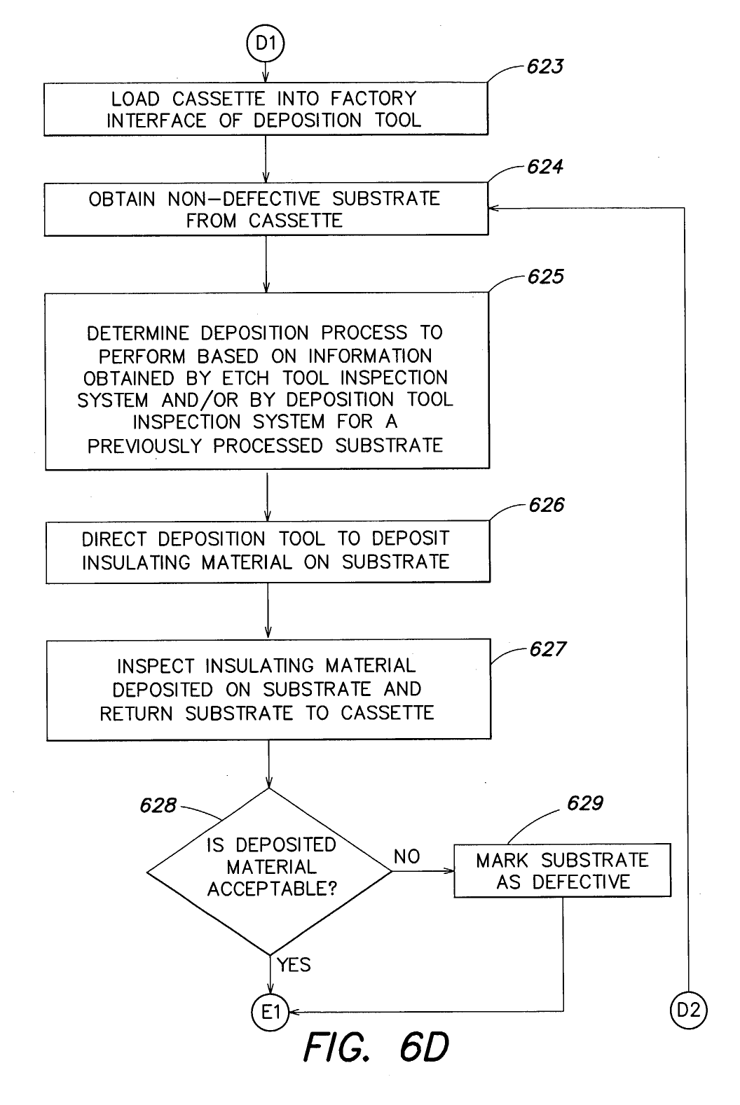

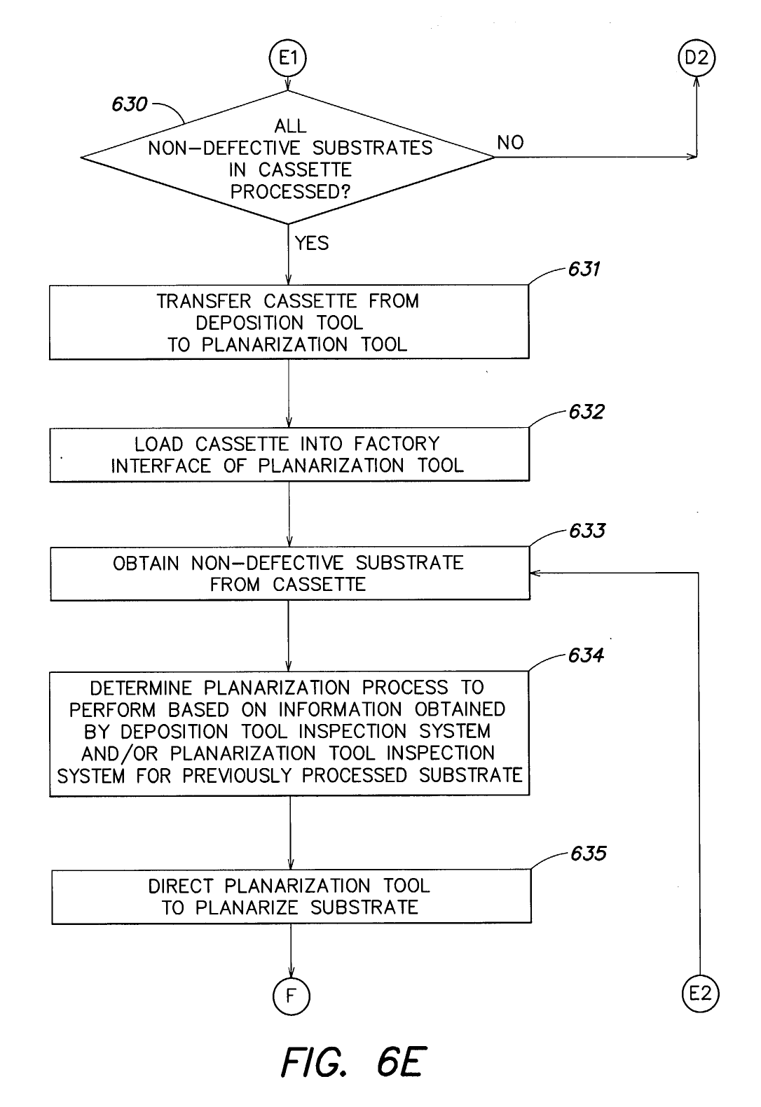

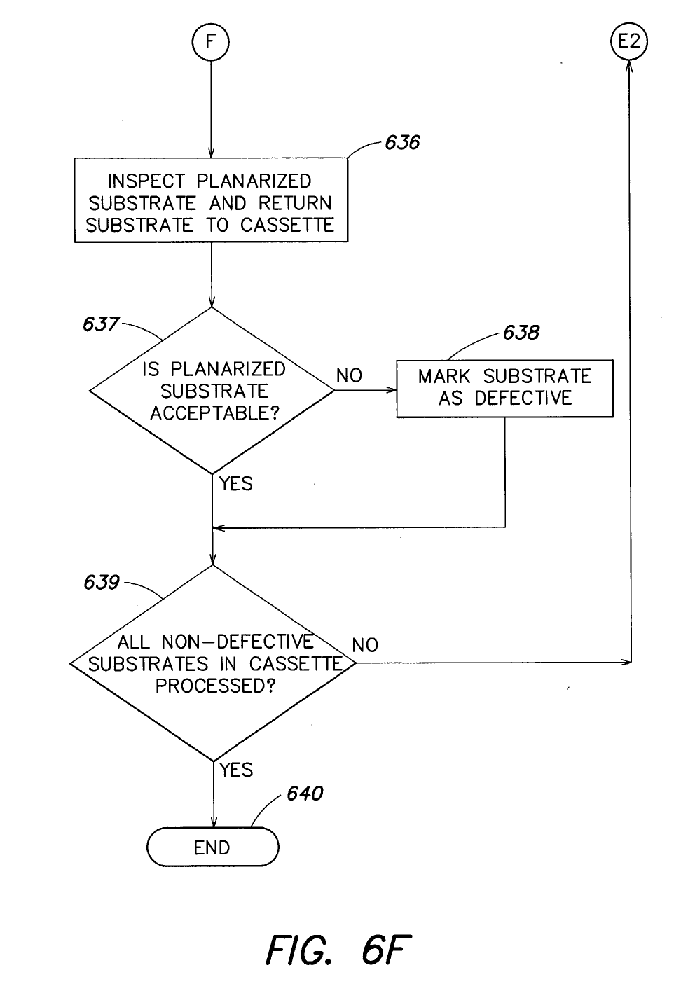

FIGS. 6A-F illustrate a flowchart of a first exemplary process 600 for forming shallow trench isolation (STI) regions in a substrate in accordance with the present invention. The first exemplary process 600 will be described with reference to FIGS. 1A-5, and FIGS. 7A-G which illustrate cross sectional views of a semiconductor substrate during formation of shallow trench isolation regions within the substrate.

With reference to FIGS. 6A-F, the first process 600 begins with step 601. In step 602 the inventive system 100 receives a substrate cassette from a lithography tool (not shown) such as the 550B lithography tool manufactured by ASM Lithography, Inc. (although any suitable lithography tool may be employed). The lithography tool may be located within the clean room 112 or the substrate cassette may be delivered to the clean room 112 via a delivery mechanism (e.g., an overhead conveyor system, an automated guided vehicle, etc.). In step 603, the substrate cassette is loaded into the factory interface 304 of the etch tool 102. For example, the substrate cassette may be loaded into one of the loadports 320a-d of the factory interface 304.

In step 604, the substrate is extracted from the substrate cassette and in step 605, a patterned masking layer (formed on the substrate by the lithography tool (not shown) and used to define the regions on the substrate where STI trenches are to be etched) is inspected via the integrated inspection system 322. Assuming the etch tool 102 of FIG. 3 is employed within the system 100, steps 604 and 605 may be performed by employing the substrate handler 318 to extract a substrate from the substrate cassette (located within one of the loadports 320a-d), and by transferring the substrate to the metrology tool 324b via the substrate handler 318. Thereafter the metrology tool 324b may inspect the substrate's patterned masking layer and may communicate information about the patterned masking layer to the module controller 114. For example, the metrology tool 324b may communicate information such as pattern density, patterned masking layer feature size, etc.

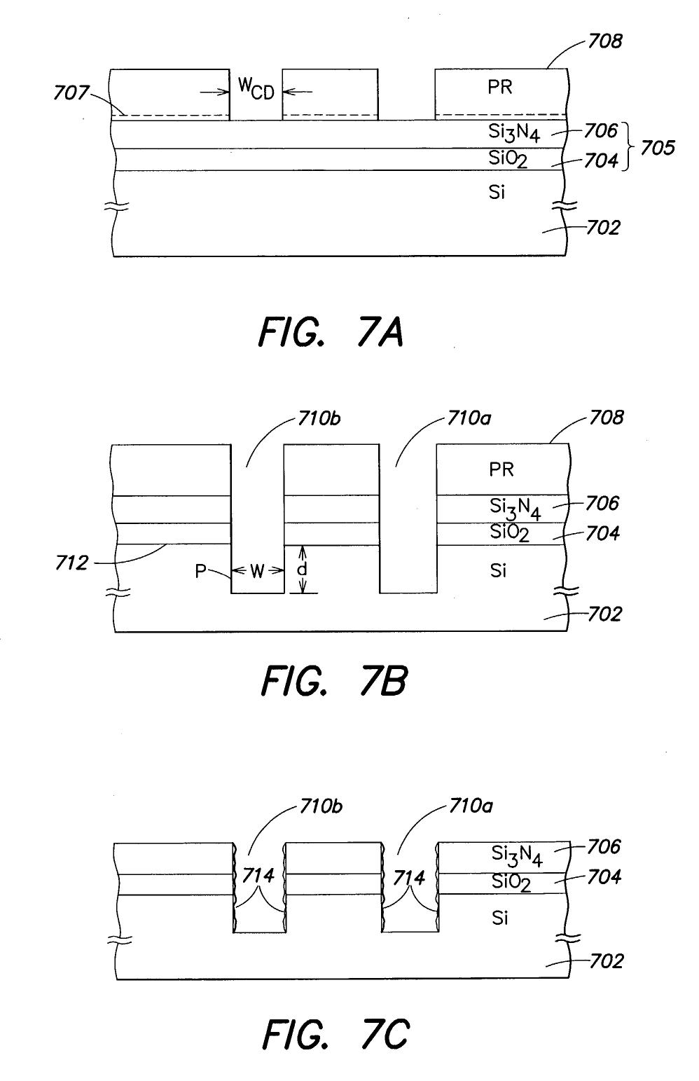

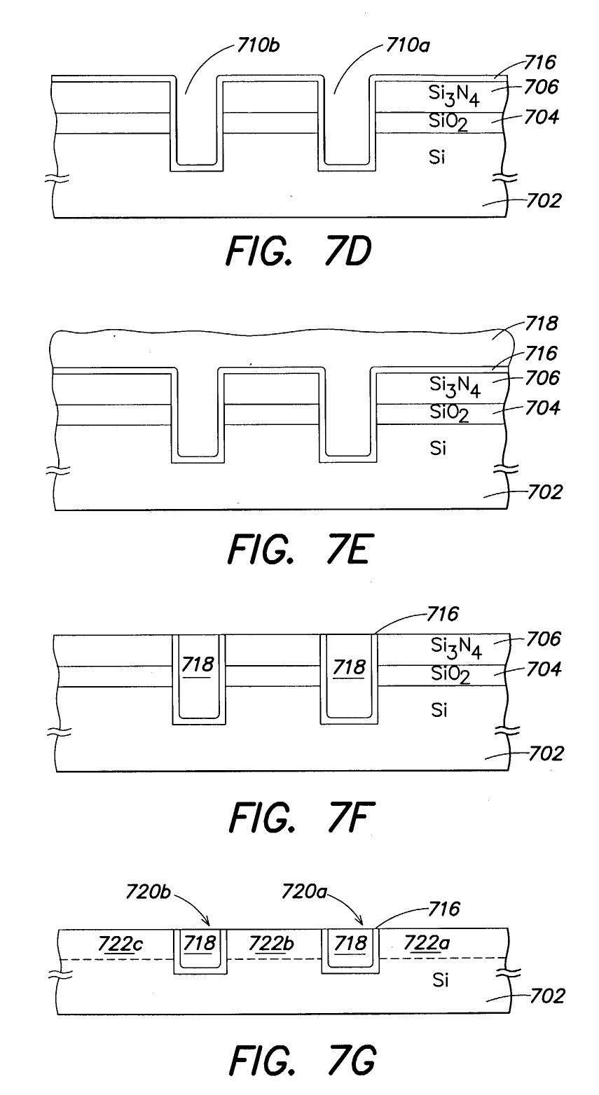

FIG. 7A illustrates an exemplary silicon substrate 702 having a patterned masking layer formed thereon. To form the structure of FIG. 7A, the silicon substrate 702 is oxidized to form a silicon dioxide layer 704 having a thickness of about 100 angstroms (e.g., by rapid thermal oxidation or some other known process). A silicon nitride layer 706 is then formed over the silicon dioxide layer 704. The silicon nitride layer 706 typically has a thickness of between about 1000 and 1500 angstroms, and may be formed by low pressure chemical vapor deposition (LPCVD) or any other known technique.

The silicon dioxide layer 704 and the silicon nitride layer 706 together form a hard mask layer 705. A dielectric antireflection coating (DARC) layer 707 (shown in phantom and in FIG. 7A only) also may be formed on the silicon nitride layer 706 to improve lithography performance as is known in the art (e.g., a silicon oxynitride film typically having a thickness of about 200-300 angstroms). A bottom antireflection coating (BARC) similarly may be employed (e.g., a polymer film typically having a thickness of about 300-600 angstroms and that may be etched in a chlorine/O₂ chemistry).

Thereafter a photoresist layer 708 is formed over the silicon nitride layer 706 and is patterned by conventional photolithography techniques as is known in the art. In particular, the photoresist layer 708 is exposed and developed so that portions of the underlying silicon nitride layer 706 are exposed and may be etched along with underlying portions of the silicon dioxide layer 704 and the substrate 702 to form STI trench regions as described further below.

With reference to FIGS. 6A-F, after information regarding the substrate's patterned masking layer has been communicated to the module controller 114 (in step 605), in step 606 the module controller 114 determines whether the patterned masking layer formed on the substrate is acceptable. For example, the module controller 114 may determine that the patterned masking layer (e.g., the patterned photoresist layer 708) is overpatterned (e.g., has features that will result in STI trenches that are too wide) or underpatterned (e.g., has features that will result in STI trenches that are too narrow). If the patterned masking layer on the substrate is not acceptable the substrate is returned to the substrate cassette and marked as a defective substrate (step 607); otherwise process 600 proceeds to step 608. Defective substrates, for example, may be sorted and returned to the lithography tool (not shown) for reprocessing after all substrates within the substrate cassette have been processed within the etch tool 102.

In step 608 the substrate is transferred from the factory interface 304 to one of the etch chambers 312a-d (e.g., via the substrate handler 308). In step 609, the module controller 114 determines an etch process to perform on the substrate within the appropriate etch chamber 312a-d based on the information obtained about the patterned masking layer formed on the substrate (e.g., pattern density information, dimensions and/or profile of features of the patterned masking layer which may influence etched trench dimensions/profile, etc.). This type of information constitutes one example of “feedforward” information. It will be understood that the etch process may be determined based on patterned masking layer information (or other feedforward information) at any time after the information is received from the metrology tool 324b.

The etch process alternatively or additionally may be based on information obtained from the integrated inspection system 322 for a substrate previously etched within one of the etch chambers 312a-d (e.g., information such as trench dimensions/profile that resulted for a given etch process). This type of information constitutes “feedback” information.

The module controller 114 may determine an etch process (or any other process described herein) in any suitable manner. For example, the module controller 114 may store (e.g., in the data storage device 206) a library of etch processes each of which has been optimized for a particular patterned masking layer density, feature dimensions, feature profile, etc. Based on feedforward information about the patterned masking layer, and/or based on other feedforward information, the module controller 114 may determine an etch process by selecting the “most optimal” process from the library of stored etch processes. Based on actual patterned masking layer density, feature dimensions, feature profile or other feedforward information, the module controller 114 may adjust various process parameters of a selected etch process to better match the characteristics of the substrate.

Exemplary process parameters that may be adjusted for an etch process include source power, substrate bias power, processing pressure, processing temperature, processing time, process gas flow rates, etc., which may affect one or more of trench dimensions (e.g., width or depth), trench profile, etch rate, etch uniformity, etc.

In one exemplary embodiment a BARC layer and a silicon nitride/silicon dioxide hard mask are employed (e.g., as shown in FIG. 7A). A Cl₂/O₂ etch process is employed to etch the BARC layer (e.g., ARC layer 707), and an SF₆/CHF₃/O₂ etch process is employed to etch the hard mask (e.g., hard mask 705) and to expose the underlying silicon substrate (e.g., substrate 702). Thereafter, a Cl₂/O₂ etch process is employed to etch the silicon substrate (e.g., substrate 702) so as to form STI trenches therein (as described further below with reference to FIG. 7B). In such an etch process, the module controller 114 may, for example, based on feedforward information about a patterned masking layer and/or feedback information about a previously etch substrate:

1. adjust trench dimensions/profile by adjusting SF₆, CHF₃ and/or O₂ flow rates, chamber pressure (e.g., processing pressure), etch time, source power, substrate bias power, etc., during hard mask etching; and/or

2. adjust trench dimensions/profile by adjusting CL₂ and/or O₂ flow rates, chamber pressure (e.g., processing pressure), etch time, source power, substrate bias power, etc., during BARC layer and/or silicon etching.

In another embodiment, the module controller 114 compares a dimension of a feature of a patterned masking layer (i.e., a feedforward feature dimension) to a target feature dimension (e.g., a desired or ideal feature dimension of a patterned masking layer). For example, the module controller 114 may compare the feedforward feature dimension to a range of acceptable feature dimensions or some other applicable control limit (CL), such as a device specification. Assuming the feedforward feature dimension is within the desired/acceptable range, the module controller 114 then may determine if an etch process suitable for etching a substrate having a patterned masking layer with the target feature dimension may be adjusted to correct for any deviation between the feedforward feature dimension and the target feature dimension (e.g., whether any required process adjustment is within the range or control limit of acceptable process adjustments). If so, then the module controller 114 may adjust the etch process accordingly.

Assuming the feedforward feature dimension is width (e.g., W_{CD} in FIG. 7A), if the feedforward feature width is smaller than the target feature width, then the module controller 114 may increase CHF₃ flow rate during hard mask etching to compensate for the small feature width. However, if the feedforward feature width of the patterned masking layer is larger than the target feature width, then the module controller 114 may compensate for the larger feature width by (1) increasing an overetch time during BARC layer etching; (2) decreasing CHF₃ flow rate during hard mask etching; (3) increasing SF₆ or O₂ flow rate during hard mask etching; and/or (4) decreasing chamber pressure during hard mask etching. Other techniques may be similarly employed.

In another embodiment, an etch process is determined based on feedback information regarding a previously etched substrate. An STI trench characteristic of the previously etched substrate (i.e., a feedback trench characteristic) is compared to a target trench characteristic (e.g., a desired or ideal trench characteristic). The module controller 114 then may determine an etch process based on the etch process used to etch the previous substrate (e.g., by adjusting certain etch parameters of the process). For example, assume the feedforward trench characteristic is trench width. If the feedforward trench width (of the previously etched substrate) is smaller than the target trench width, then the module controller 114 may increase trench width for subsequently etched substrates by (1) increasing CHF₃ flow rate and/or decreasing SF₆ flow rate during hard mask etching; (2) increasing bias power during hard mask and/or silicon etching; and/or (3) decreasing source power during hard mask and/or silicon etching. The module controller 114 may adjust the above parameters in the opposite direction to decrease trench width.

As another example, assume that the feedforward trench characteristic is trench profile. If the trench profile of the previously etched substrate is less vertical than the target trench profile, then the module controller 114 may increase trench profile angle for subsequently etched substrates by (1) decreasing CHF₃ flow rate and/or increasing SF₆ flow rate during hard mask etching; (2) increasing Cl₂/O₂ flow ratio during silicon etching; (3) increasing chamber pressure during silicon etching; and/or (4) decreasing bias power during silicon etching. The module controller 114 may adjust the above parameters in the opposite direction to decrease trench profile angle.

The module controller 114 may employ one or more algorithms (in addition to or in place of process libraries) for determining appropriate process parameters based on patterned masking layer density, feature dimensions, feature profile, or other feedforward information. Likewise one or more process parameters may be adjusted via algorithms based on feedback information regarding a substrate previously etched within the etch tool 102 (e.g., if previously formed STI trenches were too deep, too shallow, too narrow, too wide, had an undesirable profile, if a previously etched substrate had too high of a defect density, or some other undesirable characteristic).

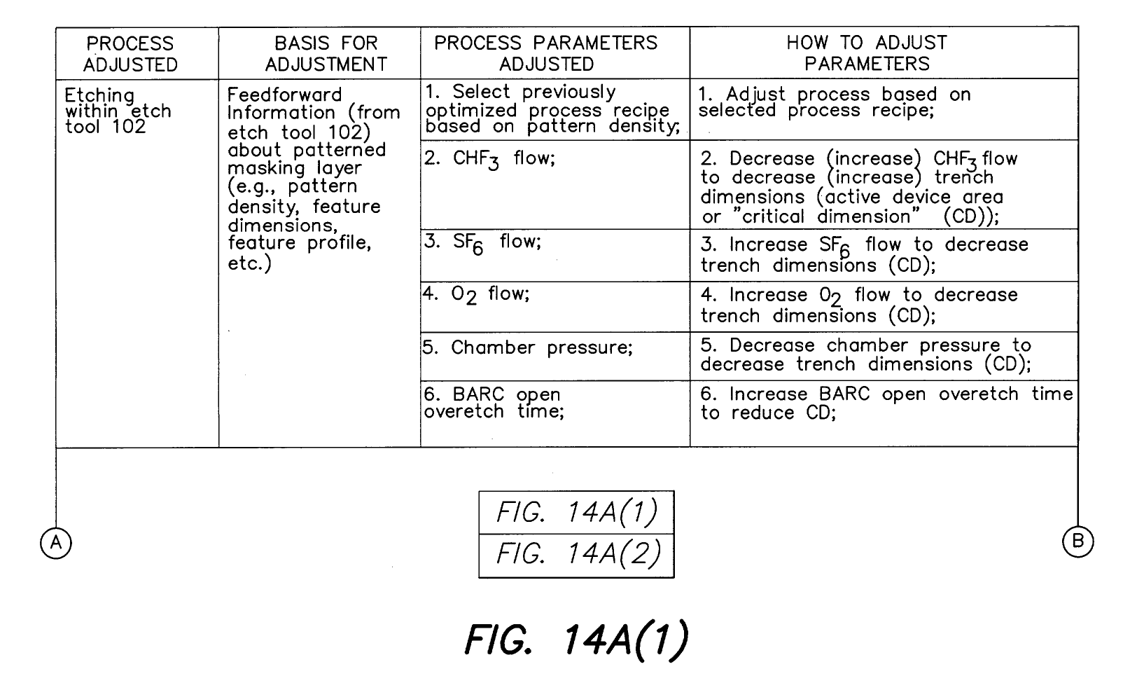

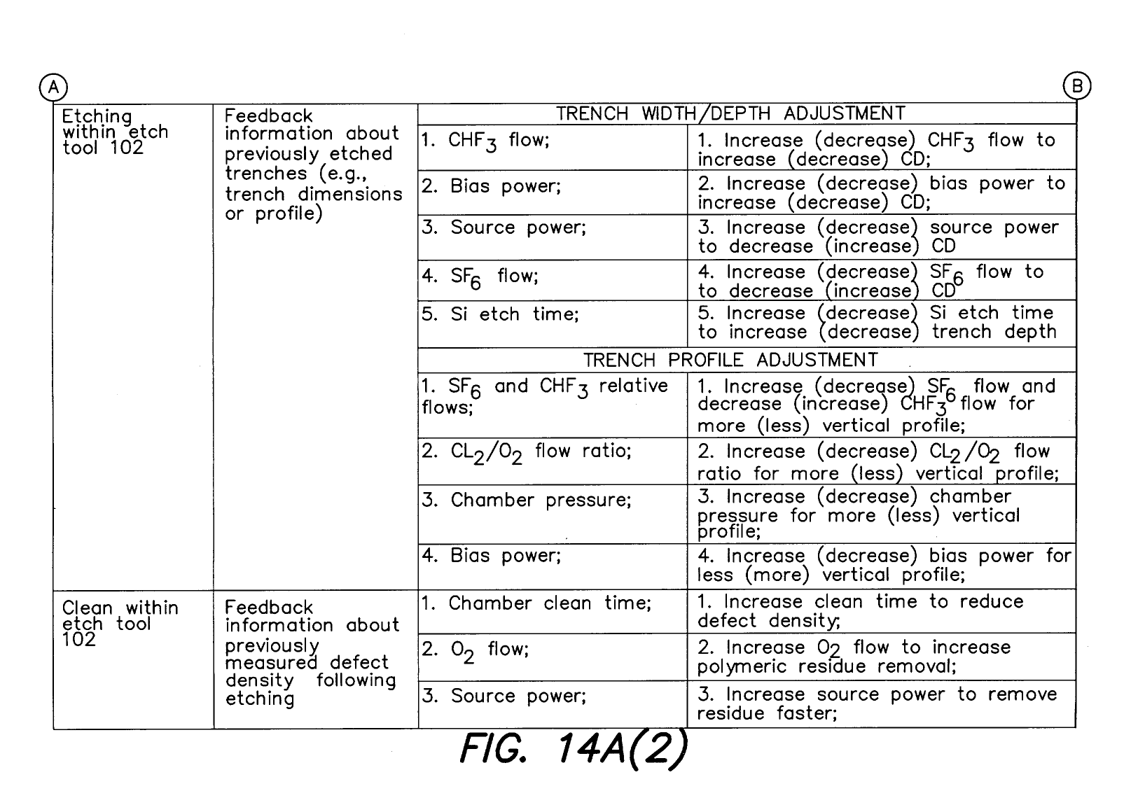

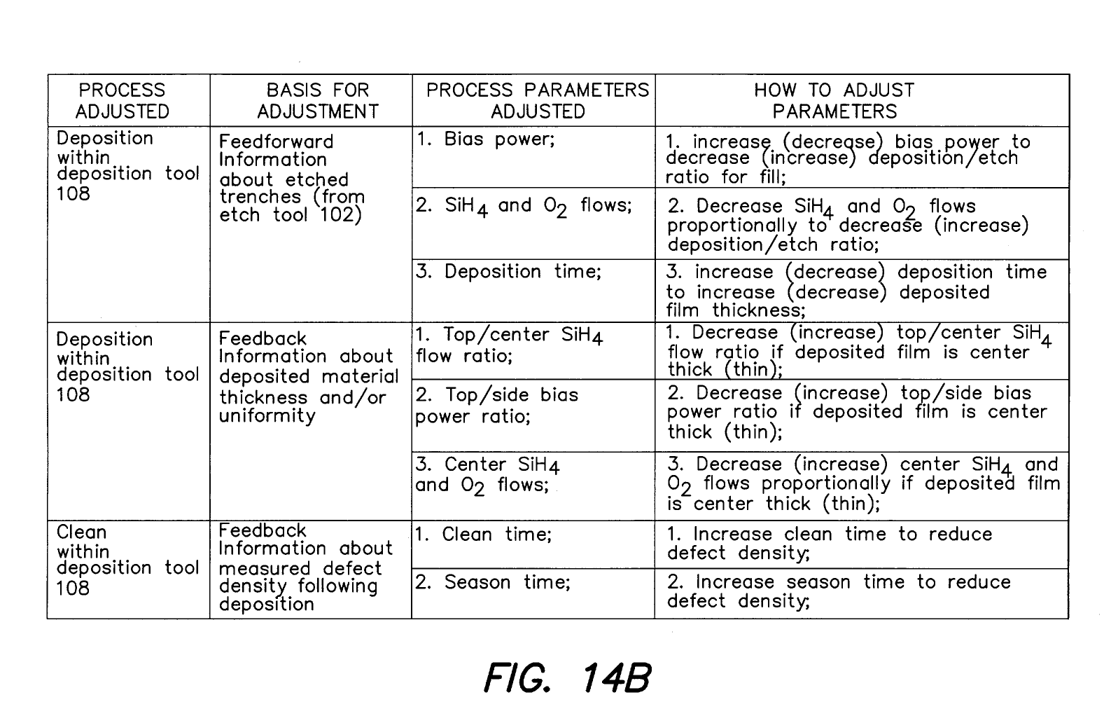

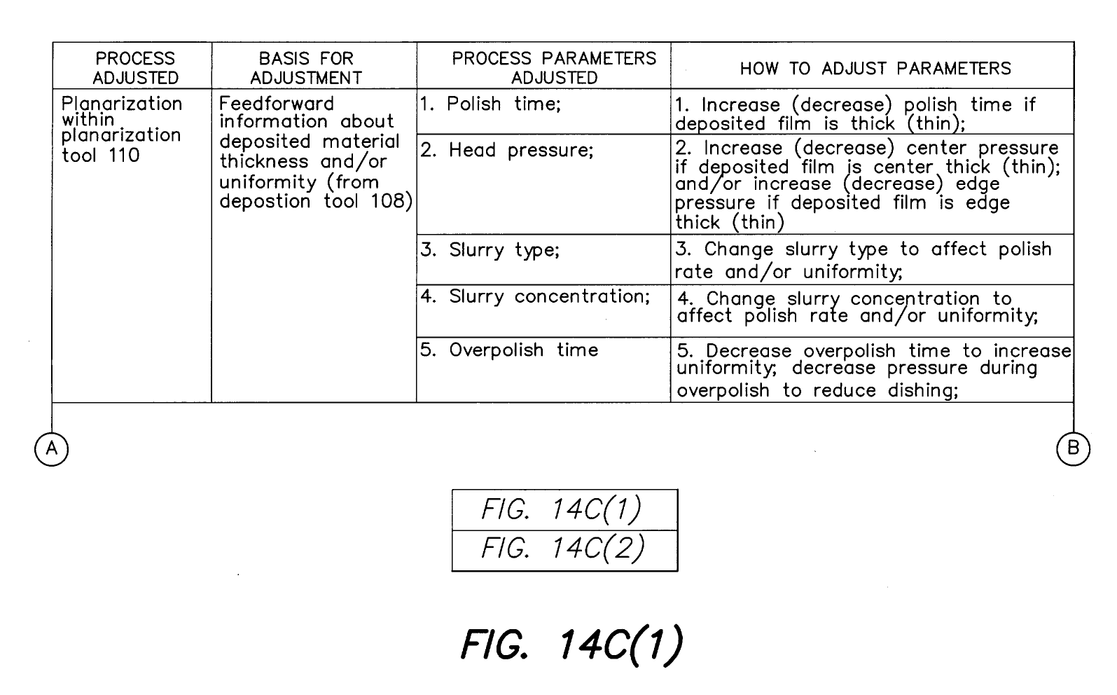

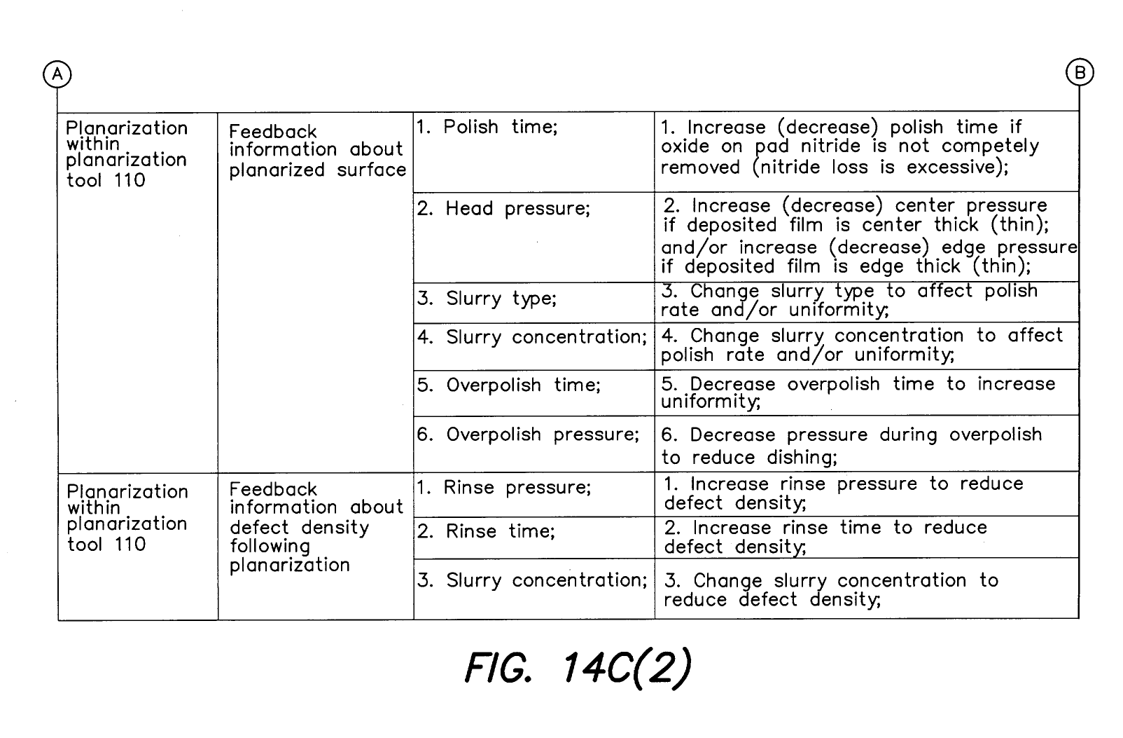

In one embodiment, feedback information regarding the defect density of a previously etched substrate may be employed to affect the length of time and/or how often an etch chamber is cleaned following etching or seasoned following chamber maintenance, O₂ flow or source power during patterned masking layer removal (e.g., during ashing), etc., so as to reduce defect density, polymeric residue and the like. FIGS. 14A(1) and 14A(2) illustrate exemplary process parameters of an etch process that may be adjusted based on feedforward and feedback information. These process parameters may be adjusted alone or in combination when determining an etch process.

It will be understood that information regarding a patterned masking layer present on a substrate may be used to affect other processing tools such as the lithography tool (not shown) used to define the patterned masking layer. For example, the module controller 114 (or some other module controller) may adjust, based on feedback information about the patterned masking layer formed by a given process, one or more parameters of the process to affect future patterned masking layer formation. Adjustable process parameters of a lithography tool used to form a patterned masking layer include, for example, dose of a lithographic process, exposure time, development time, masking layer deposition time, etc. Referring again to FIGS. 6A-F, once an etch process has been determined, in step 610, the module controller 114 directs the etch tool 302 to etch the substrate based on the etch process.

FIG. 7B illustrates the silicon substrate 702 of FIG. 7A after etching. As shown in FIG. 7B, etching of the silicon substrate 702 results in the formation of STI trench regions 710a, 710b (as well as other STI regions not shown). Each STI trench region 710a, 710b has a width W, a depth D and a profile P (e.g., shown as substantially vertical or perpendicular to a surface 712 of the substrate 702 for convenience purposes only).

In step 611, the module controller 114 directs the etch tool 102 to remove the patterned masking layer from the substrate. For example, if the patterned masking layer is formed from photoresist, any conventional technique may be employed to remove the patterned masking layer (e.g., such as the use of an oxygen plasma, often referred to as “ashing”). In general, ashing may be performed in-situ (e.g., within one of the etch chambers 312a-d, or ex-situ (e.g., within a separate ashing chamber (not shown)).

FIG. 7C illustrates the substrate 702 following removal of the patterned masking layer (photoresist layer 708). As shown in FIG. 7C, following removal of the patterned masking layer, the silicon dioxide layer 704 and the silicon nitride layer 706 remain. Additionally, when photoresist is employed as the masking layer, residual polymeric material 714 may remain on the sidewalls of the trench regions 710a, 710b (which may subsequently be removed via the cleaning tool 104 as described further below).

In step 612, the substrate is transferred from one of the etch chambers 312a-d to the factory interface 304, and in step 613 the substrate is inspected via the integrated inspection system 322. For example, the substrate may be inspected via the defect detection tool 324a to determine the number of defects present on the surface of the substrate following etching and/or may be inspected within the metrology tool 324b to determine the depth of the STI trenches formed within the substrate, as well as trench profile, trench width, and/or any other critical dimension information. Information regarding the substrate is communicated to the module controller 114.

In step 614 the module controller 114 determines whether the etched substrate is acceptable (e.g., if the defect level on the surface of the substrate is within an acceptable limit, if the trenches formed within the substrate have acceptable depths, widths, profiles, etc.). If the etch substrate is not acceptable, in step 615, the module controller 114 marks (e.g., records that) the substrate is defective and the process 600 proceeds to step 616; otherwise following step 614, the process 600 proceeds directly to step 616.

In step 616, the module controller 114 determines if all non-defective substrates in the substrate cassette have been etched. If all non-defective substrates in the substrate cassette have not been etched, the process 600 returns to step 604 to obtain another substrate from the cassette to etch as described previously; otherwise the process 600 proceeds to step 617.

Following etching of all substrates within the substrate cassette, in step 617 the substrate cassette is transferred from the etch tool 102 to the cleaning tool 104 (e.g., via a technician, an automated guided vehicle, an overhead carrier system, etc.). Thereafter, in step 618, the module controller 114 directs the cleaning tool 104 to clean each non-defective substrate within the substrate cassette using conventional cleaning techniques. For example, one or more wet cleaning techniques may be used that employ dilute hydrofluoric acid, Marangoni drying, megasonic cleaning, etc., whether done on a single substrate or on a batch of substrates. The cleaning tool 104 may be employed to remove any residual polymeric material that remains following removal of the patterned masking layer (e.g., polymeric material 714 shown in FIG. 7C).

In step 619 the substrate cassette is transferred from the cleaning tool 104 to the oxidation tool 106. In step 620, the module controller 114 determines an oxidation process to perform on the etched substrates contained within the substrate cassette, and in step 621 the module controller 114 directs the oxidation tool 106 to form an oxide layer (e.g., a liner oxide) on each non-defective substrate within the substrate cassette. Any conventional technique may be employed to form the oxide layer. For example, the oxide layer may be formed by rapid thermal oxidation, growth or any other known technique.

FIG. 7D illustrates the silicon substrate 702 following formation of an oxide layer thereon in accordance with step 621. With reference to FIG. 7D, an oxide liner layer 716 is formed over the silicon nitride layer 706 and the bottom and side walls of each STI trench 710a, 710b. In the exemplary structure of FIG. 7D, the oxide liner layer 716 comprises approximately 100 to 200 angstroms of silicon dioxide.

Following step 621, in step 622 the substrate cassette is transferred from the oxidation tool 106 to the deposition tool 108. In step 623 the substrate cassette is loaded into the factory interface 404 of the deposition tool 108. In step 624, a non-defective substrate is obtained from the substrate cassette (e.g., via the substrate handler 418) and is transferred to one of the deposition chambers 412a-d (e.g., via the substrate handler 408).

In step 625, the module controller 114 determines a deposition process to perform on the substrate based on information obtained from the integrated inspection system 322 of the etch tool 102 and/or based on information obtained from the integrated inspection system 422 of the deposition tool 108 for a substrate previously processed within one of the deposition chambers 412a-d. For example, when step 613 is performed on an etched substrate as previously described, module controller 114 receives information about the STI trenches formed within the substrate (e.g., trench depth, trench width, trench profile, etc.) and stores this information (e.g., within the data storage device 206) for the substrate. During step 625, the module controller 114 may retrieve this information for the substrate to be processed, and based on the actual dimensions and/or profile of the trenches formed within the substrate may select the appropriate deposition process to be performed on the substrate (e.g., the thickness of the dielectric layer that must be deposited on the substrate in order to adequately fill each STI trench of the substrate). Additionally, and as described further below, following deposition of a dielectric layer within the deposition tool 108, the integrated inspection system 422 of the deposition tool 108 inspects the deposited dielectric layer (e.g., to determine defect density, deposited layer thickness, etc.) and communicates information about the deposited dielectric layer to the module controller 114. Based on this information the module controller 114 may modify the process parameters used within one or more of the deposition chambers 412a-d.

As with the etch processes, the module controller 114 may store a library of deposition processes each of which has been optimized for a particular STI trench density, dimension, aspect ratio, profile, etc. Based on feedforward information about the STI trenches on which a dielectric layer is to be deposited, the module controller 114 may select a deposition process and/or vary process parameters accordingly. Likewise one or more process parameters of a stored deposition process may be adjusted based on feedback information regarding a dielectric layer previously deposited on a substrate (e.g., if the previously deposited layer was too thin, too thick, has too high of a defect density or some other desirable characteristics). Algorithms may be employed to determine such process parameters.

Exemplary process parameters that may be adjusted for a deposition process based on feedforward information (e.g., STI trench information) and/or feedback information (e.g., information about a previously deposited dielectric layer) include, for example, source power, substrate bias power, processing pressure, processing temperature, deposition time, process gas flow rates, etc., which may affect one or more of refractive index, reflectivity, thickness, defect density and uniformity of the deposited layer. The above process parameters may be adjusted alone or in combination when determining a deposition process to perform. FIG. 14B summarizes exemplary process parameters that may be adjusted to affect deposition.

In one exemplary process the dielectric layer deposited within the deposition tool 108 is silicon dioxide deposited via the reaction of SiH₄ and O₂. The silicon dioxide layer is deposited within a high density plasma (HDP) chemical vapor deposition (CVD) chamber having independently controllable top/center process gas flow rates and independently controllable top/side substrate bias powers (e.g., the Ultima™ HDP CVD chamber manufactured by Applied Materials, Inc.). In such a deposition process and chamber, the module controller 114 may adjust, for example:

1. one or more of SiH₄ and O₂ flow rates, substrate bias power and deposition time to affect deposition thickness; and

2. one or more of top/center SiH₄ flow ratio, top/side substrate bias power ratio and center SiH₄ and O₂ flow rates to affect deposition uniformity.

Feedback information regarding defect density of a previously deposited dielectric layer may be employed, for example, to affect chamber clean time or chamber season time (e.g., to reduce defect density).

In another embodiment, a deposition process is determined based on feedforward information regarding STI trenches etched within a substrate. A dimension of an STI trench of a substrate on which a dielectric layer is to be deposited (i.e., a feedforward trench dimension) is compared to a target trench dimension (e.g., a desired or ideal trench dimension). Based on this comparison, the module controller 114 may determine if a deposition process suitable for deposition on a substrate having trenches of the target trench dimension may be adjusted to correct for any deviation between the feedforward trench dimension and the target trench dimension. For example, if the actual STI trench of a substrate (on which a dielectric layer is to be deposited) is deeper and/or narrower than a target STI trench, then the module controller 114 may compensate for the deeper and/or narrower trench by decreasing a deposition to etch ratio of a deposition process (e.g., by increasing substrate bias power and/or decreasing SiH₄ and O₂ flows proportionally). The module controller 114 may perform the opposite adjustment if the actual STI trench is shallower and/or wider than the target STI trench. If the actual STI trench is deeper than the target STI trench, then the module controller 114 may compensate for the deeper trench by increasing deposited film thickness (e.g., by increasing deposition time and/or SiH₄ and O₂ flows proportionally). Other techniques may be similarly employed.

In another embodiment, a deposition process is determined based on feedback information regarding a previously deposited dielectric layer. A thickness of a previously deposited dielectric layer (i.e., a feedback dielectric layer thickness) is compared to a target thickness. The module controller 114 then may determine a deposition process based on the deposition process used to deposit the previously deposited dielectric layer (e.g., by adjusting certain deposition parameters of the process). For example, if the feedback dielectric layer thickness is thinner than the target thickness, then the module controller 114 may increase deposited layer thickness by (1) increasing deposition time; and/or (2) increasing SiH₄ and O₂ flow rates proportionally. The module controller 114 may adjust the above parameters in the opposite direction to decrease dielectric layer thickness.

A uniformity of a previously deposited dielectric layer also may be compared to a target uniformity. Based on this comparison, the module controller 114 may determine a deposition process based on the deposition process used to deposit the previously deposited dielectric layer (e.g., by adjusting certain deposition parameters of the process). For example, if the previously deposited dielectric layer is too thick in its center (i.e., center thick), then the module controller 114 may decrease center thickness by (1) reducing the top SiH₄ flow; and/or (2) reducing the top/side source power ratio of the deposition process. Likewise, if the previously deposited dielectric layer is too thin in its center (i.e., center thin), then the module controller 114 may increase center thickness by (1) increasing the center SiH₄ and O₂ flows proportionally; and/or (2) increasing the top/side source power ratio of the deposition process.

Referring again to FIGS. 6A-F, once a deposition process has been determined, in step 626, the module controller 114 directs the deposition tool 108 to deposit a dielectric layer (e.g., an electrically insulating layer) on the substrate (e.g., in accordance with the process determined in step 625). FIG. 7E illustrates the silicon substrate 702 following deposition of a silicon dioxide filler layer 718 (a dielectric/electrically insulating layer) within one of the deposition chambers 412a-d. In the exemplary embodiment of FIG. 7E, the oxide filler layer 718 comprises approximately 1000 to 2000 angstroms of silicon dioxide extending above each filled trench. The silicon dioxide layer 718 may be formed by any known deposition technique such as high density plasma chemical vapor deposition.

In step 627 the substrate is unloaded from the appropriate deposition chamber 412a-d is transferred to the integrated inspection system 422 of the factory interface 404, is inspected, and is returned to the substrate cassette. For example, the defect detection tool 424a may analyze the surface of the deposited layer to determine the defect density and/or to characterize defects present on the surface of the deposited layer. The metrology tool 424b also may determine the thickness of the deposited layer and/or other material parameters (e.g., refractive index, film density, film quality, etc., as is known in the art). The above information is communicated to the module controller 114.

In step 628, the module controller 114 determines whether the material layer deposited on the substrate is acceptable (e.g., has the proper thickness, the proper material properties, a low enough defect density, etc.). If the deposited layer is not acceptable, in step 629 the substrate is marked as defective and the process 600 proceeds to step 630; otherwise the process 600 proceeds directly to step 630 from step 628. In step 630, the module controller 114 determines if all non-defective substrates in the substrate cassette have been processed. If so, the process 600 proceeds to step 631; otherwise the process 600 returns to step 624 to obtain another non-defective substrate from the substrate cassette for processing within the deposition tool 108 as previously described.

In step 631, the substrate cassette is transferred from the deposition tool 108 to the planarization tool 110. In step 632, the substrate cassette is loaded into the factory interface 504 of the planarization tool 110.

In step 633, a non-defective substrate is obtained from the substrate cassette and is transferred to the load cup 516 of the polishing system 512 (e.g., via the substrate handler 524 and the robot 506 as previously described). In step 634, the module controller 114 determines a planarization process to perform within the planarization tool 110 based on information obtained from the integrated inspection system 422 of the deposition tool 108 and/or based on information obtained from the integrated inspection system 528 of the planarization tool 110 for a substrate previously processed within the planarization tool 110. For example, based on information previously received from the integrated inspection system 422 of the deposition tool 108 for the non-defective substrate to be planarized, the module controller 114 may determine the actual thickness of the insulating layer deposited on the substrate via the deposition tool 108 and may determine an appropriate planarization process (e.g., planarization time) based thereon. Likewise, based on a planarization process previously performed within the planarization tool 110, the module controller 114 may determine/suggest a planarization process

As with other processes described herein, the module controller 114 may store a library of planarization processes each of which has been optimized for a particular substrate condition (e.g., a particular deposited layer thickness or material, a particular polish stop layer, etc.). Based on feedforward information about a dielectric layer deposited on a substrate, other feedforward information, feedback information about a substrate previously processed within the planarization tool 110, or other feedback information, the module controller 114 may select one of the stored planarization processes and/or adjust the process parameters of a planarization process to achieve a desired planarization result. Algorithms may be employed to determine process parameters based on feedforward and/or feedback information.

Exemplary process parameters that may be adjusted for a planarization process include, for example, retaining ring pressure, membrane pressure, inner tube pressure, slurry or rinsing fluid flow rate, head pressure, head velocity, slurry type, slurry concentration, fixed abrasive type, polishing pad type, polish time, rinse time, various cleaning parameters such as scrub time, spin-rinse-dry time, etc. Adjusting one or more of these process parameters may affect one or more of polish rate, surface profile, surface uniformity, defect density, defect type, etc. Feedback information regarding defect density of a previously planarized substrate may be employed, for example, to affect rinse pressure, rinse time, slurry concentration or type, fixed abrasive type, polishing pad type, etc., to reduce defect density following planarization. The above process parameters may be adjusted alone or in combination when determining a planarization process to perform. FIGS. 14C(1) and 14C(2) summarize exemplary process parameters that may be adjusted to affect planarization.

In one embodiment, a planarization process is determined based on feedforward information regarding a dielectric layer deposited on a substrate having STI trenches etched therein. A characteristic of the dielectric layer deposited on the substrate which is to be planarized (i.e., a feedforward dielectric layer characteristic) is compared to a target characteristic for the dielectric layer (e.g., a desired or ideal characteristic). Based on this comparison, the module controller 114 may determine if a planarization process suitable for planarization of a substrate having the target dielectric layer deposited thereon may be adjusted to correct for any deviation between the feedforward dielectric layer characteristic and the characteristic of the target dielectric layer. For example, if the feedforward dielectric layer characteristic indicates that the dielectric layer to be planarized is thicker than a target dielectric layer, then the module controller 114 may compensate for the thicker dielectric layer by increasing polish time. Likewise, the module controller 114 may decrease polish time if the feedforward dielectric layer characteristic indicates that the dielectric layer to be planarized is thinner than the target dielectric layer.

If the dielectric layer to be planarized is center thick, then the module controller 114 may increase head pressure in the center of the substrate or decrease head pressure along the edges of the substrate during polishing. Center pressure may be decreased and/or edge pressure may be increased during polishing if the dielectric layer to be planarized is center thin. Head pressure may be otherwise adjusted to compensate for actual dielectric layer non-uniformity.

In another embodiment, a planarization process is determined based on feedback information regarding a previously planarized substrate. A characteristic of a previously planarized substrate (e.g., surface planarity, defect density, etc.) is compared to a target characteristic. Thereafter, the module controller 114 may determine a planarization process to perform on a substrate based on the planarization process employed on the previously planarized substrate (e.g., by adjusting certain deposition parameters of the process). For example, if a previously planarized substrate is center thin (e.g., due to overpolishing in the center of the substrate or underpolishing on the edges of the substrate), then the module controller 114 may reduce head pressure during an overpolishing portion of the planarization process. Likewise, the center head pressure used during polishing may be increased or decreased to affect polish uniformity, as may the edge head pressure. If a previously planarized substrate has a high defect density, then the module controller 114 may increase rinse pressure of a post polish rinse, or change the slurry concentration used during polishing. Likewise, if a previous planarization process did not completely remove a dielectric layer from a polish stop layer (e.g., if the silicon dioxide layer 718 was not completely removed from the silicon nitride layer 706 during polishing), then the module controller 114 may increase the overpolish time of the planarization process. Other process parameters similarly may be adjusted based on feedback information.

Defects such as slurry residue may be removed by a cleaning process performed after chemical mechanical polishing, and the module controller 114 may increase/decrease post polishing clean time (e.g., within the cleaning system 514 of FIG. 5) based on the defect density of the current substrate being processed and/or the defect density of a previously processed substrate. In response to defects such as scratches following (or during) polishing, the module controller 114 may adjust head pressure, slurry concentration/type, or the like so that such scratches are removed or prevented in the future.

Once a planarization process has been determined, in step 635, the module controller 114 directs the planarization tool 110 to planarize the substrate based on the process determined in step 634. The substrate also may be cleaned within the cleaning system 514 as previously described.

FIG. 7F illustrates the substrate 702 following planarization within the planarization tool 110. As shown in FIG. 7F, following planarization the silicon nitride layer 706, the oxide liner layer 716 and the oxide filler layer 718 form a substantially smooth top surface. In at least one embodiment the silicon nitride layer 706 is used as a polish stop layer. Both the silicon nitride layer 706 and the silicon dioxide layer 704 thereafter may be removed by conventional techniques to form the structure shown in FIG. 7G.

The structure of FIG. 7G comprises the silicon substrate 702 having a first STI region 720a and a second STI region 720b (each formed from a trench having the oxide liner layer 716 and the oxide filler layer 718) formed therein, and device regions 722a, 722b and 722c. As shown in FIG. 7G, because of the STI regions 720a and 720b, the device region 722a-c are electrically isolated from each other.

In step 636, the planarized substrate is inspected and is returned to the substrate cassette. For example, the substrate may be inspected within the defect detection tool 530a and/or the metrology tool 530b to determine such information as defect density, surface uniformity, etc., and this information may be communicated to the module controller 114.

In step 637, the module controller 114 determines if the planarized substrate is acceptable (e.g., has a low enough defect density level, has sufficient surface smoothness/planarity, etc.). If the planarized substrate is not acceptable, the substrate is marked as defective in step 638 and the process 600 proceeds to step 639; otherwise if the planarized substrate is acceptable the process 600 proceeds directly to step 639.

In step 639 the module controller 114 determines if all non-defective substrates within the substrate cassette have been planarized. If so, the process 600 ends in step 640; otherwise the process 600 returns to step 633 to obtain another non-defective substrate from the substrate cassette and to planarize the substrate within the planarization tool 110 as described previously.

It will be understood that the process 600 is merely exemplary of one STI process that may be performed within the inventive system 100 of FIGS. 1A and 1B. Other STI processes also may be performed within the system 100. While in process 600 every substrate processed is inspected following etching, deposition and planarization, it will be understood that fewer than every substrate may be inspected following etching, deposition and/or planarization. Further, the material layers and material layer thicknesses described herein are merely exemplary and other suitable materials and material layer thicknesses may be similarly employed. The program 208 of the module controller 114 may contain computer program code and/or data structures for performing one or more of the steps 601-640 of process 600.

Second Exemplary Integrated Process and Operation of Integrated System and Method for Forming Shallow Trench Isolation Regions

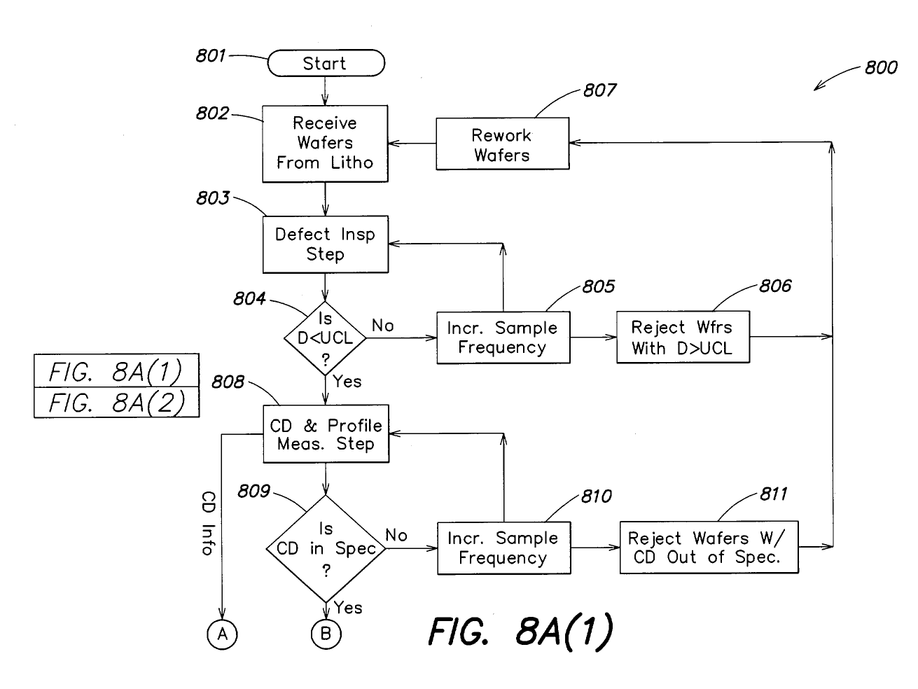

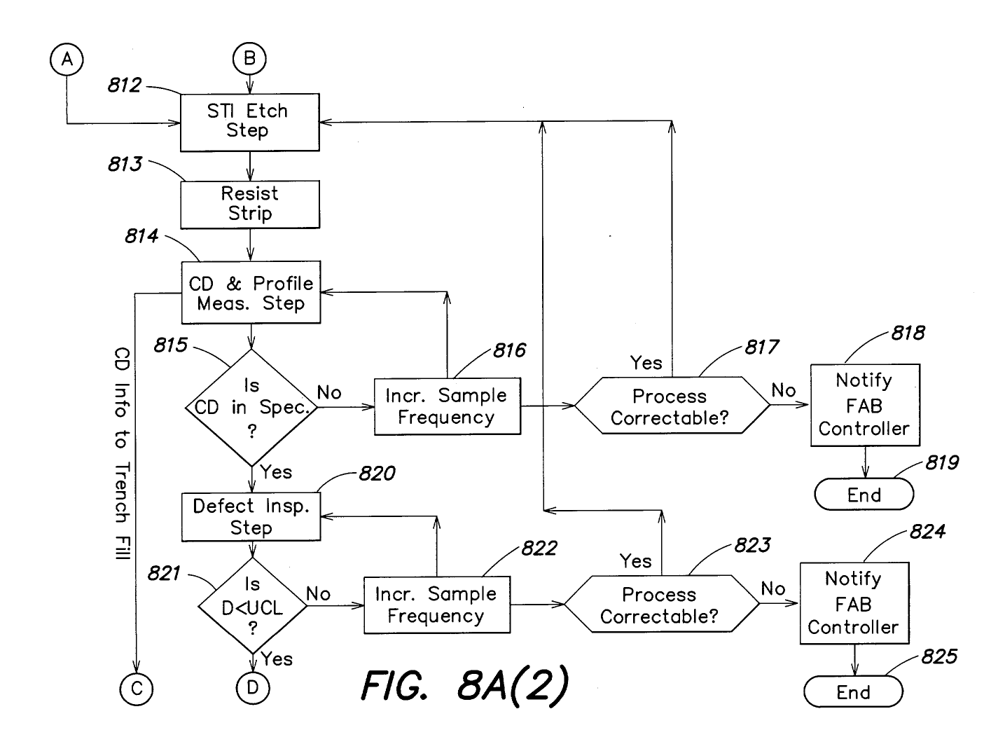

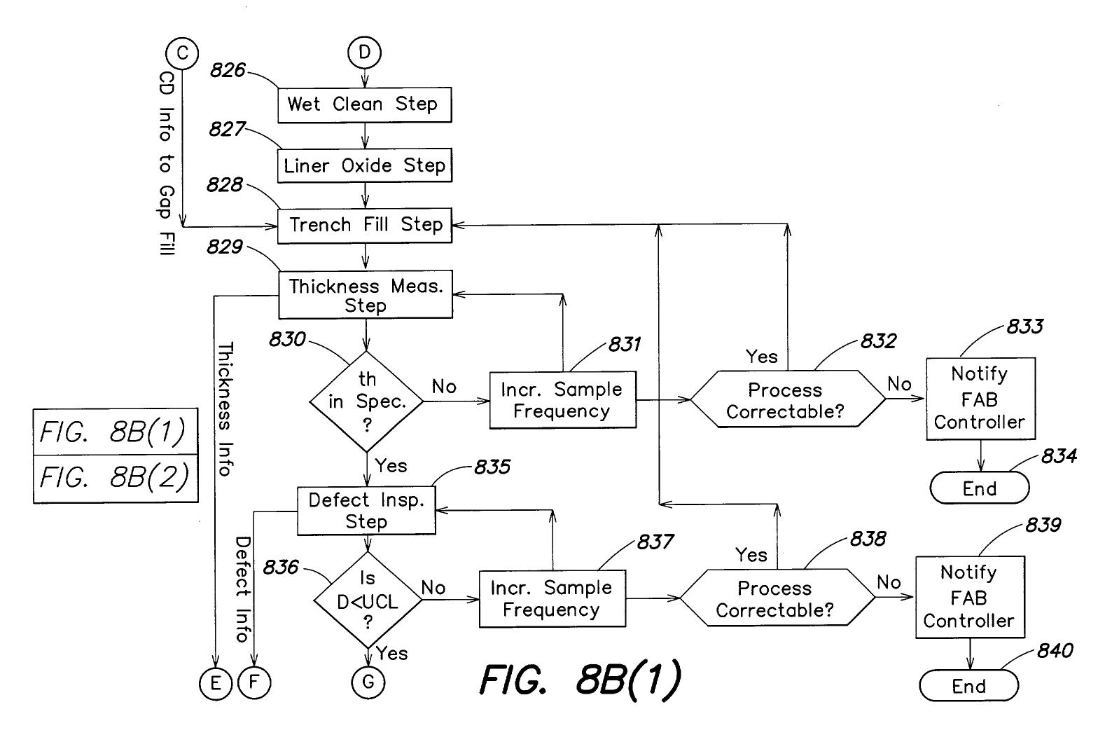

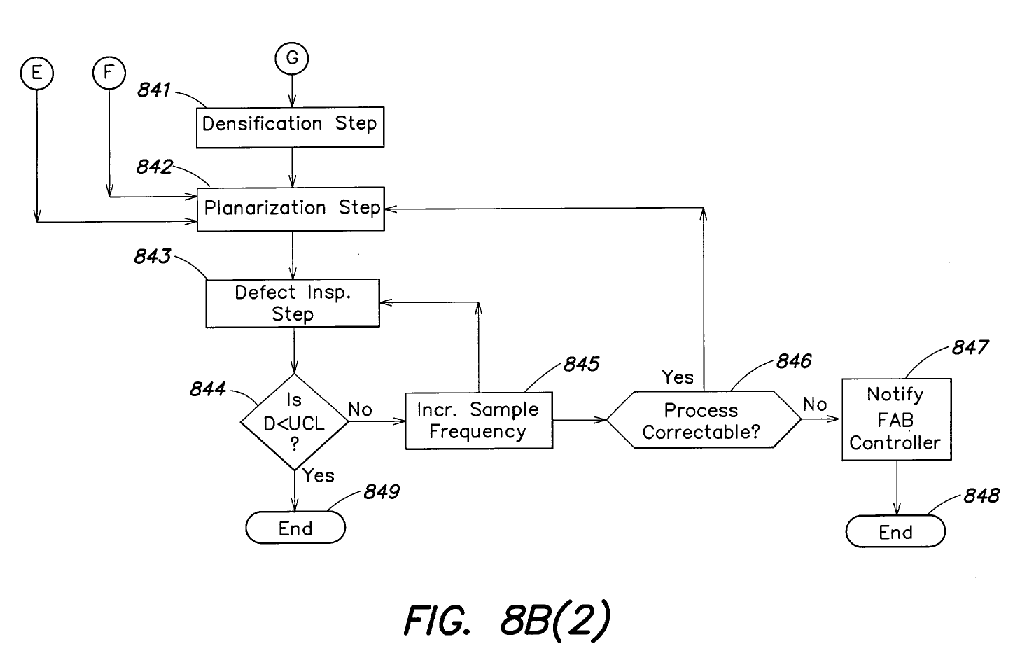

FIGS. 8A(1), 8A(2), 8B(1) and 8B(2) illustrate a flowchart of a second exemplary process 800 for forming shallow trench isolation STI regions within a substrate in accordance with the present invention. With reference to FIGS. 8A(1), 8A(2), 8B(1) and 8B(2), the process 800 begins in step 801. In step 802, the system 100 receives a cassette of substrates (e.g., a cassette of semiconductor wafers each having a patterned masking layer formed thereon) from a lithography tool (not shown) as previously described. The cassette of wafers is then delivered to the factory interface 304 of the etch tool 102. In step 803, the integrated inspection system 322 (via the defect detection tool 324a) inspects a first semiconductor wafer and provides defect information to the module controller 114.

In step 804, the module controller 114 determines if the number of defects present on the surface of the semiconductor wafer (the defect density “D”) is less than an upper control limit (UCL) for the STI formation process. For example, the upper control limit for the STI formation process may be a defect density of less than 0.1 defects per square centimeter for defects having a size of 0.15 microns or larger. Other criteria for the upper control limit may be employed and such criteria or other specified requirements of the STI formation process may be stored, for example, in the database 210 of the module controller 114 of FIG. 2.

If the module controller 114 determines that the defect density on the surface of the substrate is greater than the upper control limit, in step 805 the module controller 114 may increase the number of substrates that are inspected or “sampled” by the inspection system 322 (e.g., assuming that the inventive system 100 does not inspect every wafer processed within the etch tool 102, the module controller 114 may increase the number of wafers that are inspected), the module controller 114 may reject the wafer (step 806) and the module controller 114 may direct the inventive system 100 to rework the wafer if possible (step 807). For example, if the wafer has a patterned masking layer formed with photoresist, the etch tool 102 may be employed to ash the photoresist layer and the cleaning tool 104 may be employed to remove any residual photoresist as previously described. The wafer then may be reprocessed via a lithography tool (not shown).

If in step 804, the module controller 114 determines that the defect density D of the substrate is less than the upper control limit, the process 800 proceeds to step 808 wherein the integrated inspection system 322 performs a critical dimension and profile measurement on the wafer's patterned masking layer. For example, the metrology tool 324b may be employed to measure the width, depth and/or profile of the features formed within the patterned masking layer. This information may be communicated to the module controller 114, and in step 809 the module controller 114 may determine if the patterned masking layer has feature widths, depths and/or profiles that are within the specification requirements of the STI formation process.

If the dimensions/profile of the patterned masking layer's features are not within specification, then in step 810 the module controller 114 may increase the frequency with which substrates are sampled (e.g., increase the number of wafers that are inspected via the integrated inspection system 322 of the etch tool 102), the module controller 114 may reject the wafer as being out of specification (step 811) and the module controller 114 may direct the inventive system 100 to rework the wafer (step 807) as previously described.

If in step 809 the module controller 114 determines that the patterned masking layer is within the specification requirements of the STI formation process, in step 812 the module controller 114 directs the etch tool 102 to perform an STI etch process (e.g., based on the dimensions/profile of the features of the patterned masking layer, the density of the patterned masking layer, information received about a substrate previously etched within the etch tool 102, etc.) as previously described. In step 813, the module controller 114 directs the etch tool 102 to remove the patterned masking layer (as previously described).

In step 814, the integrated inspection system 322 (via the metrology tool 324b) examines the etched wafer to determine trench width, trench depth, trench profile and/or any other relevant critical dimension information, and provides this information to the module controller 114. In step 815, the module controller 114 determines if the etched wafer is within the specified requirements of the STI formation process (e.g., has the required trench depth, trench width, trench profile, etc.).

If the etched wafer is not within the specified requirements of the STI formation process, the module controller 114 may increase the frequency with which wafers are inspected (step 816), and/or the module controller 114 may determine (in step 817) whether the particular etch chamber which produced the out of specification wafer should be taken out of service or if a corrective measure may be taken to bring the etch process within specification (e.g., performing a cleaning recipe to remove any residue build up from the etch chamber, adjusting process parameters to bring the process within specification as described previously with reference to FIGS. 14A(1)-14A(2), etc.).

If in step 817, the module controller 114 determines that the etch process is correctable, the module controller 114 may adjust the etch process for the next wafer to be etched; otherwise the module controller 114 may notify the FAB controller 116 that the relevant etch chamber should be serviced (step 818) and the process 800 may end (step 819) or may process another wafer (by employing a different etch chamber during etching).

If in step 815, the module controller 114 determines that the etched wafer is within the specified requirements of the STI formation process, in step 820 the etched wafer is inspected via the defect detection tool 324a to determine the defect density “D” present on the surface of the etched wafer. This information is communicated to the module controller 114.

In step 821, the module controller 114 determines whether the defect density of the etched wafer is less than an upper control limit for the STI formation process. If the defect density is greater than the upper control limit, in step 822 the module controller 114 may increase the frequency with which wafers etched within the etch tool 102 are inspected, and/or the module controller 114 may determine whether the etch process is correctable (step 823).

If the etch process is correctable, the module controller 114 may adjust the etch process to be performed within the etch tool 102 for subsequent wafers (e.g., such as by characterizing the defects, and if the defects are due to flaking, performing a chamber cleaning recipe to remove residue build up, by adjusting an ashing process to more effectively remove polymeric residue, etc.). Otherwise, the module controller 114 may notify the FAB controller 116 that the relevant etch chamber should be taken out of service (step 824) and the process 800 may end (step 825) or may process another wafer (by employing a different etch chamber during etching).

If in step 821, the module controller 114 determines that the defect density of the etched wafer is less than an upper control limit of the STI formation process (and assuming that all wafers within the wafer cassette that are to be etched have been etched), in step 826, the etched wafer is returned to an appropriate wafer cassette and the wafer cassette is transferred to the cleaning tool 104. The module controller 114 then directs the cleaning tool 104 to clean the wafers within the wafer cassette (e.g., to remove any residue).

In step 827, the wafer cassette is transferred from the cleaning tool 104 to the oxidation tool 106, and the module controller 114 directs the oxidation tool 106 to grow a liner oxide layer on the wafers within the wafer cassette.

In step 828, the wafer cassette is transferred to the deposition tool 108, and based on the trench width, trench depth, trench profile and/or other critical dimension information provided by the integrated inspection system 322 of the etch tool 102, the module controller 114 determines a deposition process to perform on a first of the wafers within the wafer cassette. Information regarding one or more wafers previously processed within the deposition tool 108 also may be employed during deposition process determinations. The module controller 114 then directs the deposition tool 108 to deposit a material layer (e.g., a trench filler oxide) on the wafer (as previously described).

In step 829, the integrated inspection system 422 (via the metrology tool 424b) determines the thickness (and/or uniformity) of the material layer deposited on the wafer. This information is communicated to the module controller 114.

In step 830, the module controller 114 determines whether the thickness (th) and/or uniformity of the material layer deposited on the wafer is within the specified requirements of the STI formation process (e.g., has sufficient thickness and/or uniformity to allow the wafer to be properly planarized). If the deposited layer is not within the specified requirements of the STI formation process, the module controller 114 may increase the frequency which wafers are inspected by the metrology tool 424b (step 831), and the module controller 114 may determine whether the deposition process is correctable (step 832).

If the deposition process is correctable, the module controller 114 may adjust the deposition process for subsequent wafers (e.g., such as by increasing deposition time or by any of the other techniques described previously with reference to FIG. 14B); otherwise the module controller 114 may notify the FAB controller 116 that the appropriate deposition chamber 412a-d should be taken out of service (step 833), and the process 800 may end (step 834) or may process another wafer (by employing a different deposition chamber during deposition).

If in step 830 the module controller 114 determines that the thickness and/or uniformity of the deposited layer is within the specified requirements of the STI formation process, in step 835 the integrated inspection system 422 (via the defect detection tool 424a) determines the defect density of the deposited layer. This information is communicated to the module controller 114.

In step 836, the module controller 114 determines whether the defect density of the deposited layer is less than the upper control limit of the STI formation process. If the measured defect density is greater than the upper control limit, the module controller 114 may increase the frequency with which defect inspections are performed on wafers via the integrated inspection system 422 (step 837), and the module controller 114 may determine whether the deposition process may be adjusted so that material layers deposited on subsequent substrates are within the specified requirements of the STI formation process (step 838).

If the deposition process is correctable the module controller 114 may adjust the deposition process for subsequent wafers (e.g., such as by adjusting a cleaning/seasoning process for the deposition chamber including increasing cleaning/seasoning time as described previously with reference to FIG. 14B); otherwise the module controller 114 notifies the FAB controller 116 that the appropriate deposition chamber 412a-d should be taken out of service (step 839), and the process 800 may end (step 840) or may process another wafer (by employing the same or a different deposition process during deposition, depending on the defect source).

If in step 836 the module controller 114 determines that the defect density of the deposited layer is less than the upper control limit of the STI formation process, in step 841 a densification process may be performed on the wafer (e.g., a rapid thermal process in nitrogen at 950° Celsius for about one to two minutes as is known in the art). Note that a densification process may not be required, but is typically employed if the material layer deposited within the deposition tool 108 is deposited using SA-CVD. Steps 828-841 are repeated for each wafer within the wafer cassette that is to be processed. Step 841 (e.g., densification) may be performed after deposition has been performed on all “non-defective” wafers within the wafer cassette (e.g., on a wafer-by-wafer basis or as part of a batch process).

In step 842, assuming that all wafers within the wafer cassette have been processed as described above, the wafer cassette is transferred from the deposition tool 108 to the planarization tool 110. Based on deposited material layer thickness information provided by the integrated inspection system 422 of the deposition tool 108 and/or based on information regarding one or more wafers previously processed within the planarization tool 110, the module controller 114 determines a planarization process to perform on a first of the wafers within the wafer cassette. The module controller 114 then directs the planarization tool 110 to planarize the wafer (step 842). After the wafer is planarized within the planarization tool 110, the integrated inspection system 528 of the planarization tool 110 measures the defect density “D” of the planarized wafer (via the defect detection tool 530a), planarity (via the metrology tool 530b) and/or whether all material to be planarized has been removed from a stop layer such as the silicon nitride layer 706 of FIGS. 7A-7F (via the metrology tool 530b) and communicates this information to the module controller 114 (step 843).

In step 844, the module controller 114 determines whether the defect density of the wafer is less than an upper control limit of the STI formation process. If the wafer's defect density is greater than the upper control limit of the STI formation process, the module controller 114 may increase the frequency with which defect measurements are performed on wafers processed within the planarization tool 110 (step 845), and the module controller 114 may determine whether the planarization process is correctable (step 846).

If the planarization process is correctable, the module controller 114 may correct the planarization process so that subsequent wafers are properly planarized within the planarization tool 110 (e.g., such as by reducing head pressure, adjusting slurry concentration, etc., as described previously with reference to FIGS. 14C(1) and 14C(2)); otherwise the module controller 114 may notify the FAB controller 116 that the planarization tool 110 should be removed from service (step 847) and that the process 800 should end (848) unless an additional/redundant planarization tool is available.

If in step 844, the module controller 114 determines that the defect density of the planarized wafer is less than the upper control limit, steps 842-848 are repeated for each wafer within the wafer cassette that is to be processed. The process 800 then ends in step 849. It will be understood that the program 208 of the module controller 114 may contain computer program code and/or data structures for performing one or more of the steps 801-849 of the process 800.

Third Exemplary Integrated Process and Operation of Integrated System and Method for Forming Shallow Trench Isolation Regions

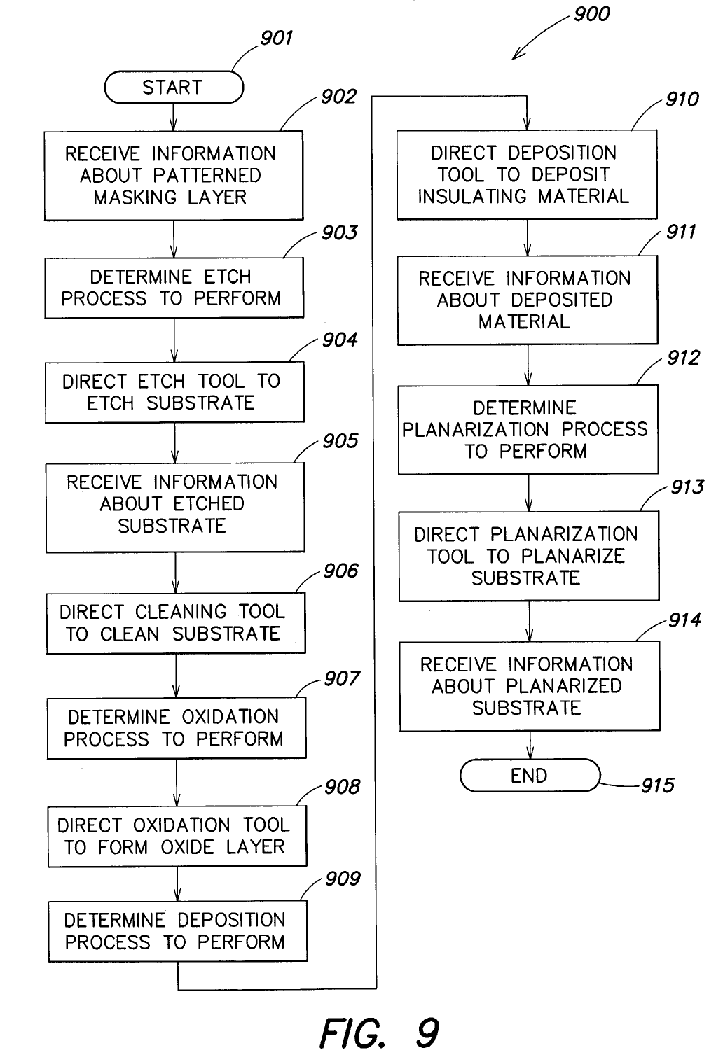

FIG. 9 is a flowchart of a third exemplary process 900 that may be performed within the inventive system 100 of FIGS. 1A or 1B. In particular the process 900 represents a process that may be performed by module controller 114 during STI region formation. The process 900 may be embodied within computer program code within the data storage device 206, and may comprise a computer program product and/or a data structure.

With reference to FIG. 9, the process 900 begins in step 901 after a substrate having a patterned masking layer is transferred to the etch tool 102. In step 902, the module controller 114 receives information about the patterned masking layer from the integrated inspection system 322 of the etch tool 102. In step 903, based on this information and/or information about a substrate previously processed within the etch tool 102 (also received from the integrated inspection system 322), the module controller 114 determines an etch process to perform within one of the etch chambers 312a-d. In step 904, the module controller 114 directs one of the etch chambers to perform the etch process.

In step 905, the module controller 114 receives information from the integrated inspection system 322 of the etch tool 102 about the etched substrate (e.g., trench dimensions/profile, defect density, etc.). In step 906, the module controller 114 directs the cleaning tool 104 to clean the substrate. The module controller 114 may or may not determine the cleaning process employed to clean the substrate.

In step 907, the module controller 114 determines an oxidation process to perform within the oxidation tool 106, and in step 908 the module controller 114 directs the oxidation tool 106 to form a liner oxide layer on the etched substrate.

In step 909, the module controller 114 determines a deposition process to perform within the deposition tool 108 (e.g., based on information received about the etched substrate from the integrated inspection system 322 of the etch tool 102 and/or based on information received about a substrate previously processed within the deposition tool 108 from the integrated inspection system 422 of the deposition tool 108). In step 910, the module controller 114 directs one of the deposition chambers 412a-d to deposit an insulating material on the substrate based on the deposition process determined in step 909.

In step 911, the module controller 114 receives information about the deposited insulating material from the integrated inspection system 422 of the deposition tool 108 (e.g., deposited layer thickness, defect density, etc.). In step 912, the module controller 114 determines a deposition process to perform within the planarization tool 110 (e.g., based on information received about the substrate from the integrated inspection system 422 of the deposition tool 108 and/or based on information received about a substrate previously processed within the planarization tool 110 from the integrated inspection system 528 of the planarization tool 110). In step 913, the module controller 114 directs the planarization tool 110 to planarize the substrate based on the planarization process determined in step 912.

In step 914, the module controller 114 receives information about the planarized substrate from the integrated inspection system 528 of the planarization tool 110 (e.g., surface planarity, defect density, etc.). In step 915, the process 900 ends.

Fourth Exemplary Integrated Process and Operation of Integrated System and Method for Forming Shallow Trench Isolation Regions

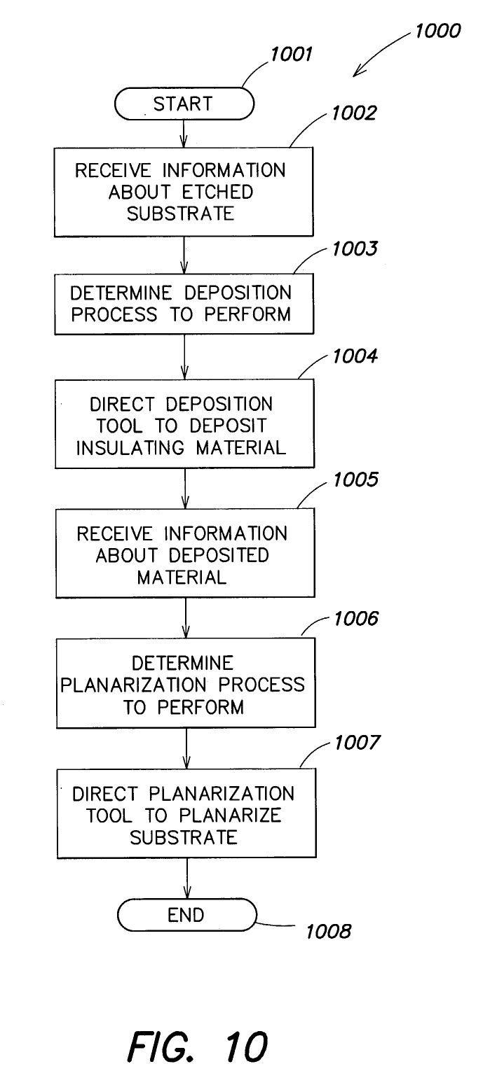

FIG. 10 is a flowchart of a fourth exemplary process 1000 that may be performed within the inventive system 100 of FIG. 1A or 1B. In particular the process 1000 represents a process that may be performed by module controller 114 during STI region formation. The process 1000 may be embodied within computer program code within the data storage device 206, and may comprise a computer program product and/or a data structure.

Process 1000 comprises steps 1001-1008 and is similar to process 900 but without steps 902, 903, 904, 906, 907, 908 and 914. These steps, if performed at all, may be performed by the FAB controller 116 or some other controller.

Fifth Exemplary Integrated Process and Operation of Integrated System and Method for Forming Shallow Trench Isolation Regions

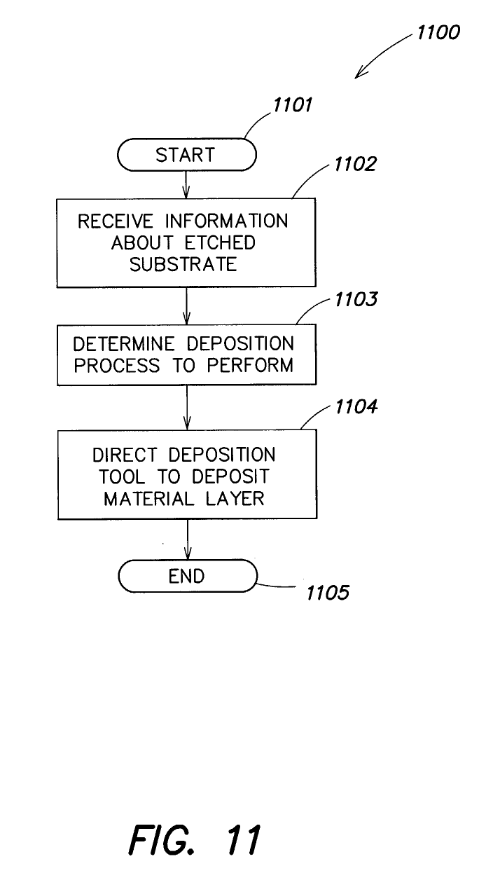

FIG. 11 is a flowchart of a fifth exemplary process 1100 that may be performed within the inventive system 100 of FIG. 1A or 1B or within any system that employs an etch tool having an integrated inspection system and a deposition tool (whether or not employed for STI region formation and whether or not the deposition tool has an integrated inspection system such as the integrated inspection system 422). The process 1100 represents a process that may be performed by module controller 114, may be embodied within computer program code within the data storage device 206, and may comprise a computer program product and/or a data structure.

Process 1100 comprises steps 1101-1105 and is similar to process 1000 but without steps 1005-1007. These steps, if performed at all, may be performed by the FAB controller 116 or some other controller.

Sixth Exemplary Integrated Process and Operation of Integrated System and Method for Forming Shallow Trench Isolation Regions

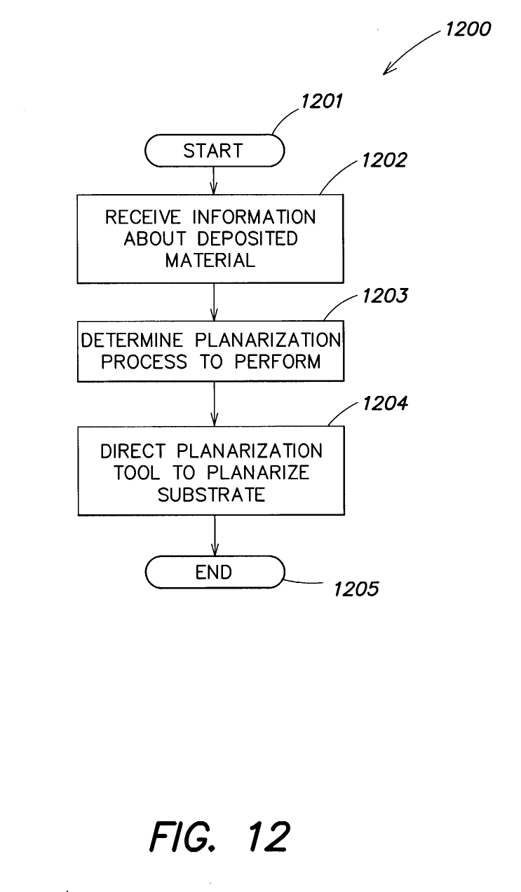

FIG. 12 is a flowchart of a sixth exemplary process 1200 that may be performed within the inventive system 100 of FIGS. 1A or 1B or within any system that employs a deposition tool having an integrated inspection system and a planarization tool (whether or not employed for STI region formation and whether or not the planarization tool has an integrated inspection system such as the integrated inspection system 528). The process 1200 represents a process that may be performed by module controller 114, may be embodied within computer program code within the data storage device 206, and may comprise a computer program product and/or a data structure.

Process 1200 comprises steps 1201-1205 and is similar to process 1000 but without steps 1002-1004. These steps, if performed at all, may be performed by the FAB controller 116 or some other controller.

Seventh Exemplary Integrated Process and Operation of Integrated System and Method for Forming Shallow Trench Isolation Regions

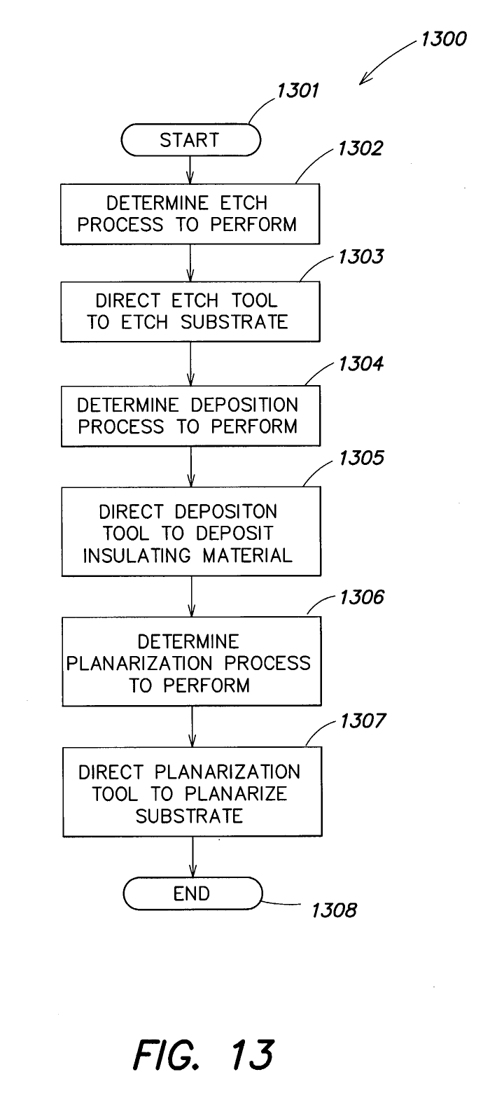

FIG. 13 is a flowchart of a seventh exemplary process 1300 that may be performed within the inventive system 100 of FIGS. 1A or 1B. In particular the process 1300 represents a process that may be performed by module controller 114 during STI region formation. The process 1300 may be embodied within computer program code within the data storage device 206, and may comprise a computer program product and/or a data structure.

Process 1300 comprises steps 1301-1308 and is similar to process 900 but without steps 902, 905, 906, 907, 908, 911 and 914. These steps, if performed at all, may be performed by the FAB controller 116 or some other controller. Process 1300 may be employed, for example, when only feedback information is used to affect the process performed within the etch tool 102, the deposition tool 108 and/or the planarization tool 110.

The foregoing description discloses only exemplary embodiments of the invention. Modifications of the above disclosed apparatus and method which fall within the scope of the invention will be readily apparent to those of ordinary skill in the art. For instance, the cleaning tool 104 and/or the oxidation tool 106 also may be configured with an integrated inspection system that provides feedforward information to other tools (e.g., the deposition tool 108) and/or feedback information (e.g., for improving/adjusting the cleaning process performed within the cleaning tool 104 or the oxidation process performed within the oxidation tool 106). During substrate inspection within the integrated inspection systems, all or a portion of each substrate may be inspected (e.g., a pre-programmed or predetermined part of a wafer die, 5-10 wafer die, etc.).

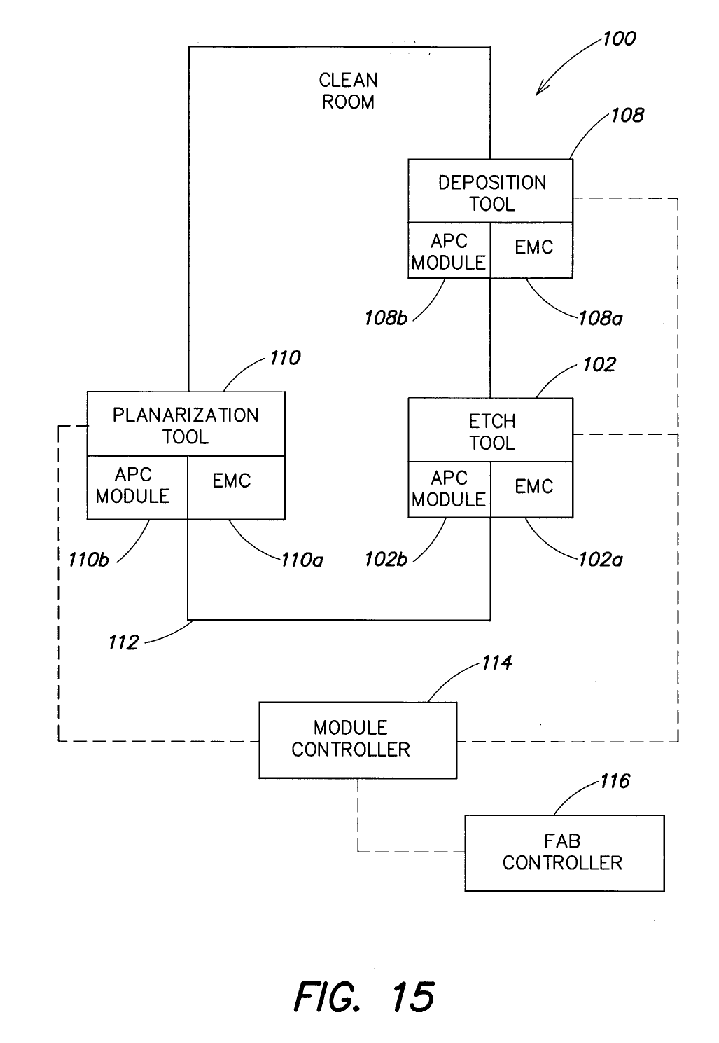

Note that in the embodiment of FIG. 1A, the module controller 114 is illustrated as a “central” controller that may communicate with the tools 102-110 (e.g., with the integrated inspection system of each tool) to receive feedforward and feedback information, to determine appropriate processes to perform within each tool based on the feedforward and/or feedback information, to direct each tool to perform a process, etc., as described previously. FIG. 15 illustrates an alternative embodiment for the system 100 wherein the module controller 114 is “distributed” among the tools 102, 108 and 110. That is, each of the tools 102, 108 and 110 includes an embedded module controller (EMC) 102a, 108a and 110a, respectively, and an automated process control (APC) module 102b, 108b and 110b, respectively. For convenience, only tools 102, 108 and 110 are shown in FIG. 15. Each APC module may comprise, for example, computer program code for performing one or more of the previously described functions of the module controller 114 (e.g., determining a process to perform for a tool based on feedforward and/or feedback information).

In at least one embodiment of the invention, the EMC's 102a, 108a and 110a communicate with the module controller 114 to provide feedforward and/or feedback information to the module controller 114, to receive processes from the module controller 114, etc. The EMC's 102a-110a and/or the APC modules 102b-110b may be configured, for example, similarly to the module controller 114 of FIG. 2, and may contain computer program code and/or data structures for performing one or more of the steps of one or more of the processes 600-1300 rather than or in addition to the module controller 114.

The module controller 114 and/or one or more embedded module controllers 102a, 108a and 110a may be employed to monitor tool health. For example, a software diagnostic tool such as SmartSys™ (distributed by Applied Materials, Inc.) which monitors equipment signals (e.g., signals from mass flow controllers, throttle valves, radio frequency sources, etc.) and analyzes such signals for drift may be used in conjunction with the module controller 114, and/or embedded module controllers, by having the module controllers provide other process drift information to the software diagnostic tool, or by having the module controllers adjust process parameters to compensate for process drift (e.g., by increasing process time, flow rates, chamber pressure, etc.).

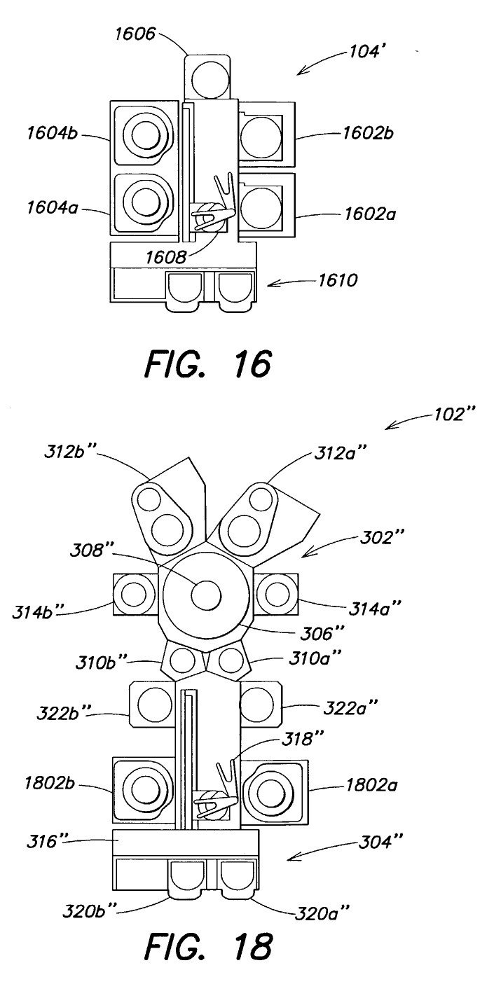

The cleaning tool 104 and the oxidation tool 106 of FIGS. 1A and 1B each may include an integrated inspection system that is in communication with the module controller 114 and/or an embedded module controller (not shown). Processes performed within each tool 104, 106 thereby may be determined by the module controller 114 and/or by an embedded module controller (not shown) of the tool 104, 106 based on feedforward and feedback information such as defect density, oxide thickness of oxides, etc. For example, FIG. 16 is a top plan view of an exemplary stand-alone cleaning tool 104′ which may include one or more resist strip chambers 1602a-b (e.g., one or more ashing chambers), one or more clean chambers 1604a-b (e.g., one or more single wafer wet clean chambers), an integrated inspection system 1606, and a wafer handler 1608 for transferring wafers between a factory interface 1610 and the resist strip chambers 1602a-b, the clean chambers 1604a-b and the integrated inspection system 1606. Each clean chamber 1604a-b may comprise any conventional apparatus for cleaning a substrate such as a wet chemical cleaning station that employs dilute HF, de-ionized (DI) water rinsing, Marangoni drying, megasonic techniques and/or any combination thereof to clean a substrate. One such exemplary stand-alone cleaning tool is the Tempest™ cleaning tool manufactured by Applied Materials, Inc. Information from the integrated inspection system 1606 such as defect density may be employed to affect clean time and/or other process parameters (e.g., megasonic power, composition, etc.) of the cleaning tool via feedback and/or feedforward information provided, for example, to the module controller 114.

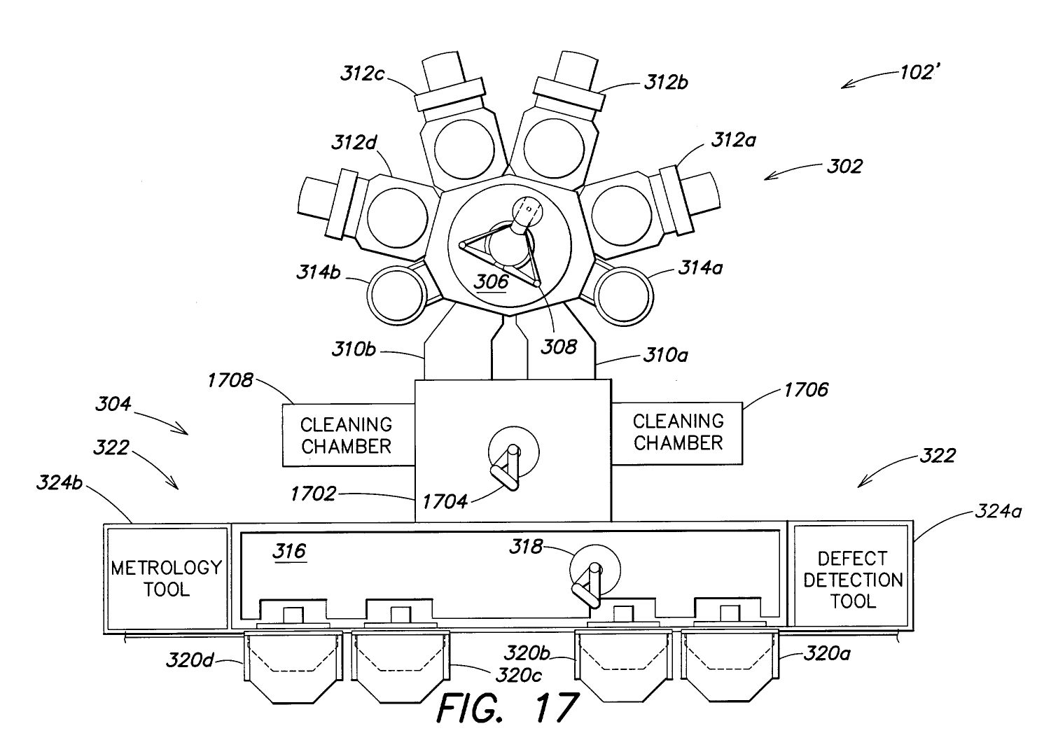

The cleaning tool 104 may be part of an etch tool, and may share use of the integrated inspection system of the etch tool. FIG. 17 is a top plan view of an exemplary etch and clean tool 102′ that may be employed within the inventive system of FIGS. 1A, 1B and 15. The etch and clean tool 102′ is similar to the etch tool 102 of FIG. 3, but includes an additional buffer chamber 1702 having a substrate handler 1704 disposed therein, and two cleaning chambers 1706 and 1708 coupled to the buffer chamber 1702. Each cleaning chamber 1706, 1708 may comprise any conventional apparatus for cleaning a substrate such as a wet chemical cleaning station that employs dilute HF, de-ionized (DI) water rinsing, Marangoni drying, megasonic techniques and/or any combination thereof to clean a substrate. Such cleaning chambers are well known in the art and are not described in further detail herein.

The etch and clean tool 102′ operates similarly to the etch tool 102, with the exception that the substrate handler 1704 is also employed when transferring a substrate between the factory interface 304 and the loadlocks 310a, 310b of the tool 302. The integrated inspection system 322 may be employed to perform defect detection and/or metrology on substrates (1) before etching; (2) after etching; and/or (3) after cleaning. Information collected by the integrated inspection system 322 may be employed to affect both etch processes and cleaning processes performed within the etch and clean tool 102′ (e.g., via feedback or feedforward information) or processes performed within other tools (e.g., via feedforward information).

FIG. 18 is a top plan view of an alternative integrated etch and clean tool 102″ that may be employed within the inventive system of FIGS. 1A, 1B and 15. The etch and clean tool 102″ includes a processing tool 302″ coupled to a factory interface 304″. The processing tool 302″ includes a transfer chamber 306″ which houses a first substrate handler 308″. The transfer chamber 306″ is coupled to a first loadlock 310a″, a second loadlock 310b″, a first etch chamber 312a″, a second etch chamber 312b″ and auxiliary processing chambers 314a″, 314b″ (e.g., resist strip chambers). Fewer or more etch chambers or auxiliary processing chambers may be employed, and the module controller 114 may communicate with and/or control the processes performed within each chamber. The factory interface 304″ includes a buffer chamber 316″ which is accessible via a second substrate handler 318″ and which is coupled to a plurality of loadports 320a″-b″. The etch and clean tool 102″ further includes integrated inspection systems 322a″, 322b″ (e.g., defect detection and/or metrology tools similar to the defect detection tool 324a and/or metrology tool 324b), and clean chambers 1802a, 1802b (e.g., single wafer wet clean chambers). Each clean chamber 1802a, 1802b may comprise any conventional apparatus for cleaning a substrate such as a wet chemical cleaning station that employs dilute HF, de-ionized (DI) water rinsing, Marangoni drying, megasonic techniques and/or any combination thereof to clean a substrate.

The various components of the etch and clean tool 102″ of FIG. 18 may be similar in configuration and/or operation to similarly enumerated components of the etch tool 102 of FIG. 3 and/or the etch and clean tool 102′ of FIG. 17. For example, wafers coming out of the processing tool 302″ may be inspected for defects (both pattern and particle defects) via one or both of the integrated inspection systems 322a″, 322b″. Information therefrom may be fed to the module controller 114 and used as feedback and/or feedforward information for the etch and clean tool 102″ (e.g., for subsequent etch or clean processes). Similarly, wafers may be inspected after cleaning within one or more of the clean chambers 1802a, 1802b (e.g., allowing the module controller 114 to make process adjustments in the clean chambers 1802a, 1802b depending on, for example, defect levels following cleaning). Clean times and/or other process parameters such as megasonic power and composition may be adjusted. Likewise, if defect levels are too high following cleaning, the wafers may be re-cleaned to reduce defect levels.

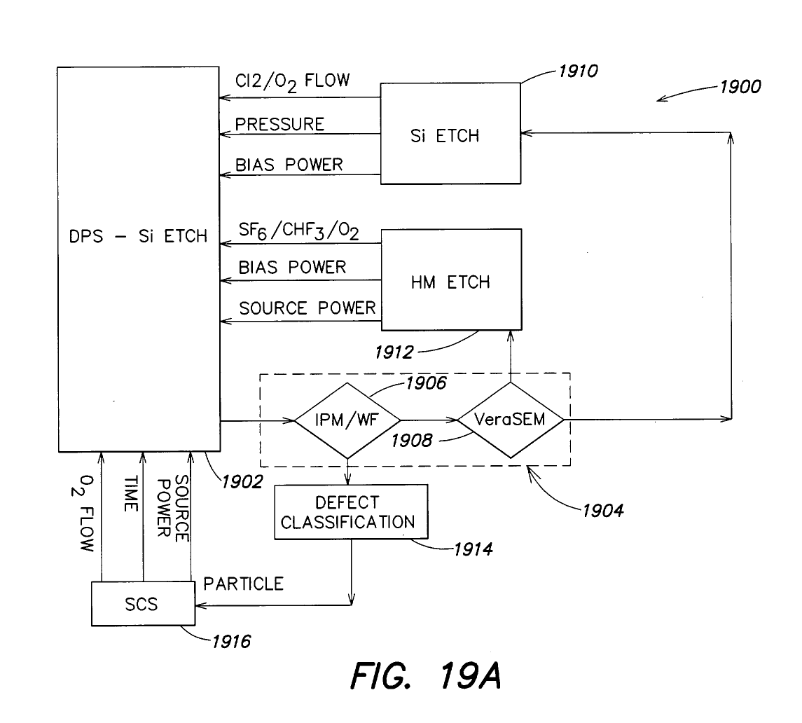

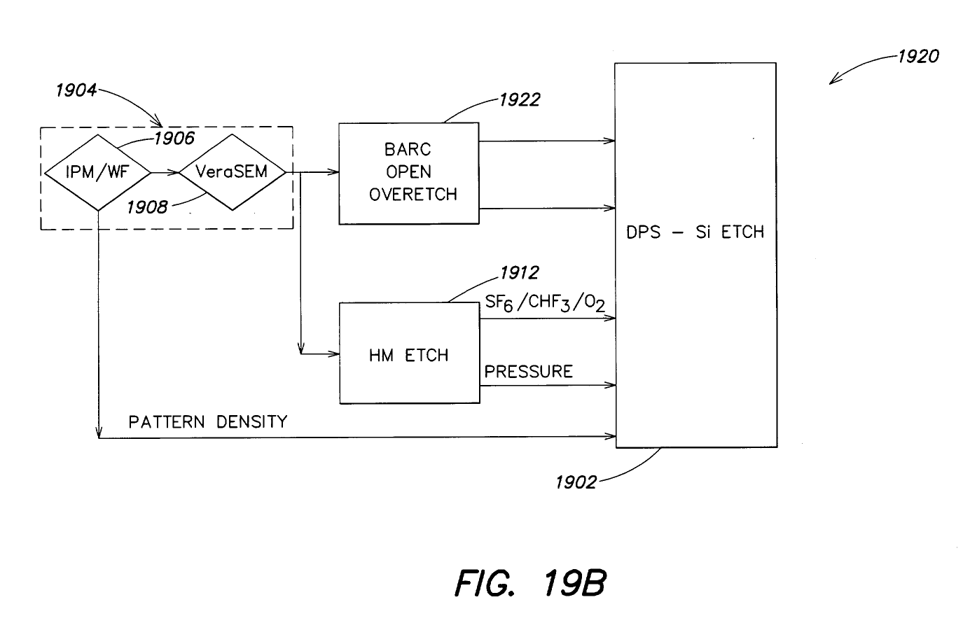

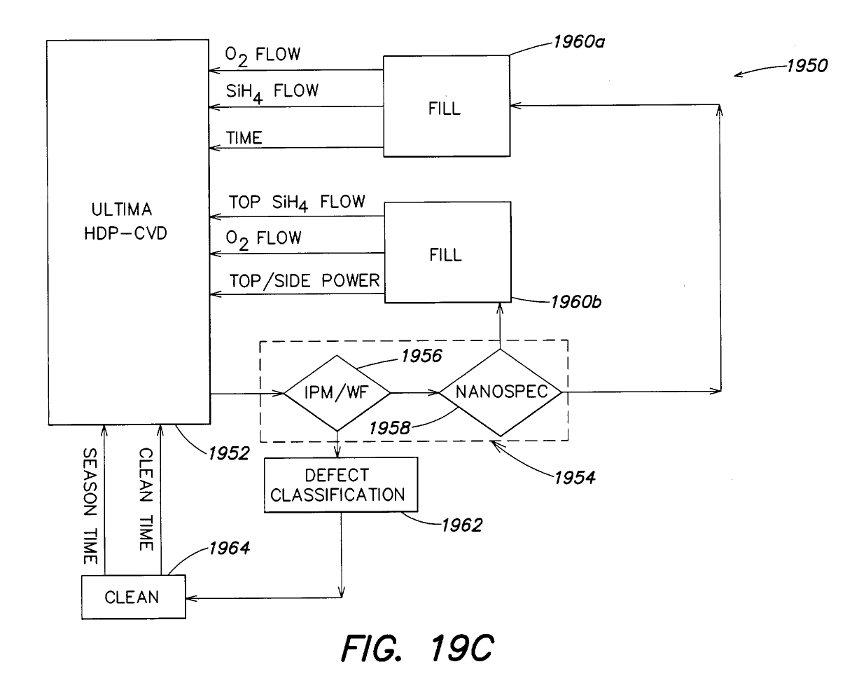

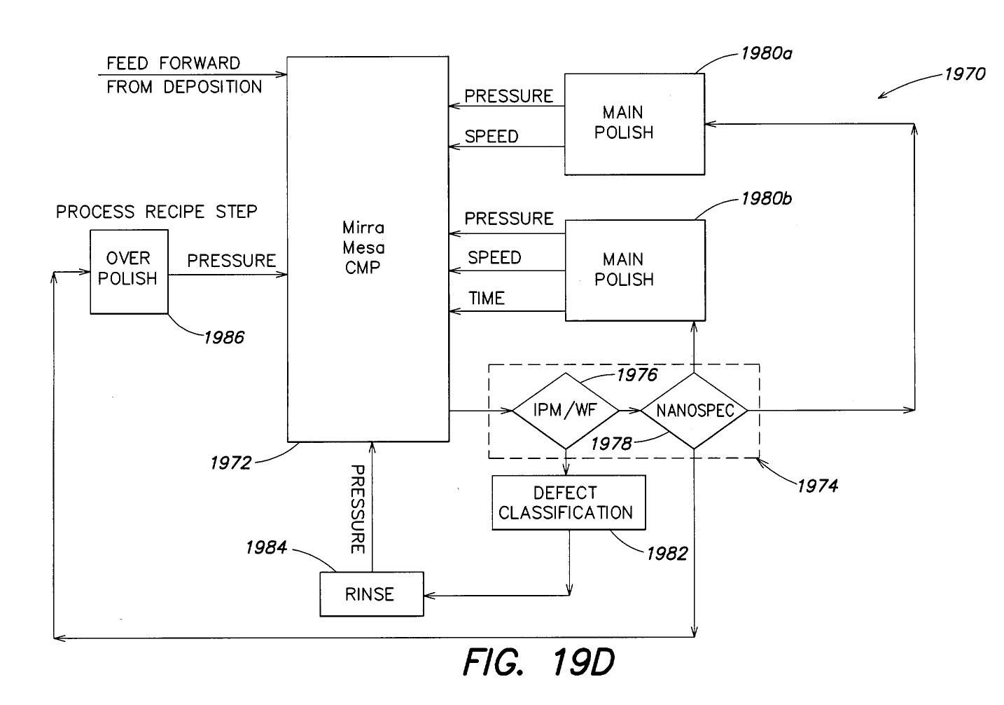

FIG. 19A is a schematic diagram of an exemplary embodiment of a feedback etch control portion 1900 of an integrated shallow trench isolation manufacturing system provided in accordance with the present invention. With reference to FIG. 19A, the feedback etch control portion 1900 includes an etch subsystem 1902, such as a DPS silicon etch tool available from Applied Materials, Inc., and an integrated inspection system 1904.

The integrated inspection system 1904 includes a defect detection tool 1906, such as an IPM™ defect detection tool available from Applied Materials, Inc., and a metrology tool 1908, such as a VeraSEM™ scanning electron microscope metrology tool also available from Applied Materials, Inc. Other integrated inspection systems may be employed.

The feedback etch control portion 1900 also includes silicon (Si) etch control logic 1910, hard mask (HM) etch control logic 1912, defect classification logic 1914 and/or soft chamber season (SCS) control logic 1916. One or more of the silicon etch control logic 1910, hard mask etch control logic 1912, defect classification logic 1914 and/or soft chamber season control logic 1916 may be implemented, for example, in hardware, software or a combination thereof as part of the etch subsystem 1902, the integrated inspection system 1904 and/or a module controller (not shown in FIG. 19A).

In operation, the feedback etch control portion 1900 employs feedback information about a previously etched substrate to control or otherwise affect etching within the etch subsystem 1902. For example, after a substrate is etched within the etch subsystem 1902, the substrate may be inspected within the defect detection tool 1906. The defect detection tool 1906 may, for example, merely provide a measure of defect density on a substrate surface or may provide detailed information about any detected defects such as defect characterization and/or classification information (e.g., via the defect classification logic 1914). The defect detection tool 1906 may provide such information to the module controller (not shown).

Based on defect information provided by the defect detection tool 1906, the module controller may, among other things, adjust the cleaning process for the etch subsystem 102 to affect the defect characteristics of subsequently processed substrates. For example, if defect density is high following etching, the module controller (e.g., via the SCS control logic 1916) may (1) increase chamber clean time (soft chamber season) or frequency; (2) increase O₂ flow to improve polymeric residue removal from chamber surfaces; and/or (3) increase source power (e.g., to speed residue removal).

Likewise, after a substrate is etched within the etch subsystem 1902, the substrate may be inspected within the metrology tool 1908. Based on critical dimension information, such as active device area left unetched, the module controller (e.g., via the hard mask etch control logic 1912) may, among other things, adjust hard mask etching within the etch subsystem 1902 to affect etching of subsequently processed substrates. For example, increasing CHF₃ flow or increasing bias power will increase critical dimension, while increasing source power or SF₆ flow will reduce critical dimension, or vice versa.

Based on etch feature profile, such as sidewall angle, the module controller may employ the hard mask etch control logic 1912 to increase SF₆ flow and decrease CHF₃ flow so as to increase sidewall angle (e.g., increase the verticalness of sidewall angle) or vice versa. Additionally or alternatively, the module controller may employ the silicon etch control logic 1910 to increase Cl₂/O₂ ratio and pressure so as to increase sidewall angle, or increase bias power to decrease sidewall angle. Other parameters than those described may be adjusted based on feedback information to affect processing within the etch subsystem 1902.

FIG. 19B is a schematic diagram of an exemplary embodiment of a feedforward etch control portion 1920 of an integrated shallow trench isolation manufacturing system provided in accordance with the present invention. With reference to FIG. 19B, the feedforward etch control portion 1920 includes the etch subsystem 1902, such as a DPS silicon etch tool available from Applied Materials, Inc., and the integrated inspection system 1904 of FIG. 19A.

As stated, the integrated inspection system 1904 includes a defect detection tool 1906, such as an IPM™ defect detection tool available from Applied Materials, Inc., and a metrology tool 1908, such as a VeraSEM™ scanning electron microscope metrology tool also available from Applied Materials, Inc. Other integrated inspection systems may be employed.

The feedforward etch control portion 1920 also includes the hard mask (HM) etch control logic 1912 and bottom antireflection coating (BARC) etch control logic 1922. One or more of the hard mask etch control logic 1912 and the BARC etch control logic 1922 may be implemented, for example, in hardware, software or a combination thereof as part of the etch subsystem 1902, the integrated inspection system 1904 and/or a module controller (not shown in FIG. 19B).

In operation, the feedforward etch control portion 1920 employs feedforward information about a substrate to be etched within the etch subsystem 1902 to control or otherwise affect etching of the substrate within the etch subsystem 1902. For example, before a substrate is etched within the etch subsystem 1902, the substrate may be inspected within the defect detection tool 1906 and/or metrology tool 1908 to determine a pattern density of a masking layer formed on the substrate prior to etching. Based on pattern density information, the module controller may, among other things, selected a pre-optimized etch recipe for the substrate.

Likewise, the metrology tool 1908 may be employed to measure critical dimension information for the substrate to be etched. Based on critical dimension information, such as active device area that will be left unetched following etching, the module controller may, among other things, determine if any deviation in critical dimension from a target critical dimension (that will result following etching) is within the correctable range of the etch subsystem 1902. If so, and if the module controller determines that pattern masking layer features are too small, the module controller, via the hard mask etch control logic 1912, may increase CHF₃ flow accordingly. Alternatively, the module controller (via the hard mask etch control logic 1912) may decrease CHF₃ flow, increase SF₆ flow, increase O₂ flow and/or decrease pressure during hard mask etching to reduce critical dimension. The module controller (via the BARC etch control logic 1922) also may increase BARC overetch to reduce critical dimension. Other parameters than those described may be adjusted based on feedforward information to affect processing within the etch subsystem 1902.

FIG. 19C is a schematic diagram of an exemplary embodiment of a feedback and feedforward deposition control portion 1950 of an integrated shallow trench isolation manufacturing system provided in accordance with the present invention. With reference to FIG. 19C, the feedback and feedforward deposition control portion 1950 includes a deposition subsystem 1952, such as an Ultima™ High Density Plasma (HDP) Chemical Vapor Deposition (CVD) tool available from Applied Materials, Inc., and an integrated inspection system 1954.

The integrated inspection system 1954 includes a defect detection tool 1956, such as an IPM™ defect detection tool available from Applied Materials, Inc., and a metrology tool 1958, such as a Nanospec measurement tool available from Nanometrics. Other integrated inspection systems may be employed.

The feedback and feedforward deposition control portion 1950 also includes first fill control logic 1960a, second fill control logic 1960b, defect classification logic 1962 and/or clean control logic 1964. One or more of the first fill control logic 1960a, the second fill control logic 1960b, the defect classification logic 1962 and/or the clean control logic 1964 may be implemented, for example, in hardware, software or a combination thereof as part of the deposition subsystem 1952, the integrated inspection system 1954 and/or a-module controller (not shown in FIG. 19C).

In operation, the feedback and feedforward deposition control portion 1950 employs feedback information about a previously etched substrate to control or otherwise affect deposition within the deposition subsystem 1952. For example, after a dielectric layer is deposited within the deposition subsystem 1952, the substrate may be inspected within the defect detection tool 1956. The defect detection tool 1956 may, for example, merely provide a measure of defect density on a substrate surface or may provide detailed information about any detected defects such as defect characterization and/or classification information (e.g., via the defect classification logic 1962). The defect detection tool 1956 may provide such information to the module controller (not shown).

Based on defect information provided by the defect detection tool 1956, the module controller may, among other things, adjust the cleaning process for the deposition subsystem 1952 to affect the defect characteristics of subsequently processed substrates. For example, if defect density is high following deposition, the module controller (e.g., via the clean control logic 1964) may (1) increase chamber clean time or frequency (e.g., to ensure removal of all oxide residue); and/or (2) increase season film thickness.

Likewise, after a dielectric layer is deposited on a substrate within the deposition subsystem 1952, the substrate may be inspected within the metrology tool 1958. Based on deposited layer information such as thickness and uniformity, the module controller (e.g., via the fill control logic 1960a, 1960b) may, among other things, adjust deposition processes within the deposition subsystem 1952 to affect dielectric layer deposition on subsequently processed substrates. For example, increasing deposition time or increasing SiH₄ and O₂ flows proportionally will increase deposited film thickness; and decreasing deposition time or decreasing SiH₄ and O₂ flows proportionally will decrease deposited film thickness. To compensate for a center thick dielectric layer profile, top SiH₄ flow or top/side power ratio may be reduced. To compensate for a center thin dielectric layer profile, SiH₄ and O₂ flow may be increased proportionally, or top/side power ratio may be increased.

The feedback and feedforward deposition control portion 1950 also employs feedforward information about a substrate on which a dielectric layer is to be deposited (within the deposition subsystem 1952) to control or otherwise affect deposition on the substrate within the deposition subsystem 1952. For example, before a dielectric layer is deposited on a substrate within the deposition subsystem 1952, the substrate may be inspected within the metrology tool 1956 to determine trench dimension information (e.g., trench depth, width, etc.). Alternatively, such information may be provided by the integrated inspection system 1904 of the etch subsystem 1902 of FIGS. 19A and 19B. Based on trench dimension information, the module controller may, among other things, employ the fill control logic 1960a and/or 1960b to affect film deposition on the substrate. For example, if the trenches to be filled are deeper and/or narrower than expected, the module controller may increase deposition to etch ratio by increasing bias power and/or decreasing SiH₄ and O₂ flows proportionally. Likewise, if the trenches to be filled are wider and/or shallower than expected, opposite adjustments to bias power and/or SiH₄ and O₂ flows may be made. If the trenches to be filled are deeper than expected, deposited film thickness may be increased by increasing deposition time or SiH₄ and O₂ flows proportionally to have enough film deposited to fill the trenches. Other parameters than those described may be adjusted based on feedforward information to affect processing within the deposition subsystem 1952.

FIG. 19D is a schematic diagram of an exemplary embodiment of a feedback and feedforward planarization control portion 1970 of an integrated shallow trench isolation manufacturing system provided in accordance with the present invention. With reference to FIG. 19D, the feedback and feedforward planarization control portion 1970 includes a planarization subsystem 1972, such as a Mirra Mesa™ Planarization tool available from Applied Materials, Inc., and an integrated inspection system 1974.

The integrated inspection system 1974 includes a defect detection tool 1976, such as an IPM™ defect detection tool available from Applied Materials, Inc., and a metrology tool 1978, such as a Nanospec measurement tool available from Nanometrics. Other integrated inspection systems may be employed.

The feedback and feedforward planarization control portion 1970 also includes first main polish control logic 1980a, second main polish control logic 1980b, defect classification logic 1982, rinse control logic 1984 and/or overpolish control logic 1986. One or more of the first main polish control logic 1980a, second main polish control logic 1980b, defect classification logic 1982, rinse control logic 1984 and/or overpolish control logic 1986 may be implemented, for example, in hardware, software or a combination thereof as part of the planarization subsystem 1972, the integrated inspection system 1974 and/or a module controller (not shown in FIG. 19D).

In operation, the feedback and feedforward planarization control portion 1970 employs feedback information about a previously planarized substrate to control or otherwise affect planarization within the planarization subsystem 1972. For example, after a substrate has been planarized within the planarization subsystem 1972, the substrate may be inspected within the defect detection tool 1976. The defect detection tool 1976 may, for example, merely provide a measure of defect density on a substrate surface or may provide detailed information about any detected defects such as defect characterization and/or classification information (e.g., via the defect classification logic 1982). The defect detection tool 1976 may provide such information to the module controller (not shown).

Based on defect information provided by the defect detection tool 1976, the module controller may, among other things, adjust the cleaning (rinsing) process for the planarization subsystem 1972 to affect the defect characteristics of subsequently planarized substrates. For example, if defect density is high following planarization, the module controller (e.g., via the rinse control logic 1984) may increase rinse pressure or change slurry concentration.

Likewise, after a substrate is planarized within the planarization subsystem 1972, the substrate may be inspected within the metrology tool 1978. Based on planarized surface information such as surface planarity and/or uniformity, the module controller (e.g., via the main polish control logic 1980a, 1980b and/or the overpolish control logic 1986) may, among other things, adjust the planarization process performed within the planarization subsystem 1972 to affect planarization of subsequently processed substrates. For example, increasing center polish head pressure may lead to a more center thin uniformity profile, increasing edge polish head pressure may lead to a more center thick uniformity profile, increasing polish time (e.g., over polish time) may increase non-uniformity, reducing pressure during overpolish may reduce dishing, etc.

The feedback and feedforward planarization control portion 1970 also employs feedforward information about a substrate to be planarized within the planarization subsystem 1972 to control or otherwise affect planarization of the substrate within the planarization subsystem 1972. For example, before a substrate is planarized within the planarization subsystem 1972, the substrate may be inspected within the metrology tool 1976 to determine the thickness and/or uniformity of the dielectric layer to be planarized. Alternatively, such information may be provided by the integrated inspection system 1954 of the deposition subsystem 1952 of FIG. 19C. Based on dielectric layer thickness and/or uniformity, the module controller may, among other things, employ the main polish control logic 1980a and/or 1980b to affect planarization of the substrate. For example, if the dielectric layer to be planarized is thicker than expected, then the module controller may increase polish time. Polish time may be decreased for a thinner than expected dielectric layer. If the dielectric layer to be planarized is center thick, then the center polish head pressure may be increased planarization; and if the dielectric layer to be planarized is edge thick, then the edge polish head pressure may be increased during planarization. Over polish time may be increased to ensure complete dielectric layer removal. Other parameters than those described may be adjusted based on feedback and/or feedforward information to affect processing within the planarization subsystem 1972. Note that planarization processes vary based on planarization tool design, type of slurry used, type of pad used, type of abrasive material used (e.g., fixed abrasive versus slurry), etc.

Accordingly, while the present invention has been disclosed in connection with exemplary embodiments thereof, it should be understood that other embodiments may fall within the spirit and scope of the invention, as defined by the following claims.

The invention claimed is:

1. A system configured to form shallow trench isolation regions in a substrate, the system comprising:
an etch subsystem configured to etch a substrate, the etch subsystem having an integrated inspection system configured to inspect the substrate;
a deposition subsystem configured to receive the substrate after the substrate has been etched and to deposit an insulating material on the substrate, the deposition subsystem having an integrated inspection system configured to inspect the substrate;
a planarization subsystem configured to receive the substrate after the insulating material has been deposited on the substrate and to planarize the substrate; and
a controller coupled to the etch subsystem, the deposition subsystem and the planarization subsystem, the controller having computer program code configured to communicate with each subsystem and to perform the steps of:
receiving information about a substrate etched within the etch subsystem from the inspection system of the etch subsystem;
determining a deposition process to perform within the deposition subsystem based at least in part on the information received from the inspection system of the etch subsystem;
directing the deposition subsystem to deposit an insulating material on the substrate based on the deposition process;
receiving information about the insulating material deposited on the substrate from the inspection system of the deposition subsystem;
determining a planarization process to perform within the planarization subsystem based at least in part on the information received from the inspection system of the deposition subsystem; and
directing the planarization subsystem to planarize the substrate based on the planarization process.

2. The system of claim 1 wherein the controller further comprises computer program code configured to perform the steps of:
determining an etch process to perform within the etch subsystem based at least in part on information received from the inspection system of the etch subsystem about a substrate previously processed within the etch subsystem; and
directing the etch subsystem to etch a substrate based on the etch process.

3. The system of claim 2 wherein determining an etch process includes determining at least one of:
(a) a CHF₃ flow rate;
(b) an SF₆ flow rate;
(c) a Cl₂ flow rate; and
(d) an O₂ flow rate;
based on the information received about the substrate previously processed within the etch subsystem.

4. The system of claim 2 wherein determining an etch process includes determining a chamber pressure based on the information received about the substrate previously processed within the etch subsystem.

5. The system of claim 2 wherein determining an etch process includes determining at least one of a substrate bias power and source power based on the information received about the substrate previously processed within the etch subsystem.

6. The system of claim 2 wherein the controller further comprises computer program code configured to perform the steps of:
determining at least one of a clean time for an etch chamber, an O₂ flow for an ashing process and a source power for an ashing process based on information received about a defect density of the substrate previously processed within the etch subsystem.

7. The system of claim 1 wherein determining a deposition process to perform within the deposition subsystem comprises determining a deposition process based at least in part on information received from the inspection system of the deposition subsystem about a substrate previously processed within the deposition subsystem.

8. The system of claim 7 wherein determining a deposition process includes determining at least one of:
(a) a top/center SiH₄ flow ratio;
(b) a top/side source power ratio; and
(c) center SiH₄ and O₂ flow rates;
based on the information received about the substrate previously processed within the deposition subsystem.

9. The system of claim 7 wherein the controller further comprises computer program code configured to perform the steps of:
determining at least one of a clean time and a season time for deposition chamber based on information received about a defect density of the substrate previously processed within the deposition subsystem.

10. The system of claim 1 wherein the planarization subsystem includes an integrated inspection system configured to inspect the substrate after the substrate has been planarized; and
wherein the controller further comprises computer program code configured to perform the step of receiving information about the planarized substrate from the inspection system of the planarization subsystem.

11. The system of claim 11 wherein determining a planarization process to perform within the planarization subsystem comprises determining a planarization process based at least in part on information received from the inspection system of the planarization subsystem about a substrate previously processed within the planarization subsystem.

12. The system of claim 11 wherein determining a planarization process includes determining at least one of:
(a) a polish time;
(b) a head pressure;
(c) slurry type;
(d) slurry concentration; and
(e) overpolish time;
based on the information received about the substrate previously processed within the planarization subsystem.

13. The system of claim 11 wherein the controller further comprises computer program code configured to perform the steps of:
determining at least one of rinse pressure, rinse time and slurry concentration based on information received about a defect density of the substrate previously processed within the planarization subsystem.

14. The system of claim 1 wherein the inspection system of the etch subsystem is configured to inspect a patterned masking layer formed on a substrate before the substrate is etched within the etch subsystem; and
wherein the controller further comprises computer program code configured to perform the steps of:
receiving information about the patterned masking layer from the inspection system of the etch subsystem;
determining an etch process to perform within the etch subsystem based at least in part on the information received from the inspection system of the etch subsystem about the patterned masking layer; and
directing the etch subsystem to etch the substrate based on the etch process.

15. The system of claim 14 wherein determining an etch process to perform includes selecting a one of a plurality of etch processes based on information received about a patterned masking layer.

16. The system of claim 14 wherein determining an etch process to perform includes selecting at least one of a CHF₃ flow rate, an SF₆ flow rate, an O₂ flow rate, a Cl₂ flow rate and chamber pressure based on information received about a patterned masking layer.

17. The system of claim 1 wherein the inspection system of at least one of the subsystems is coupled to a factory interface of the subsystem.

18. The system of claim 1 wherein the inspection system of at least one of the subsystems comprises a metrology system.

19. The system of claim 1 wherein the inspection system of at least one of the subsystems comprises a defect detection system.

20. The system of claim 1 wherein the inspection system of at least one of the subsystems comprises both a defect detection system and a metrology system.

21. The system of claim 1 wherein determining a deposition process includes determining substrate power based on information received about trenches etched in the substrate.

22. The system of claim 1 wherein determining a deposition process includes determining SiH₄ and O₂ flow rates based on information received about trenches etched in the substrate.

23. The system of claim 1 wherein determining a deposition process includes determining deposition time based on information received about trenches etched in the substrate.

24. The system of claim 1 wherein determining a planarization process includes determining polish time based on information received about the insulating material deposited on the substrate.

25. The system of claim 1 wherein determining a planarization process includes determining head pressure based on information received about the insulating material deposited on the substrate.

26. The system of claim 1 wherein determining a planarization process includes determining slurry type based on information received about the insulating material deposited on the substrate.

27. The system of claim 1 wherein determining a planarization process includes determining slurry concentration based on information received about the insulating material deposited on the substrate.

28. The system of claim 1 wherein determining a planarization process includes determining overpolish time based on information received about the insulating material deposited on the substrate.

29. A method of forming shallow trench isolation regions in a substrate comprising:
receiving information about a substrate etched within an etch subsystem from an integrated inspection system of the etch subsystem;
determining a deposition process to perform within a deposition subsystem based at least in part on the information received from the inspection system of the etch subsystem;
directing the deposition subsystem to deposit an insulating material on the substrate based on the deposition process;
receiving information about the insulating material deposited on the substrate from an integrated inspection system of the deposition subsystem;
determining a planarization process to perform within a planarization subsystem based at least in part on the information received from the inspection system of the deposition subsystem; and
directing the planarization subsystem to planarize the substrate based on the planarization process.

30. The method of claim 29 further comprising receiving information about the planarized substrate from an inspection system of the planarization subsystem.

31. The method of claim 30 further comprising: determining an etch process to perform within the etch subsystem based at least in part on information received from the inspection system of the etch subsystem about a substrate previously processed within the etch subsystem;
wherein determining a deposition process to perform within a deposition subsystem comprises determining a deposition process based at least in part on information received from the inspection system of the deposition subsystem about a substrate previously processed within the deposition subsystem; and
wherein determining a planarization process to perform within a planarization subsystem comprises determining a planarization process based at least in part on information received from the inspection system of the planarization subsystem about a substrate previously processed within the planarization subsystem.

32. The method of claim 29 further comprising:
receiving information from the inspection system of the etch subsystem about a patterned masking layer formed on a substrate before the substrate is etched within the etch subsystem;
determining an etch process to perform within the etch subsystem based at least in part on the information received from the inspection system of the etch subsystem about the patterned masking layer; and
directing the etch subsystem to etch the substrate based on the etch process.

33. A computer program product comprising:
a medium readable by a computer, the computer readable medium having computer program code adapted to:
receive information about a substrate etched with an etch subsystem from an integrated inspection system of the etch subsystem;
determine a deposition process to perform within a deposition subsystem based at least in part on the information received from the inspection system of the etch subsystem;
direct the deposition subsystem to deposit an insulating material on the substrate based on the deposition process;
receive information about the insulating material deposited on the substrate from an integrated inspection system of the deposition subsystem;
determine a planarization process to perform within a planarization subsystem based at least in part on the information received from the inspection system of the deposition subsystem; and
direct the planarization subsystem to planarize the substrate based on the planarization process.

34. The computer program product of claim 33 further comprising computer program code adapted to receive information about the planarized substrate from an inspection system of the planarization subsystem.

35. The computer program product of claim 34 further comprising:
computer program code adapted to determine an etch process to perform within the etch subsystem based at least in part on information received from the inspection system of the etch subsystem about a substrate previously processed within the etch subsystem;
wherein the computer program code adapted to determine a deposition process to perform within a deposition subsystem comprises computer program code adapted to determine a deposition process based at least in part on information received from the inspection system of the deposition subsystem about a substrate previously processed within the deposition subsystem; and
wherein the computer program code adapted to determine a planarization process to perform within a planarization subsystem comprises computer program code adapted to determine a planarization process based at least in part on information received from the inspection system of the planarization subsystem about a substrate previously processed within the planarization subsystem.

36. The computer program product of claim 33 further comprising computer program code adapted to:
receive information from the inspection system of the etch subsystem about a patterned masking layer formed on a substrate before the substrate is etched within the etch subsystem;
determine an etch process to perform within the etch subsystem based at least in part on the information received from the inspection system of the etch subsystem about the patterned masking layer; and
direct the etch subsystem to etch the substrate based on the etch process.

37. A system for forming shallow trench isolation regions in a substrate comprising:
means for determining an etch process to perform within an etch subsystem;
means for directing the etch subsystem to etch a substrate based on the etch process;
means for receiving information about the etched substrate from an integrated inspection system of the etch subsystem;
means for determining a deposition process to perform within a deposition subsystem based at least in part on the information received from the inspection system of the etch subsystem;
means for directing the deposition subsystem to deposit an insulating material on the substrate based on the deposition process;
means for receiving information about the insulating material deposited on the substrate from an integrated inspection system of the deposition subsystem;
means for determining a planarization process to perform within a planarization subsystem based at least in part on the information received from the inspection system of the deposition subsystem; and
means for directing the planarization subsystem to planarize the substrate based on the planarization process.

38. A method for forming shallow trench isolation regions in a substrate comprising:
a step for determining an etch process to perform within an etch subsystem;
a step for directing the etch subsystem to etch a substrate based on the etch process;
a step for receiving information about the etched substrate from an integrated inspection system of the etch subsystem;
a step for determining a deposition process to perform within a deposition subsystem based at least in part on the information received from the inspection system of the etch subsystem;
a step for directing the deposition subsystem to deposit an insulating material on the substrate based on the deposition process;
a step for receiving information about the insulating material deposited on the substrate from an integrated inspection system of the deposition subsystem;
a step for determining a planarization process to perform within a planarization subsystem based at least in part on the information received from the inspection system of the deposition subsystem; and
a step for directing the planarization subsystem to planarize the substrate based on the planarization process.

39. A system configured to form shallow trench isolation regions in a substrate, the system comprising:
an etch subsystem configured to etch a substrate having a patterned masking layer and to remove the patterned masking layer from the substrate, the etch subsystem having an integrated inspection system configured to inspect the substrate after the patterned masking layer has been removed from the substrate;
a cleaning subsystem configured to receive the substrate from the etch subsystem and to clean the substrate;
an oxidation subsystem configured to receive the substrate from the cleaning subsystem and to form an oxide layer on the substrate;
a deposition subsystem configured to receive the substrate from the oxidation subsystem and to deposit an insulating material on the substrate, the deposition subsystem having an integrated inspection system configured to inspect the substrate after the insulating material has been deposited on the substrate;
a planarization subsystem configured to receive the substrate from the deposition subsystem and to planarize the substrate; and
a controller coupled to the etch subsystem, the cleaning subsystem, the oxidation subsystem, the deposition subsystem and the planarization subsystem, the controller having computer program code configured to communicate with each subsystem and to perform the steps of:
determining an etch process to perform within the etch subsystem;
directing the etch subsystem to etch a substrate having a patterned masking layer based on the etch process;
directing the etch subsystem to remove the patterned masking layer from the substrate;
receiving information about the etched substrate from the inspection system of the etch subsystem;
directing the cleaning subsystem to clean the substrate;
determining an oxidation process to perform within the oxidation subsystem;
directing the oxidation subsystem to form an oxide layer on the substrate based on the oxidation process;
determining a deposition process to perform within the deposition subsystem based at least in part on the information received from the inspection system of the etch subsystem about the etched substrate;
directing the deposition subsystem to deposit an insulating material on the substrate based on the deposition process;
receiving information about the insulating material deposited on the substrate from the inspection system of the deposition subsystem;
determining a planarization process to perform within the planarization subsystem based at least in part on the information received from the inspection system of the deposition subsystem about the deposited insulating material; and
directing the planarization subsystem to planarize the substrate based on the planarization process.

40. The system of claim 39 wherein the planarization subsystem includes an integrated inspection system configured to inspect a substrate after the substrate is planarized; and
wherein the controller further comprises computer program code configured to perform the step of receiving information about the planarized substrate from the inspection system of the planarization subsystem.

41. The system of claim 40 wherein:
determining an etch process to perform within an etch subsystem comprises determining an etch process based at least in part on information received from the inspection system of the etch subsystem about a substrate previously processed within the etch subsystem;
determining a deposition process to perform within a deposition subsystem comprises determining a deposition process based at least in part on information received from the inspection system of the deposition subsystem about a substrate previously processed within the deposition subsystem; and
determining a planarization process to perform within a planarization subsystem comprises determining a planarization process based at least in part on information received from the inspection system of the planarization subsystem about a substrate previously processed within the planarization subsystem.

42. A method of forming shallow trench isolation regions in a substrate comprising:
determining an etch process to perform within an etch subsystem;
directing the etch subsystem to etch a substrate having a patterned masking layer based on the etch process;
directing the etch subsystem to remove the patterned masking layer from the substrate;
receiving information about the etched substrate from an integrated inspection system of the etch subsystem;
directing a cleaning subsystem to clean the substrate;
determining an oxidation process to perform within an oxidation subsystem;
directing the oxidation subsystem to form an oxide layer on the substrate based on the oxidation process;
determining a deposition process to perform within a deposition subsystem based at least in part on the information received from the inspection system of the etch subsystem about the etched substrate;
directing the deposition subsystem to deposit an insulating material on the substrate based on the deposition process;
receiving information about the insulating material deposited on the substrate from an integrated inspection system of the deposition subsystem;
determining a planarization process to perform within a planarization subsystem based at least in part on the information received from the inspection system of the deposition subsystem about the deposited insulating material; and
directing the planarization subsystem to planarize the substrate based on the planarization process.

43. The method of claim 42 further comprising receiving information about the planarized substrate from an inspection system of the planarization subsystem.

44. The method of claim 43 wherein:
determining an etch process to perform within an etch subsystem comprises determining an etch process based at least in part on information received from the inspection system of the etch subsystem about a substrate previously processed within the etch subsystem;
determining a deposition process to perform within a deposition subsystem comprises determining a deposition process based at least in part on information received from the inspection system of the deposition subsystem about a substrate previously processed within the deposition subsystem; and
determining a planarization process to perform within a planarization subsystem comprises determining a planarization process based at least in part on information received from the inspection system of the planarization subsystem about a substrate previously processed within the planarization subsystem.

45. The method of claim 42 further comprising receiving information about the patterned masking layer from the inspection system of the etch subsystem, and wherein determining an etch process comprises determining an etch process based at least in part on the information about the patterned masking layer received from the inspection system of the etch subsystem.

46. A computer program product comprising:
a medium readable by a computer, the computer readable medium having computer program code adapted to:
determine an etch process to perform within an etch subsystem;
direct the etch subsystem to etch a substrate having a patterned masking layer based on the etch process;
direct the etch subsystem to remove the patterned masking layer from the substrate;
receive information about the etched substrate from an integrated inspection system of the etch subsystem;
direct a cleaning subsystem to clean the substrate;
determine an oxidation process to perform within an oxidation subsystem;
direct the oxidation subsystem to form an oxide layer on the substrate based on the oxidation process;
determine a deposition process to perform within a deposition subsystem based at least in part on the information received from the inspection system of the etch subsystem about the etched substrate;
direct the deposition subsystem to deposit an insulating material on the substrate based on the deposition process;
receive information about the insulating material deposited on the substrate from an integrated inspection system of the deposition subsystem;
determine a planarization process to perform within a planarization subsystem based at least in part on the information received from the inspection system of the deposition subsystem about the deposited insulating material; and
direct the planarization subsystem to planarize the substrate based on the planarization process.

47. An apparatus configured to form shallow trench isolation regions in a substrate, the apparatus comprising:
a controller configured to communicate with a plurality of subsystems including: (1) an etch subsystem configured to etch a substrate and having an integrated inspection system; (2) an oxidation subsystem configured to form an oxide layer on the substrate; (3) a deposition subsystem configured to deposit a material layer on the substrate and having an integrated inspection system; and (5) a planarization subsystem configured to planarize the substrate and having an integrated inspection system; and
a data structure which causes the controller to control the formation of the shallow trench isolation regions via one or more communications with the plurality of subsystems and via one or more communications with the inspection systems of the etch subsystem, the deposition subsystem and the planarization subsystem.

48. The apparatus of claim 47 wherein the one or more communications with the inspection systems of the etch subsystem and the deposition subsystem comprise receiving feedforward information.

49. The apparatus of claim 47 wherein the one or more communications with the inspection systems of the etch subsystem, the deposition subsystem and planarization subsystem comprise receiving feedback information.

50. A system comprising:
an etch subsystem configured to etch a substrate, the etch subsystem having an integrated inspection system configured to inspect a substrate after the substrate has been etched within the etch subsystem;
a deposition subsystem configured to receive the substrate after the substrate has been etched within the etch subsystem and to deposit a material layer on the substrate; and
a controller coupled to the etch subsystem and the deposition subsystem, the controller having computer program code configured to communicate with each subsystem and to perform the steps of:
receiving information about an etched substrate from the inspection system of the etch subsystem;
determining a deposition process to perform within the deposition subsystem based at least in part on the information received from the inspection system of the etch subsystem; and
directing the deposition subsystem to deposit a material layer on the substrate based on the deposition process.

51. A method comprising:
receiving information about an etched substrate from an integrated inspection system of an etch subsystem;
determining a deposition process to perform within a deposition subsystem based at least in part on the information received from the inspection system of the etch subsystem; and
directing the deposition subsystem to deposit a material layer on the substrate based on the deposition process.

52. A computer program product comprising:
a medium readable by a computer, the computer readable medium having computer program code adapted to:
receive information about an etched substrate from an integrated inspection system of an etch subsystem;
determine a deposition process to perform within a deposition subsystem based at least in part on the information received from the inspection system of the etch subsystem; and
direct the deposition subsystem to deposit a material layer on the substrate based on the deposition process.

53. A system comprising:
a deposition subsystem configured to receive a substrate and to deposit a material layer on the substrate, the deposition subsystem having an integrated inspection system configured to inspect the substrate after deposition of the material layer;
a planarization subsystem configured to receive the substrate after a material layer has been deposited on the substrate within the deposition subsystem and to planarize the substrate; and
a controller coupled to the deposition subsystem and the planarization subsystem, the controller having computer program code configured to communicate with each subsystem and to perform the steps of:
receiving information about a material layer deposited on a substrate from the inspection system of the deposition subsystem;
determining a planarization process to perform within the planarization subsystem based at least in part on the information received from the inspection system of the deposition subsystem; and
directing the planarization subsystem to planarize the substrate based on the planarization process.

54. A method comprising:
receiving information about a material layer deposited on a substrate from an integrated inspection system of a deposition subsystem;
determining a planarization process to perform within a planarization subsystem based at least in part on the information received from the inspection system of the deposition subsystem; and
directing the planarization subsystem to planarize the substrate based on the planarization process.

55. A computer program product comprising:
a medium readable by a computer, the computer readable medium having computer program code adapted to:
receive information about a material layer deposited on a substrate from an integrated inspection system of a deposition subsystem;
determine a planarization process to perform within a planarization subsystem based at least in part on the information received from the inspection system of the deposition subsystem and
direct the planarization subsystem to planarize the substrate based on the planarization process.

56. A system configured to form shallow trench isolation regions in a substrate, the system comprising:
an etch subsystem configured to etch a substrate, the etch subsystem having an integrated inspection system configured to inspect a substrate after the substrate has been etched within the etch subsystem;
a deposition subsystem configured to receive the substrate after the substrate has been etched and to deposit an insulating material on the substrate, the deposition subsystem having an integrated inspection system configured to inspect the substrate after deposition of the insulating material;
a planarization subsystem configured to receive the substrate after an insulating material has been deposited on the substrate and to planarize the substrate; and
a controller coupled to the etch subsystem, the deposition subsystem and the planarization subsystem, the controller having computer program code configured to communicate with each subsystem and to perform the steps of:
determining an etch process to perform within the etch subsystem based at least in part on information received from the inspection system of the etch subsystem about a substrate previously processed within the etch subsystem;
directing the etch subsystem to etch a substrate based on the etch process;
determining a deposition process to perform within the deposition subsystem based at least in part on information received from the inspection system of the deposition subsystem about a substrate previously processed within the deposition subsystem;
directing the deposition subsystem to deposit an insulating material on the substrate based on the deposition process;
determining a planarization process to perform within the planarization subsystem; and
directing the planarization subsystem to planarize the substrate based on the planarization process.

57. A method for forming shallow trench isolation regions in a substrate comprising:
determining an etch process to perform within an etch subsystem based at least in part on information received from an integrated inspection system of the etch subsystem about a substrate previously processed within the etch subsystem;
directing the etch subsystem to etch a substrate based on the etch process;
determining a deposition process to perform within a deposition subsystem based at least in part on information received from an integrated inspection system of the deposition subsystem about a substrate previously processed within the deposition subsystem;
directing the deposition subsystem to deposit an insulating material on the substrate based on the deposition process;
determining a planarization process to perform within a planarization subsystem; and
directing the planarization subsystem to planarize the substrate based on the planarization process.

58. A computer program product comprising:
a medium readable by a computer, the computer readable medium having computer program code adapted to:
determine an etch process to perform within an etch subsystem based at least in part on information received from an integrated inspection system of the etch subsystem about a substrate previously processed within the etch subsystem;
direct the etch subsystem to etch a substrate based on the etch process;
determine a deposition process to perform within a deposition subsystem based at least in part on information received from an integrated inspection system of the deposition subsystem about a substrate previously processed within the deposition subsystem;
direct the deposition subsystem to deposit an insulating material on the substrate based on the deposition process;
determine a planarization process to perform within a planarization subsystem; and
direct the planarization subsystem to planarize the substrate based on the planarization process.
